(19) United States
(12) Patent Application Publication
(10) Pub. No.: US 2011/0295655 A1
(43) Pub. Date: Dec. 1, 2011

(54) INFORMATION PROCESSING SYSTEM AND INFORMATION PROCESSING DEVICE

(75) Inventors: Satomi Tsuji, Kokubunji (JP); Nobuo Sato, Saitama (JP); Kazuo Yano, Hino (JP); Koji Ara, Higashiyamato (JP); Takeshi Tanaka, Inagi (JP)

(73) Assignee: HITACHI, LTD., Tokyo (JP)

(21) Appl. No.: 13/126,793

(22) PCT Filed: Oct. 26, 2009
(86) PCT No.: PCT/JP2009/005632

§ 371 Date: Apr. 29, 2011

(30) Foreign Application Priority Data
Nov. 4, 2008 (JP) 2008-282692

(51) Int. Cl. G06Q 10/00; G06F 15/00; G06F 19/00; G06F 15/16

(52) U.S. Cl. 705/7.38; 709/224; 702/176; 702/19

(57) ABSTRACT

A terminal includes a sensor for detecting a physical quantity and a data transmitting unit for transmitting data representing the physical quantity to a processing device. An input/output device includes an input unit for receiving an input of data representing a productivity relating to the person wearing the terminal and a data transmitting unit for transmitting the data representing the productivity to the processing device. The processing device includes a feature value extracting unit for extracting a feature value from the data representing the physical quantity, a conflict calculating unit for determining items of data bringing about conflict from the data representing the productivity, and a coefficient-of-influence calculating unit for calculating a degree of the correlation between the feature value and the items of the data bringing about conflict.

### TECHNICAL FIELD

The present invention relates to a technique by which realization of better duty performance or life is supported on the basis of data on the activities of a person wearing a sensor terminal.

### BACKGROUND ART

So far, methods by which multiple feature values are extracted from behavioral data of a worker wearing a sensor terminal and the feature value most closely synchronized with indicators regarding the results of duty performance of the worker's subjective evaluation is found out have been disclosed (e.g. in Patent Literature 1).

### CITATION LIST

### Patent Literature

Patent Literature 1: Japanese Patent Application Laid-Open Publication No. 2008-210363

### SUMMARY OF INVENTION

### Technical Problem

In every organization, productivity improvement is an unavoidable challenge, and many trials and errors have been made, aimed at improving the efficiency of production and improving the quality of the output. In the performance of a duty which requires accomplishment of a fixed task in the shortest possible length of time, the efficiency of production is improved by analyzing the work process, discovering any blank time, rearranging the work procedure and so forth.

However, in the performance of duties where the quality of output, especially creativity and novelty, is considered important, mainly intellectual labor, mere analysis of the work procedure cannot facilitate sufficient improvement of productivity. The reasons for the difficulty to improve duty performance include, first of all, the diverse definition of productivity according to the pertinent organization and/or worker, and the diversity also of methods for improving productivity. For example, where the duty is intended to propose the concept of a new product, it is difficult to asses the quality of the concept itself, which is the output. And, as performance indicators considered necessary for a high quality concept, many elements are required including the introduction of a new viewpoint through communication among persons of different areas of specialization, endorsement of the idea by market survey, sturdiness of the proposal achieved by in-depth discussions, and the level of perfection of the language and coloring of the proposal document. There are also diverse methods that are effective for improvements in these elements, varying with the culture or the sector the organization belongs to and the character of the worker. Therefore, in order to improve the performance level, boiling down the target of organization improvement with regard to what should be taken note of and how it is to be changed poses a major challenge.

Furthermore, taking multiple performance elements into consideration is a new problem we are to propose in discussing the present invention. For instance, if the worker is forced to engage in heavy labor in sole pursuit of improved production efficiency, it is very likely to invite such harms as impairing his health or weakening his motivation. Therefore, it is essential to take multiple performance elements into consideration and work out measures for achieving a result that is the most suitable in overall perspective.

Incidentally, duty performance is not the only object of appropriate improvement, but the quality of life in everyday living as necessary an aspect as the aforementioned object. In this case, the problems include thinking out a specific way of improvement to make health and satisfaction of the taste compatible with each other.

The existing Patent Literature 1 discloses a method by which each worker wears a sensor terminal, multiple feature values are extracted from activities data obtained therefrom and the feature value most closely synchronized with indicators regarding the results of duty performance and the worker's subjective evaluation is found out. This, however, is intended to understand the characteristics of each individual worker by finding his feature values or to have the worker himself to transform his behavior, but no mention is made of utilization of the findings for planning a measure for improvement of duty performance. Furthermore, there is only one indicator to be considered as a performance element but no viewpoint of integrated analysis of multiple performance elements is taken into account.

Therefore, a system and a method are needed which select in an organization or a person to be considered the indicators (performance elements) to be improved, obtain guidelines regarding the measures for improving the indicators and support proposal of the measures which take account of multiple indicators to be improved and help optimize the overall business performance.

### Solution to Problem

The outlines of typical aspects of the invention disclosed in this application are briefly summarized below.

It is an information processing system having a terminal, an input/output unit and a processing unit for processing data transmitted from the terminal and the input/output unit. The terminal is provided with a sensor for detecting a physical quantity and a data transmitting unit for transmitting data representing the physical quantity to the processing unit; the input/output unit is provided with an input unit for receiving an input of data representing a productivity element relating to a person wearing the terminal and a data transmitting unit for transmitting the data representing the productivity element to the processing unit; and the processing unit is provided with a feature value extracting unit for extracting a feature value from the data representing the physical quantity, a conflict calculating unit for determining multiple items of data giving rise to conflict from the data representing the productivity, and a coefficient-of-influence calculating unit for calculating the degree of relation between the feature value and the multiple items of data giving rise to conflict.

It may also be an information processing system having a terminal, an input/output unit and a processing unit for processing data transmitted from the terminal and the input/output unit. The terminal is provided with a sensor for detecting a physical quantity and a data transmitting unit for transmitting data representing the physical quantity; the input/output unit is provided with an input unit for receiving an input of data representing a productivity element relating to a person wearing the terminal and a data transmitting unit for transmitting the data representing the productivity element to the processing unit; and the processing unit is provided with a feature value extracting unit for extracting a feature value from the data representing the physical quantity and a coefficient-of-influence calculating unit for calculating the degree of relation between the feature values whose periods and sampling frequencies are unified and the data representing multiple productivity elements.

It may also be an information processing system having a terminal, an input/output unit and a processing unit for processing data transmitted from the terminal and the input/output unit. The terminal is provided with a sensor for detecting a physical quantity and a data transmitting unit for transmitting data representing the physical quantity detected by the sensor; the input/output unit is provided with an input unit for receiving an input of data representing productivity relating to a person wearing the terminal and a data transmitting unit for transmitting the data representing productivity to the processing unit; and the processing unit is provided with a feature value extracting unit for extracting a feature value from the data representing the physical quantity, a conflict calculating unit for determining subjective data representing the person's subjective evaluation and objective data on the duty performance relating to the person from the data representing productivity, and a coefficient-of-influence calculating unit for calculating the degree of relation between the feature value and the subjective data and the degree of correlation between the feature value and the objective data.

It may also be an information processing system having a terminal, an input/output unit and a processing unit for processing data transmitted from the terminal and the input/output unit. The terminal is provided with a sensor for detecting a physical quantity and a data transmitting unit for transmitting data representing the physical quantity detected by the sensor; the input/output unit is provided with an input unit for receiving an input of data representing multiple productivity elements relating to a person wearing the terminal and a data transmitting unit for transmitting the data representing productivity to the processing unit; and the processing unit is provided with a feature value extracting unit for extracting multiple feature values from the data representing the physical quantity and a coefficient-of-influence calculating unit for calculating the degree of relation between one feature value selected out of multiple feature values and data representing the multiple productivity elements.

It may also be an information processing unit having a recording unit for recording a first time series of data, a second time series of data, a first reference value and a second reference value, a first determining unit for determining whether the first time series of data or a value resulting from conversion of the first time series is greater or smaller than the first reference value, a second determining unit for determining whether the second time series of data or a value resulting from conversion of the second time series of data is greater or smaller than the second reference value, a status determining unit for determining a case in which the first time series of data or the value resulting from conversion of the first time series is greater than the first reference value, a case in which the second time series of data or the value resulting from conversion of the second time series of data is greater than the second reference value to be a first status and a status other than the first status or a specific status other than the first status to be a second status, a unit allocating a first name to the first status and a second name to the second status and another unit for causing a display unit connected thereto a fact of being in the first status or the second status by using the first name or the second name, respectively.

It may also be an information processing unit having a unit for acquiring information inputted by a user concerning a first quantity and a second quantity relating to the user's life or duty performance, a status determining unit for determining a case in which the first quantity increases and the second quantity increases as a first status and determining a status other than the first status or a specific status other than the first status to be a second status, another unit allocating a first name to the first status and a second name to the second status, and still another unit for causing a display unit connected thereto a fact of the user being in the first status or the second status by using the first name or the second name, respectively.

It may also be an information processing unit having a unit for acquiring information inputted by a user concerning a first quantity, a second quantity, a third quantity and a fourth quantity relating to the user's life or duty performance; a status determining unit for determining a case in which the first quantity increases and the second quantity increases as a first status, determining a status other than the first status or a specific status other than the first status to be a second status, determining a case in which the third quantity increases and the fourth quantity increases as a third status, determining a status other than the third status or a specific status other than the third status to be a fourth status, determining a status which is the first status and is the third status as a fifth status, determining a status which is the first status and is the fourth status as a sixth status, determining a status which is the second status and is the third status as a seventh status and determining a status which is the second status and is the fourth status as the eighth status, another unit for allocating a first name to the fifth status, a second name to the sixth status, a third name to the seventh status and a fourth name to the eighth status, and still another unit for causing a display unit connected thereto a fact of the user being in one of the fifth status, sixth status, seventh status and eighth status by using at least one of the first name, second name, third name and fourth name.

It may also be an information processing unit having a recording unit for recording time series of data relating to movements of a person, a calculating unit for calculating indicators regarding fluctuations, unevenness or consistency in the movements of the person by converting the time series of data, a determining unit for determining from the indicators insignificance of fluctuations or of unevenness or significance of consistency in the movements of the person, and a unit for causing on the basis of the determination the desirable status of the person or the organization to which the person belongs to be displayed on a display unit connected thereto.

It may also be an information processing unit having a recording unit for recording time series of data relating to a sleep of a person, a calculating unit for calculating indicators regarding fluctuations, unevenness or consistency in the sleep of the person by converting the time series of data, a determining unit for determining from the indicators insignificance of fluctuations or of unevenness or significance of consistency in the sleep of the person, and a unit for causing on the basis of the determination the desirable status of the person or the organization to which the person belongs to be displayed on a display unit connected thereto.

It may also be an information processing unit having a recording unit for recording data representing the state of communication among at least a first user, a second user and a third user, and a processing unit for analyzing the data representing the state of communication. The recording unit records a first communication quantity and a first related information item between the first user and the second user, a second communication quantity and a second related information item between the first user and the third user, and a third communication quantity and a third related information item the second user and the third user. The processing unit, when it determines that the third communication quantity is smaller than the first communication quantity and the third communication quantity is smaller than the second communication quantity, gives a display or an instruction to urge communication between the second user and the third user.

### Advantageous Effects of Invention

According to the invention, proposal of measures to optimize duty performance can be supported on the basis of data on the activities of a worker and performance data and with the influence on multiple performance elements being taken into consideration.

### BRIEF DESCRIPTION OF DRAWINGS

FIG. 1 is one example of illustrative diagram showing a scene of utilization from collection of sensing data and performance data until displaying of analytical results in a first exemplary embodiment.

FIG. 2 is one example of diagram illustrating a balance map in the first exemplary embodiment.

FIG. 3 is a diagram illustrating one example of balance map in the in the first exemplary embodiment.

FIG. 4 is a diagram illustrating one example of configuration of an application server and a client in the first exemplary embodiment.

FIG. 5 is a diagram illustrating one example of configuration of a client for performance inputting, a sensor network server and a base station in the first exemplary embodiment.

FIG. 6 is one example of diagram illustrating the configuration of a terminal in the first exemplary embodiment.

FIG. 7 is one example of sequence chart that shows processing until sensing data and performance data are accumulated in the sensor network server in the first exemplary embodiment.

FIG. 8 is one example of sequence chart that shows processing from application start by the user until presentation of the result of analysis to the user in the first exemplary embodiment.

FIG. 9 is tables showing examples of results of coefficients of influence in the first exemplary embodiment.

FIG. 10 shows an example of combinations of feature values in the first exemplary embodiment.

FIG. 11 shows examples of measures to improve organization matched with feature values in the first exemplary embodiment.

FIG. 12 shows an example of analytical conditions setting window in the first exemplary embodiment.

FIG. 13 is one example of flow chart showing the overall processing executed to prepare a balance map in the first exemplary embodiment.

FIG. 14 is one example of flow chart showing the processing of conflict calculation in the first exemplary embodiment.

FIG. 15 is one example of flow chart showing the processing of balance map drawing in the first exemplary embodiment.

FIG. 16 is one example of flow chart showing a procedure of the analyzer in the first exemplary embodiment.

FIG. 17 is a diagram illustrating an example of user-ID matching table in the first exemplary embodiment.

FIG. 18 is a diagram illustrating an example of performance data table in the first exemplary embodiment.

FIG. 19 is a diagram illustrating an example of performance correlation matrix in the first exemplary embodiment.

FIG. 20 is a diagram illustrating an example of coefficient-of-influence table in the first exemplary embodiment.

FIG. 21 is one example of flow chart showing the overall processing executed to prepare a balance map in a second exemplary embodiment.

FIG. 22 is a diagram illustrating an example of meeting table in the second exemplary embodiment.

FIG. 23 is a diagram illustrating an example of meeting combination table in the second exemplary embodiment.

FIG. 24 is a diagram illustrating an example of meeting feature value table in the second exemplary embodiment.

FIG. 25 is a diagram illustrating an example of acceleration data table in the second exemplary embodiment.

FIG. 26 is a diagram illustrating an example of acceleration rhythm table in the second exemplary embodiment.

FIG. 27 is a diagram illustrating an example of acceleration rhythm feature value table in the second exemplary embodiment.

FIG. 28 is a diagram illustrating an example of text of e-mail for answering questionnaire and an example of response thereto in the second exemplary embodiment.

FIG. 29 is a diagram illustrating an example of screen used in responding to questionnaire at the terminal in the second exemplary embodiment.

FIG. 30 is a diagram illustrating an example of performance data table in the second exemplary embodiment.

FIG. 31 is a diagram illustrating an example of integrated data table in the second exemplary embodiment.

FIG. 32 is a diagram illustrating a configuration of client for performance inputting and sensor network server in a third exemplary embodiment.

FIG. 33 is a diagram illustrating an example of performance data combination in the third exemplary embodiment.

FIG. 34 is a diagram illustrating an example of balance map in a fourth exemplary embodiment.

FIG. 35 is one example of flow chart that shows processing for balance map drawing in the fourth exemplary embodiment.

FIG. 36 is an example of diagram illustrating the detection range of an infrared transceiver of the terminal in a fifth exemplary embodiment.

FIG. 37 is an example of diagram illustrating a process of two-stage complementing of meeting detection data in the fifth exemplary embodiment.

FIG. 38 is an example of diagram illustrating changes in values in the meeting combination table by the two-stage complementing of meeting detection data in the fifth exemplary embodiment.

FIG. 39 is one example of flow chart that shows processing for two-stage complementing of meeting detection data in the fifth exemplary embodiment.

FIG. 40 is an example of diagram illustrating positioning of phases according to the way of conducting communication in a sixth exemplary embodiment.

FIG. 41 is an example of diagram illustrating classification of communication dynamics in the sixth exemplary embodiment.

FIG. 42 is a diagram illustrating an example of meeting matrix in the sixth exemplary embodiment.

FIG. 43 is a diagram illustrating a configuration of an application server and a client in the sixth exemplary embodiment.

FIG. 44 is an example of diagram illustrating a system configuration and a processing sequence a configuration of in a seventh exemplary embodiment.

FIG. 45 is an example of diagram illustrating a system configuration and a processing sequence in the seventh exemplary embodiment.

FIG. 46 is an example of diagram illustrating analytical results in the seventh exemplary embodiment.

FIG. 47 is another example of diagram illustrating analytical results in the seventh exemplary embodiment.

FIG. 48 is another example of diagram illustrating analytical results in the seventh exemplary embodiment.

FIG. 49 is another example of diagram illustrating analytical results in the seventh exemplary embodiment.

FIG. 50 is another example of diagram illustrating analytical results in the seventh exemplary embodiment.

FIG. 51 is another example of diagram illustrating analytical results in the seventh exemplary embodiment.

FIG. 52 is an example of diagram illustrating measurement results in the seventh exemplary embodiment.

FIG. 53 is an example of diagram illustrating measurement results in the seventh exemplary embodiment.

FIG. 54 is an example of diagram illustrating a configuration of an application server and a client in an eighth exemplary embodiment.

FIG. 55 is an example of diagram illustrating a method of calculating the level of cohesion in the eighth exemplary embodiment.

FIG. 56 is a diagram illustrating an example of network diagram in the eighth exemplary embodiment.

### DESCRIPTION OF EMBODIMENTS

First, an outline of typical aspects of the invention disclosed in this application will be described.

With a sensor terminal worn by a person, activities data on the person are acquired, and multiple feature values are extracted from those activities data. Also, by calculating the closeness of relation and the positiveness or negativeness that each feature value has with respect to separately acquired multiples kinds of performance data and displaying the characters of the feature values, a system that facilitates discovery of notable feature values and planning of improving measures is realized. An outline of typical aspects of the invention for this realization will be described below.

According to a first aspect of the invention, with respect to two kinds of performance data and multiple kinds of sensing data between which conflict can arise, the closeness of relation of each is represented.

According to a first aspect of the invention, with respect to two kinds of performance data and multiple kinds of sensing data between which criteria including the duration and sampling period are identical, the closeness of relation of each is represented.

According to a third aspect of the invention, with respect to two kinds of performance data including subjective data and objective data or different sets of objective data and multiple kinds of sensing data, the closeness of relation of each is represented.

The first aspect of the invention enables both of two kinds of performance to be prevented from falling into conflict and improved by discovering any factor that may invite conflict, and planning and taking measures to eliminate the factor.

The second aspect of the invention enables appropriate measures to be taken to improve the two kinds of performance in a well balanced way even if the performance data and sensing data are acquired in different periods or are imperfect, involving deficiencies.

The third aspect of the invention enables measures to be taken to improve both qualitative performance regarding the inner self of the individual and quantitative performance regarding productivity or measures to be taken to improve both of two kinds of quantitative performance regarding productivity.

### Embodiment 1

First, a first exemplary embodiment of the present invention will be described with reference to drawings.

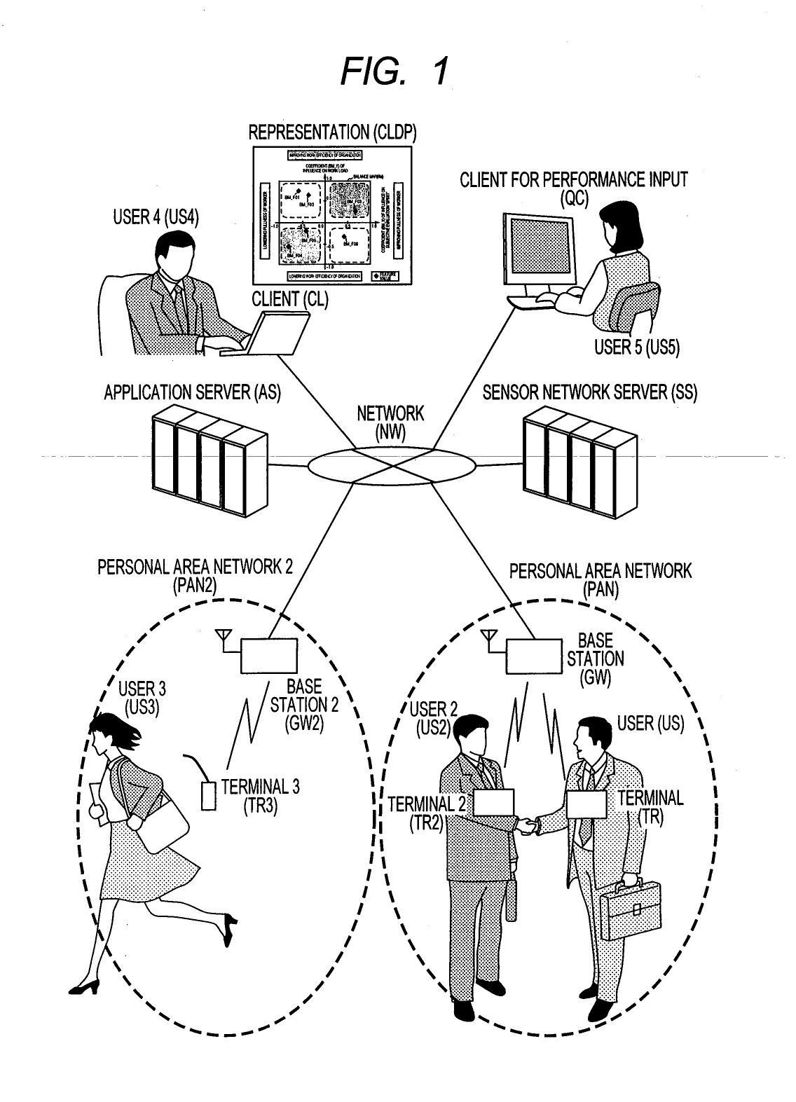

### <FIG. 1: Outline of Flow of Overall Processing>

FIG. 1 shows an outlines a device which is the first exemplary embodiment. In the first exemplary embodiment, each member of an organization wears a sensor terminal (TR) having a radio transceiver as a user (US), and sensing data regarding the behavior of each member and interactions between the members are acquired with those terminals (TR). Regarding behavior, data are collected with an acceleration sensor and a microphone. When users (US) meet each other, the meeting is detected by transmission and reception of infrared rays between their terminals (TR). The acquired sensing data are transmitted wirelessly to a base station (GW), and stored by a sensor network server (SS) via a network (NW).

Performance data are collected separately or from the same terminals (TR). Performance in this context serves as a criterion connected to the achievement of duty performance by an organization or an individual, such as the sales, profit ratio, customer satisfaction, employer satisfaction or target attainment ratio. In other words, it can be regarded as representing the productivity of a member wearing the terminal or of the organization to which the member belongs. A performance datum is a quantitative value representing a performance element. The performance data may be inputted by a responsible person of the organization, the individual may numerically input his subjective evaluation as performance data, or data existing in the network may be automatically acquired. The device for obtaining performance counts may be generically referred to here as a client for performance inputting (QC). The client for performance inputting (QC) has a mechanism for obtaining performance data and a mechanism for transmitting the data to the sensor network server (SS). It may be a PC (personal computer), or the terminal (TR) may also perform the function of the client for performance inputting (QC).

The performance data obtained by the client for performance inputting (QC) are stored into the sensor network server (SS) via the network (NW). When a display regarding improvement of duty performance is to be prepared from these sensing data and performance data, a request is issued from a client (CL) to an application server (AS), and the sensing data and the performance data on the pertinent member are taken out of the sensor network server (SS). They are processed and analyzed by the application server (AS) to draw a visual image. The visual image is returned to the client (CL) to be shown on the display (CLDP). A serial system of duty performance improvement that supports improvement of duty performance is thereby realized. Incidentally, though the sensor network server and the application server are illustrated and described as separate units, they may as well be configured into the same unit.

To add, the data acquired by the terminal (TR), instead of being consecutively transmitted by wireless means, may as well be stored in the terminal (TR) and transmitted to the base station (GW) when connected to a wired network.

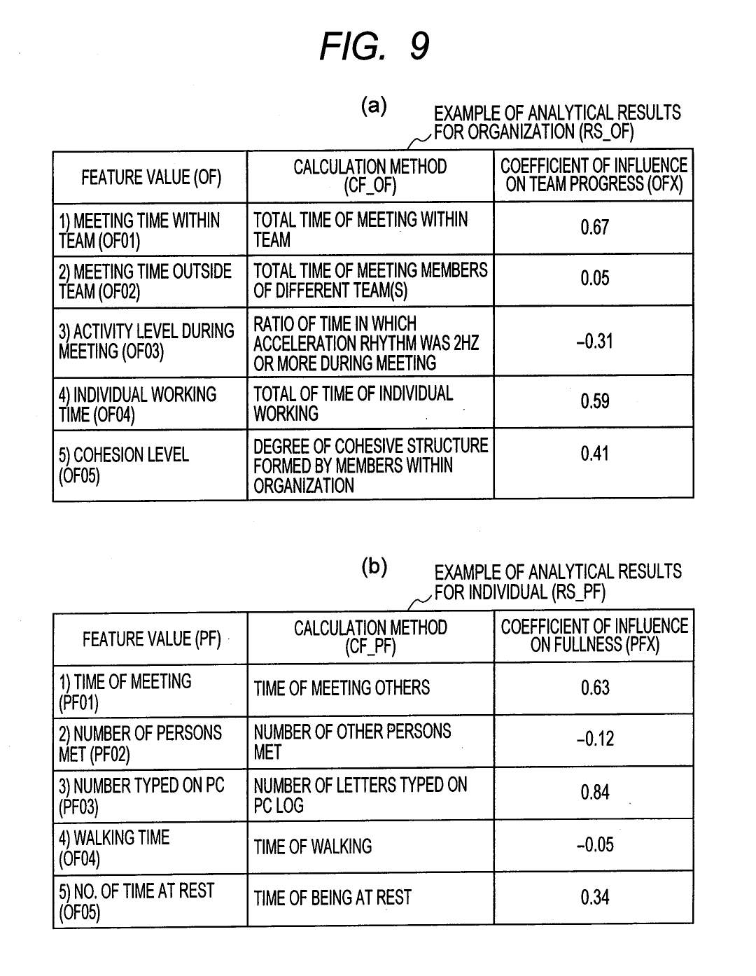

### <FIG. 9: Example of Analysis by Separate Feature Values>

FIG. 9 shows an exemplary case in which the connections between the performances of the organization and an individual and the member's behavior are to be analyzed.

This analysis is intended to know what kind of everyday activity (such as the bodily motion or the way of communication) influences the performance by checking together the performance data and the activities data on the user (US) obtained from the sensor terminal (TR).

Here, data having a certain pattern are extracted from sensing data obtained from the terminal (TR) worn by the user (US) or a PC (personal computer) as feature value (PF), and the closeness of relation of each of multiple kinds of feature value (PF) to the performance data is figured out. At this time, feature values highly likely to influence the object performance feature are selected, and what feature value strongly influences the pertinent organization or user (US) are examined. If, on the basis of the result of examination, measures to enhance the closely relating feature values (PF) feature values are taken, the behavior of the user (US) will change and the performance will be further improved. In this way, what measures should be taken to improve business performance will become known.

Regarding the closeness of relation, a numerical value representing the “coefficient of influence” is used here. The coefficient of influence is a real value representing the intensity of synchronization between the count of a feature value and a performance datum, and has a positive or negative sign. If the sign is positive, it means the presence of a synchronism that when the feature value rises the performance datum also rises or, if the sign is negative, it means the presence of a synchronism that when the feature value rises the performance datum falls. A high absolute value of the coefficient of influence represents a more intense synchronism. As the coefficient of influence, a coefficient of correlation between each feature value and performance datum is used. Or, it can as well use a partial regression coefficient obtained by multiple regression analysis using each feature value as explanatory variable and each performance datum as object variable. Any other method can also be used if only the influence is represented by a numerical value.

FIG. 9 (a) shows an example of analytical result (RS_OF) where “team progress” is selected as the performance element of the organization and five items (OF01 through OF05) which may closely relate to team progress, such as meeting time between persons within the team (OF01) as feature values (OF). As calculation methods (CF_OF), outlines of calculations for extracting each feature value (OF) from sensing data are listed. To look at the coefficients of influence (OFX) of the feature value (OF) on team progress, it is found that the greatest in the absolute value of influence is (1) the meeting time between persons within the team (OF01). On the other hand, (3) the activity level during meeting (OF03) is low as its coefficient is negative. Thus, a conference of a style in which all the participants think intensively is seen to be more effective in accelerating team progress in this organization than brainstorming in which the participants loudly argue with one another. From this finding, for instance, implementing a measure to increase meetings within the team, especially ones in which depth thinking takes place, can be considered more effective in accelerating team progress. Therefore, measures to improve the organization can be planned according to this analysis.

On the other hand, FIG. 9 (b) shows an example of analytical result (RS_PF) where “fullness” according to a reply to a questionnaire is selected as an individual's performance and five items (PF01 through PF05) which may closely relate to fullness, such as the individual's meeting time (PF01) as the feature value (PF). Similarly to the foregoing, as the calculation methods (CF_OF), outlines of calculations for extracting each feature value (OF) sensing data are listed. From this finding, it is known that, for the members of the pertinent organization, the number of PC typing is the most influential on fullness, and therefore fullness can be increased by measures to develop an environment that helps concentration on PC work.

As seen from these cases, by selecting feature values relevant to the organization for its performance and feature values relevant to the individual's behavior for his performance and analyzing them, planning of measures to improve each of them is facilitated. However, in order to improve duty performance of intellectual labor in the organization, improving only one performance element is highly likely to be insufficient. Especially, a problem arises where an attempt to improve one performance element invites deterioration of another performance element. As in the examples of FIG. 9 (a) and (b), analysis using different feature values involves the possibility that the individual's performance element “fullness” is reduced by the implementation of a measure taking note of a certain feature value to raise the organization's performance element “team progress”, but this point is not taken into consideration. Thus, simple combination of the results of analyses separately done of two kinds of performance is insufficient for knowing what feature values should be taken note of in planning a measure to improve both “team progress” and “fullness”. Especially, as the number of feature values or of performance elements increases, a limit is reached beyond which feature values as indicators for planning measures cannot be identified. Therefore, another method of analysis is needed to make multiple performance elements compatible with one another.

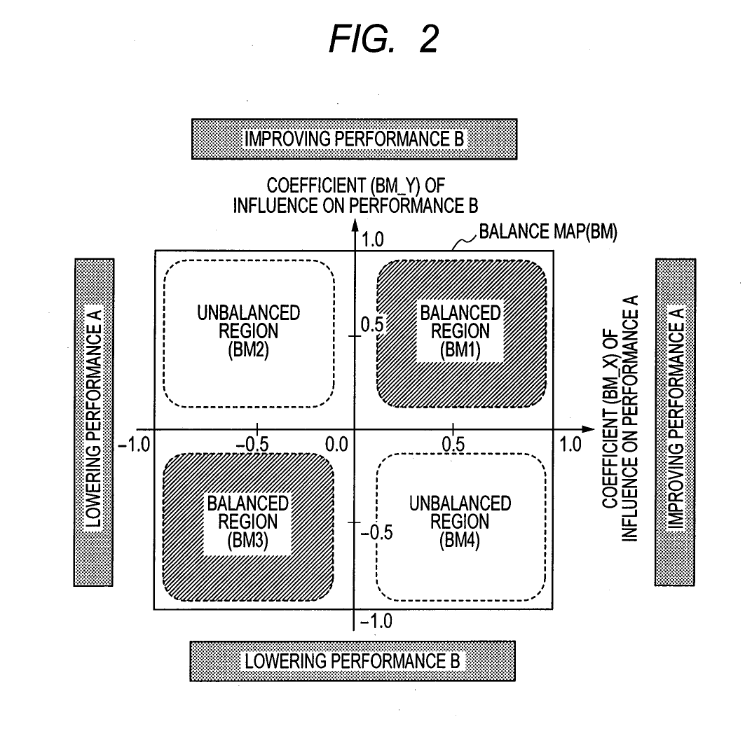

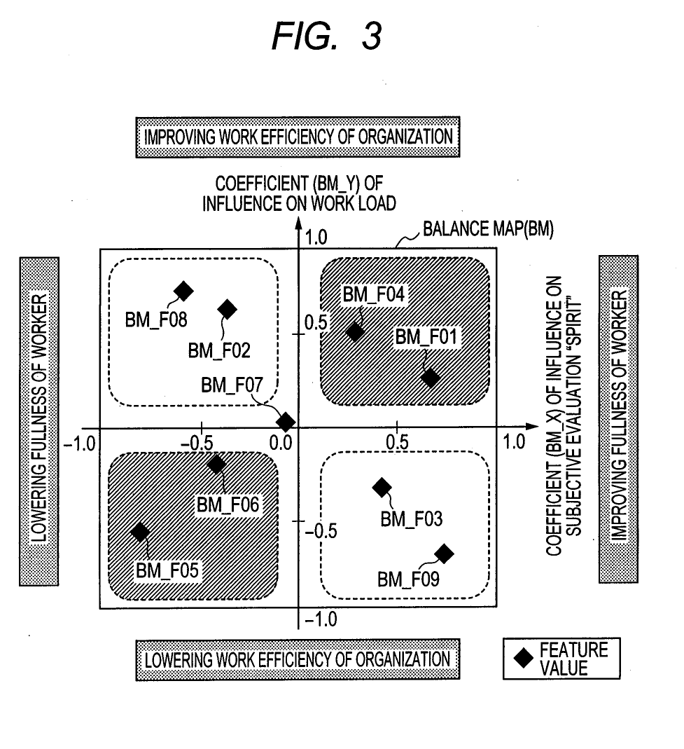

### <FIG. 2 and FIG. 3: Description of Balance Map>

FIG. 2 shows a diagram illustrating a representation form in the first exemplary embodiment. Incidentally, this representation form is called a balance map (BM). The balance map (BM) makes possible analysis for improvement of multiple performance elements, a problem that remains unsolved by the case shown in FIG. 9. This balance map (BM) is characterized by the use of a common combination of feature values for multiple performance elements and the note taken of the combination of positive and negative signs of coefficients of influence on each feature value. For the balance map (BM), the coefficient of influence on each feature value is calculated for multiple performance elements and plotted with the coefficient of influence for each performance element as the axis. FIG. 3 illustrates a case in which the result of calculation of each feature value is plotted where “fullness of worker” and “work efficiency of organization” are chosen as performance elements. An image in the form of FIG. 3 is displayed on the screen (CLDP).

Where multiple performance elements are to be improved, if there is no mutual conflict between the performance elements, the improvement will be easy. The reason is that, in the absence of mutual relation, measures to improve the performance elements can be implemented one at a time or, in the presence of positive mutual relation, improvement of one performance element will result in improvement of the other as well. However, if the performance elements conflict with each other, namely in the presence of negative mutual relation, improvement of duty performance will be the most difficult. The reason is that, if the presence of conflict remains as it is, there will be repetition of improvement of one performance element inviting deterioration of the other, making optimization of the whole duty performance impossible. Yet, very because of this circumstance, discovery of the conflicting factor of combined performance elements inviting such a conflict and elimination of the conflict would make an important contribution to the overall improvement of the duty performance. The present invention enables feature values constituting factors to invite conflict between performance elements and feature values that constitute factors to improve both performance elements to be classified and discovered by analyzing with common feature values combinations of performance elements highly likely to give rise to conflict. In this way, it is made possible to plan measures to eliminate conflict-inviting factors and achieve improvements to prevent conflict occurrence.

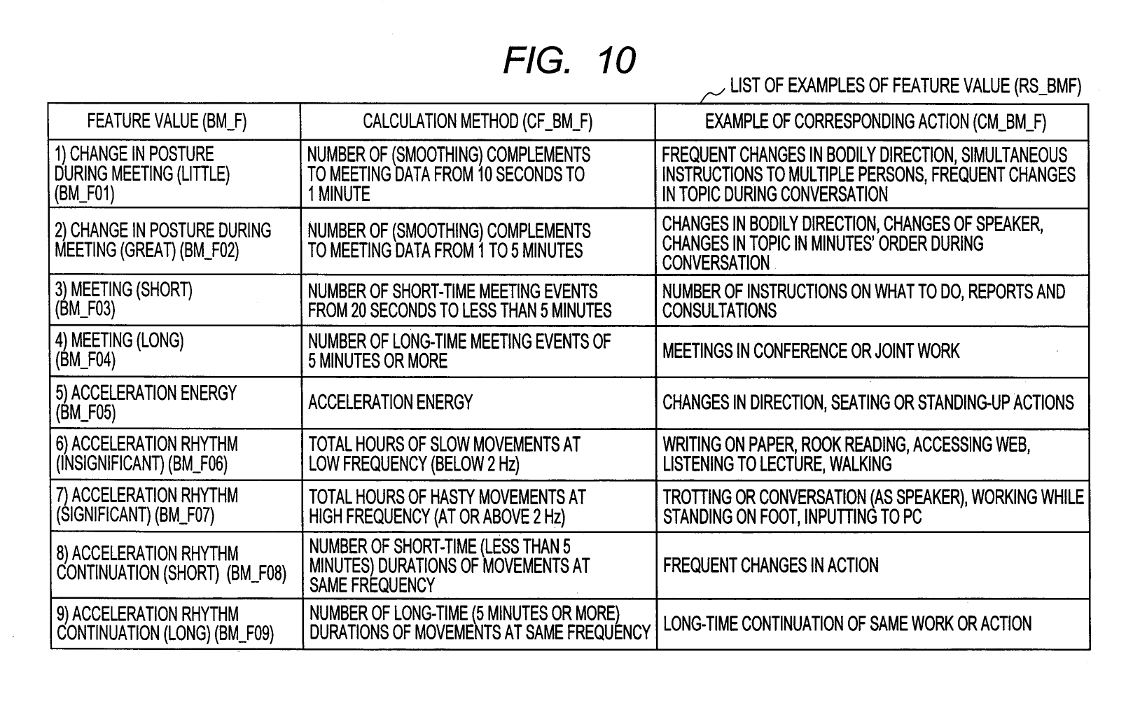

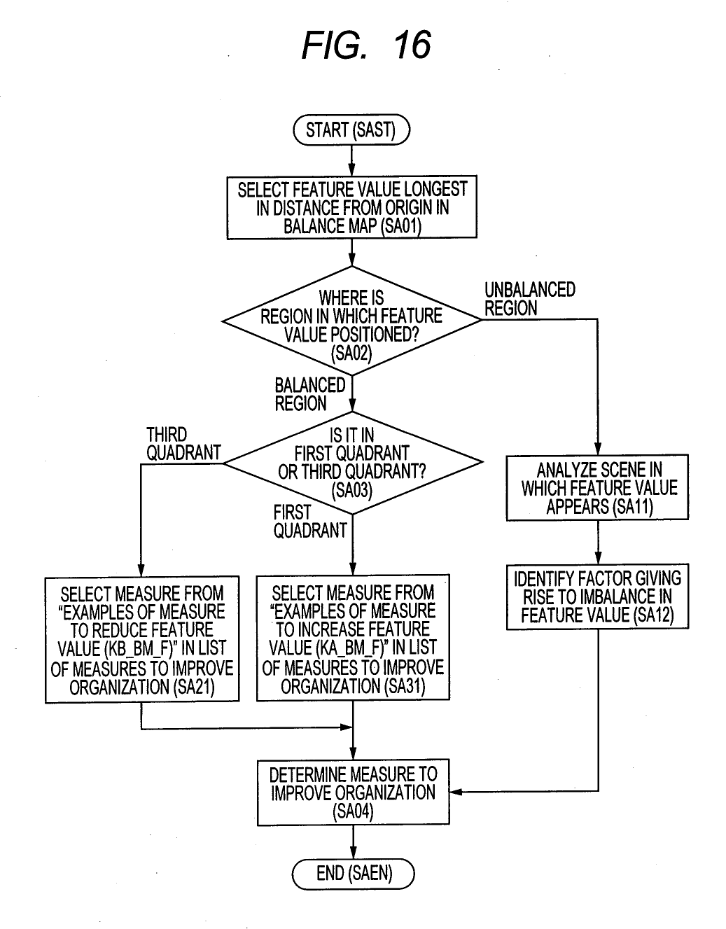

The feature value in this context is a datum regarding activities (movements and communication) of a member. An example of combinations of feature values (BMF01 through BMF09) used in FIG. 3 is shown in the table of FIG. 10 (RS_BMF). In the examples of FIG. 2 and FIG. 3, the coefficient of influence (BMX) on performance A is plotted along the axis of abscissas and the coefficient of influence (BMY) on performance B, along the axis of ordinates. Where the value (BM_X) along the X axis is positive, that feature value can be regarded as having a property to improve performance A, and where the value (BM_Y) along the Y axis is positive, it can be regarded as having a property to improve performance B. Further in respect of quadrants, the feature values in the first quadrant can be regarded as having a property to improve both performances, and those in the third quadrant can be regarded as having a property to reduce both performances. Further, the feature values in the second and fourth quadrants are known to improve one performance but to reduce the other, namely to be a factor to invite conflict. Therefore, for the sake of distinction in the balance map (BM), the first quadrant (BM1) and the third quadrant (BM3) are called balanced regions and the second quadrant (BM2) and the fourth quadrant (BM4) are called unbalanced regions. The reason is that the process of planning the measure for improvement differs with whether the noted feature value is in a balanced region or in an unbalanced region. A flow chart of measure planning is shown in FIG. 16.

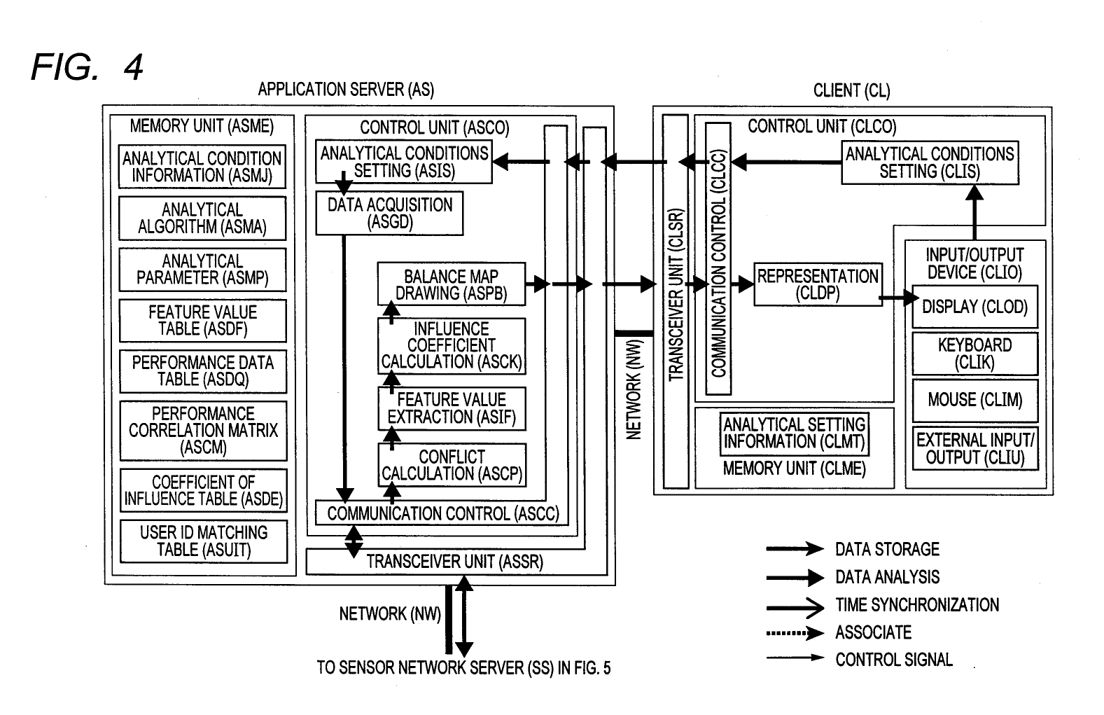

To add, this invention takes note of the combination of positive and negative coefficients of influence, wherein cases in which all are positive or all are negative are classified as balanced regions and all other cases, as unbalanced regions. For this reason, the invention can also be applied to three or more kinds of performance. For the convenience of two-dimensional illustration and description, this description and the drawings suppose that there are two kinds of performance.

<FIG. 4 through FIG. 6: Flow of Overall System>

FIG. 4 through FIG. 6 are block diagrams illustrative of the overall configuration of a sensor network system for realizing an organizational linkage display unit, which is an exemplary embodiment of the invention. Although blocks are separately shown for the convenience of illustration, the illustrated processing steps are executed in mutual linkage. At the terminal (TR), sensing data regarding the movements of and communication by the person wearing it are acquired, and the sensing data are stored into the sensor network server (SS) via the base station (GW). Also, the reply of the user (US) to a questionnaire and performance data, such as duty performance data, are stored by the client for performance inputting (QC) into the sensor network server (SS). Further, the sensing data and the performance data are analyzed in the application server (AS), and the balance map, which is the analytical result, is outputted to the client (CL). FIG. 4 through FIG. 6 illustrate this sequence of processing.

The five kinds of arrow differing in shape used in FIG. 4 through FIG. 6 respectively represent the flow of data or signals for time synchronization, associate, storage of acquired data, data analysis and control signals.

### <FIG. 4: Overall System (1) (CL•AS)>

### <On Client (CL)>

The client (CL), serving as the point of contact with the user (US), inputs and outputs data. The client (CL) is provided with an input/output unit (CLIO), a transceiver unit (CLSR), a memory unit (CLME) and a control unit (CLCO).

The input/output unit (CLIO) is a part constituting an interface with the user (US). The input/output unit (CLIO) has a display (CLOD), a keyboard (CLIK), a mouse (CLIM) and so forth. Another input/output unit can be connected to the external input/output (CLIO) as required.

The display (CLOD) is an image display unit such as a CRT (cathode-ray tube) or a liquid crystal display. The display (CLOD) may include a printer or the like.

The transceiver unit (CLSR) transmits and receives data to and from the application server (AS) or the sensor network server (SS). More specifically, the transceiver unit (CLSR) transmits analytical conditions to the application server (AS) and receives analytical results, namely a balance map (BM).

The memory unit (CLME) is configured of an external recording unit, such as a hard disk, a memory or an SD card. The memory unit (CLME) records information required for graphics drawing, such as analytical setting information (CLMT). The analytical setting information (CLMT) records the member set by the user (US) as the object of analysis, analytical conditions and so forth, and also records information regarding visual images received from the application server (AS), such as information on the size of the image and the display position of the screen. Further, the memory unit (CLME) may store programs to be executed by a CPU (not shown) of the control unit (CLCO).

The control unit (CLCO), provided with a CPU (not shown), executes control of communication, inputting of analytical conditions from the user (US) and, representation (CLDP) for presenting analytical results to the user (US). More specifically, the CPU executes processing including communication control (CLCC), analytical conditions setting (CLIS) and representation (CLDP) by executing programs stored in the memory unit (CLME).

The communication control (CLCC) controls the timing of wired or wireless communication with the application server (AS) or the sensor network server (SS). Also, the communication control (CLCC) converts the data form and assigns different destinations according to the type of data.

The analytical conditions setting (CLIS) receives analytical conditions designated by the user (US) via the input/output unit (CLIO), and records them into the analytical setting information (CLMT) of the memory unit (CLME). Here, the period of data, member, type of analysis and parameters for analysis are set. The client (CL) requests analysis by transmitting these settings to the application server (AS).

The representation (CLDP) outputs to an output unit, such as the display (CLOD), the balance map (BM) as shown in FIG. 3, which is an analytical result acquired from the application server (AS). Then, if an instruction regarding the method of representation, such as the designated size and/or position of representation, is given from the application server (AS) together with the visual image, representation will be done accordingly. It is also possible for the user (US) to make fine adjustment of the size and/or position of the image with an input unit, such as a mouse (CLIM).

Also, instead of receiving the analytical result as a visual image, only the numerical count of the coefficient of influence of each feature value in the balance map may be received, and a visual image may be formed on the client (CL) according to those numerical counts. In this way, the quantity of transmission via the network between the application server (AS) and the client (CL) can be saved.

### <On Application Server (AS)>

The application server (AS) processes and analyzes sensing data. At the request of the client (CL) or automatically at a set point of time, an analytical application is actuated. The analytical application sends a request to the sensor network server (SS), and acquires needed sensing data and performance data. Further, the analytical application analyzes the acquired data and return the result of analysis to the client (CL). Or the visual image or the numerical count of the numerical count analytical result may as well be recorded as it is into a memory unit (ASME) within the application server (AS).

The application server (AS) is provided with a transceiver unit (ASSR), the memory unit (ASME) and a control unit (ASCO).

The transceiver unit (ASSR) transmits and receives data from or to the sensor network server (SS) and the client (CL). More specifically, the transceiver unit (ASSR)) receives a command sent from the client (CL) and transmits to the sensor network server (SS) a request for data acquisition. Further, the transceiver unit (ASSR) receives sensing data and/or performance data from the sensor network server (SS) and transmits the visual image or the numerical count of the analytical result to the client (CL).

The memory unit (ASME) is configured of an external recording unit, such as a hard disk, a memory or an SD card. The memory unit (ASME) stores conditions of setting for analysis and analytical result or data being analyzed. More specifically, the memory unit (ASME) stores analytical conditions information (ASMJ), an analytical algorithm (ASMA), an analytical parameter (ASMP), a feature value table (ASDF), a performance data table (ASDQ), a coefficient-of-influence table (ASDE), an ID performance correlation matrix (ASCM) and a user-ID matching table (ASUIT).

The analytical conditions information (ASMJ) temporarily stores conditions and settings for the analysis requested by the client (CL).

The analytical algorithm (ASMA) records programs for carrying out analyses. In the case of this embodiment, it records programs for performing conflict calculation (ASCP), feature value extraction (ASIF), coefficient of influence calculation (ASCK), balance map drawing (ASPB) and so forth. In accordance with analytical conditions stated in the request from the client (CL), an appropriate program is selected from the analytical algorithm (ASMA), and the analysis is executed in accordance with that program.

The analytical parameter (ASMP) records, for instance, values to serve as references for feature values in the feature value extraction (ASIF) and parameters including the intervals and period of sampling the data to be analyzed. When the parameters are to be altered at the request of the client (CL), the analytical parameter (ASMP) is rewritten.

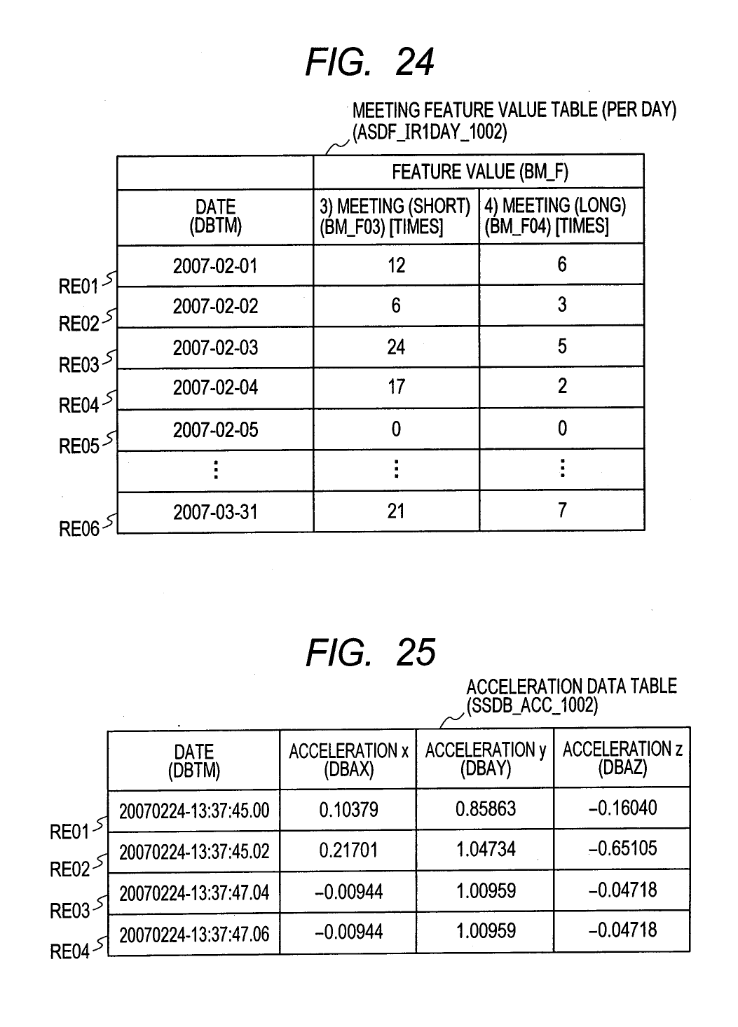

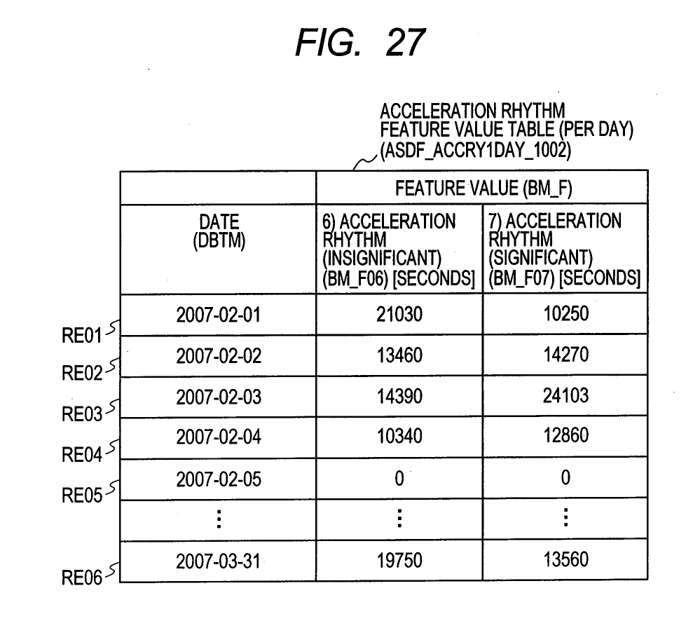

The feature value table (ASDF) is a table for storing the values of results of extracting multiple kinds of feature value from sensing data, the values being linked with the time or date information of the data used. It is composed of a table of text data or a database table. This is prepared by the feature value extraction (ASIF) and stored into the memory unit (ASME). Examples of the feature value table (ASDF) are shown in FIG. 24 and FIG. 27.

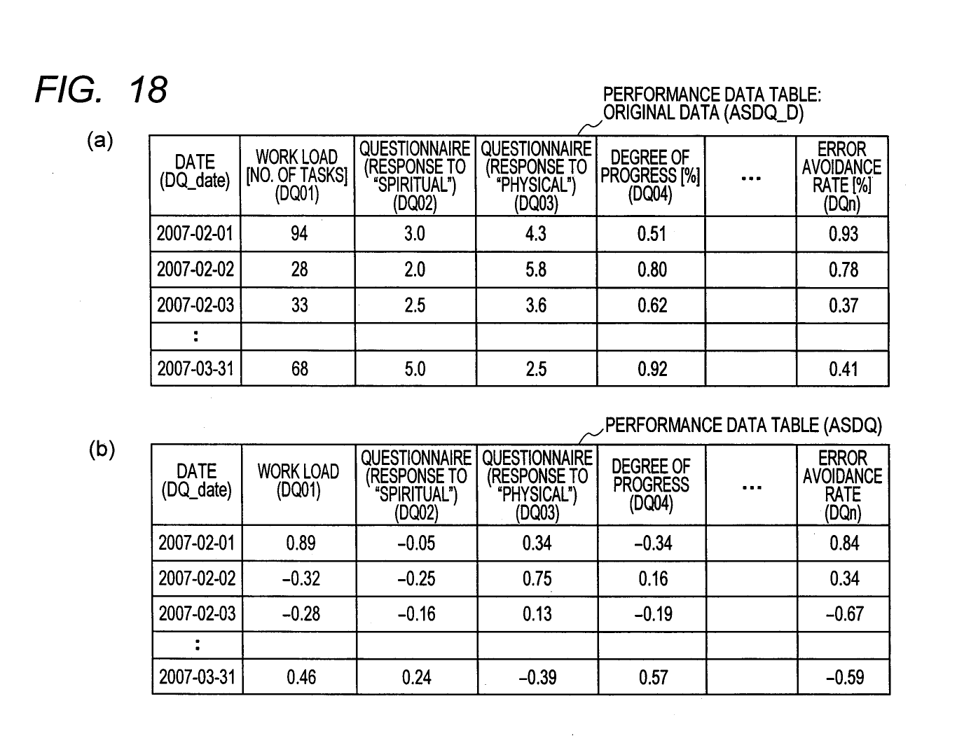

The performance data table (ASDQ) is a table for storing performance data, the data being linked with the time or date information of the data used. It is composed of a table of text data or a database table. This stores each set of performance data obtained from the sensor network server (SS), the data having undergone pretreatment, such as conversion into standardized Z-score, for use in the conflict calculation (ASCP). For conversion into Z-score, Equation (2) is used. An example of the performance data table (ASDQ) is shown in FIG. 18 (a). An example of the original performance data table (ASDQ_D) before conversion into Z-score is shown in FIG. 18 (b). In the original data, the unit of the work load value, for instance, is [the number of tasks] and the range of the value is from 0 through 100, while the range of the responses to the questionnaire is from 1 through 6 with no qualifying unit, resulting in a difference in the characteristics of the distribution of data series. For this reason, the date value of each set of performance data is converted by Equation (2) into Z-score, differentiated by the data type, namely for each column of the original data table (ASDQD). As a result, the distribution of each set of performance data in the standardized table (ASDQ) is unified into an average of 0 and a variance of 1. For this reason, in the multiple regression analysis in the subsequent influence coefficient calculation (ASCK), the relative levels of the values of the coefficient of influence on the different sets of performance data can be compared.

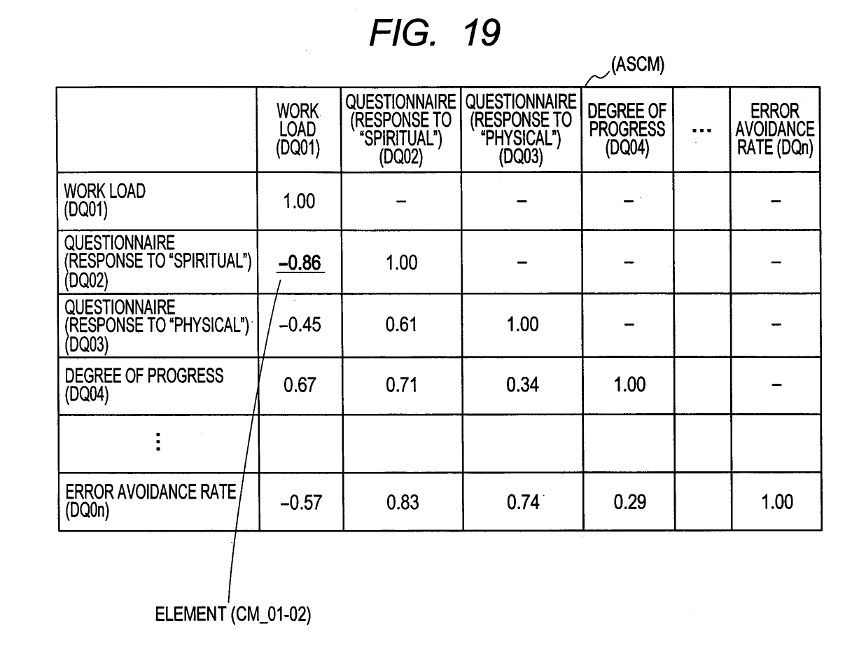

The performance correlation matrix (ASCM) is a table for storing the closeness levels of relation among performance elements, for instance, coefficients of correlation, in the performance data table (ASDQ) in the conflict calculation (ASCP). It is composed of a table of text data or a database table, an example of which is shown FIG. 19. In FIG. 19, the results of figuring out the coefficients of correlation with regard to all the combinations of performance data in the columns of FIG. 18 are stored in the respectively corresponding elements of the table. The coefficients of correlation between the work load (DQ01) and the questionnaire (response to “spiritual”) (DQ02), for instance, are stored in the element (CM_01-02) of the performance correlation matrix (ASCM).

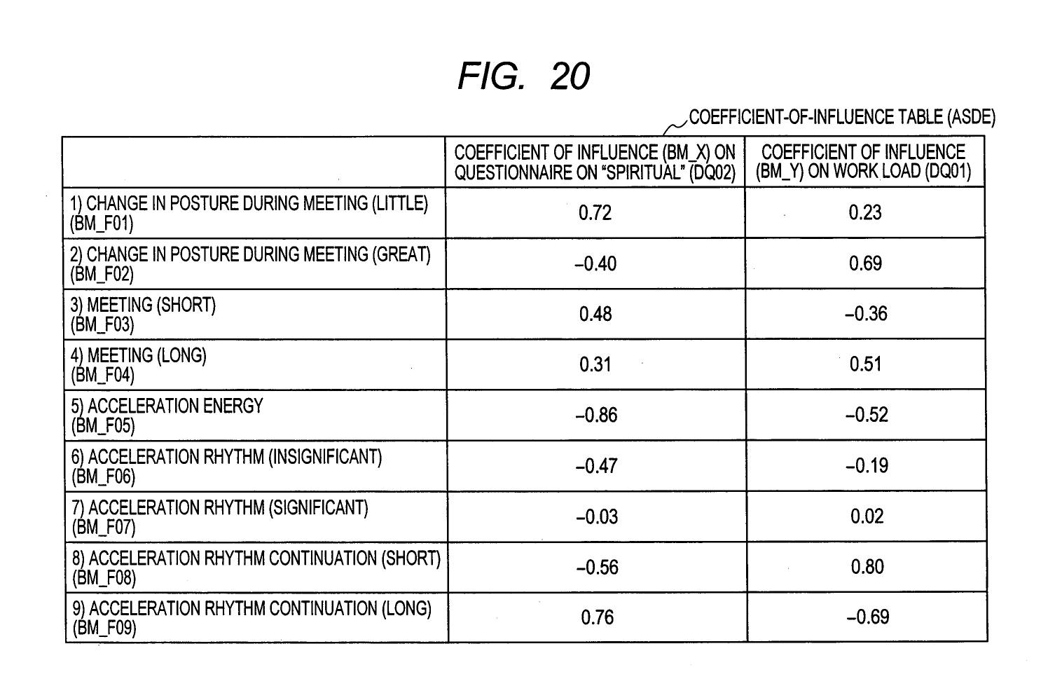

The coefficient-of-influence table (ASDE) is a table for storing the numerical counts of coefficient of influence of different feature values calculated by the coefficient of influence calculation (ASCK). It is composed of a table of text data or a database table, an example of which is shown FIG. 20. In the coefficient of influence calculation (ASCK), the numerical count of each of feature values (BMF01 through BMF09) is substituted as an explanatory variable and a performance datum (DQ02 or DQ01) is substituted as the object variable by the method of Equation (1), and a partial regression coefficient matching each feature value is figured out. The storage of these partial regression coefficients as coefficients of influence is the coefficient-of-influence table (ASDE).

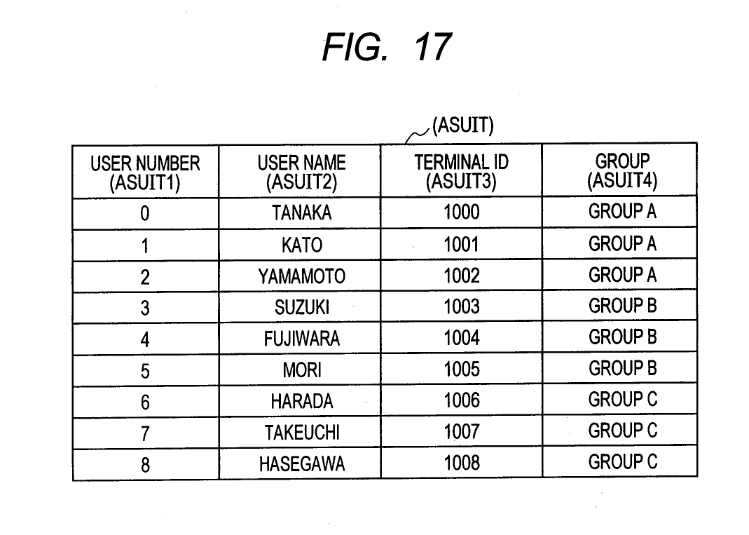

The user-ID matching table (ASUIT) is a table for collating the IDs of terminals (TR) with the names, user number and affiliated groups of the users (US) wearing the respective terminals. If so requested by the client (CL), the name of a person is added to the terminal ID of the data received from the sensor network server (SS). When only the data on persons matching a certain attribute are to be used, in order to convert the names of the persons into terminal IDs and to transmit a request for acquisition of the data to the sensor network server (SS), the user-ID matching table (ASUIT) is referenced. An example of the user-ID matching table (ASUIT) is shown in FIG. 17.

The control unit (ASCO), provided with a CPU (not shown), executes control of data transmission and reception and analysis of data. More specifically, the CPU (not shown) executes processing including communication control (ASCC), analytical conditions setting (ASIS), data acquisition (ASGD), conflict calculation (ASCP), feature value extraction (ASIF), coefficient of influence calculation (ASCK), and balance map drawing (ASPB) by executing programs stored in the memory unit (ASME).

The communication control (ASCC) controls the timing of wired or wireless communication with the sensor network server (SS) and client data (CL). Also, the communication control (ASCC) appropriately converts the data form or assigns different destinations according to the type of data.

The analytical conditions setting (ASIS) receives analytical conditions designated by the user (US) via the client (CL), and records them into the analytical conditions information (ASMJ) of the memory unit (ASME).

The data acquisition (ASGD) requests in accordance with the analytical conditions information (ASMJ) the sensor network server (SS) for sensing data and performance data regarding activities of the user (US), and receives the returned data.

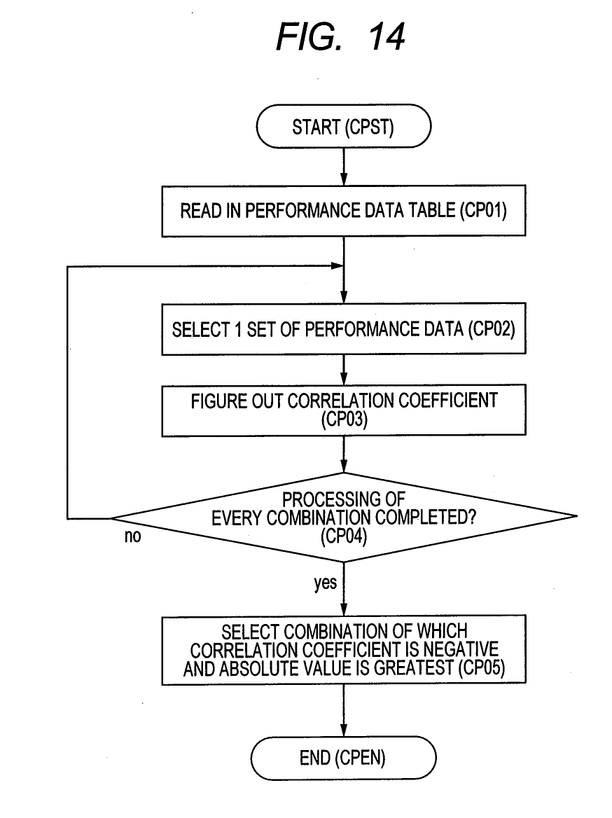

The conflict calculation (ASCP) is a calculation to find out a performance data combination which particularly needs conflict resolution out of many combinations of performance data. Here, analysis is so carried out as to select a set of performance data particularly like to be in conflict, and to plot the set against the two axes of the balance map. A flow chart of the conflict calculation (ASCP) is shown in FIG. 14. The result of the conflict calculation (ASCP) is outputted to the performance correlation matrix (ASCM).

The feature value extraction (ASIF) is a calculation to extract from data such as sensing data or a PC log regarding activities of the user (US) data of a pattern satisfying certain standards. For instance, the number of times the pattern emerged per day is counted, and outputted every day. Multiple types of feature values are used, and what type of feature value should be used for analysis is set by the user (US) in the analytical conditions setting (CLIS). As the algorithm for each attempt of feature value extraction (ASIF), the analytical algorithm (ASMA) is used. The extracted count of the feature value is stored into the feature value table (ADIF).

The coefficient of influence calculation (ASCK) is processing to figure out the strengths of influences of each feature value on two types of performance. The numerical counts of a pair of coefficients of influence on each feature value are thereby obtained. In the processing of this calculation, correlation calculation or multiple regression analysis is used. The coefficients of influence are stored into the coefficient-of-influence table (ASDE).

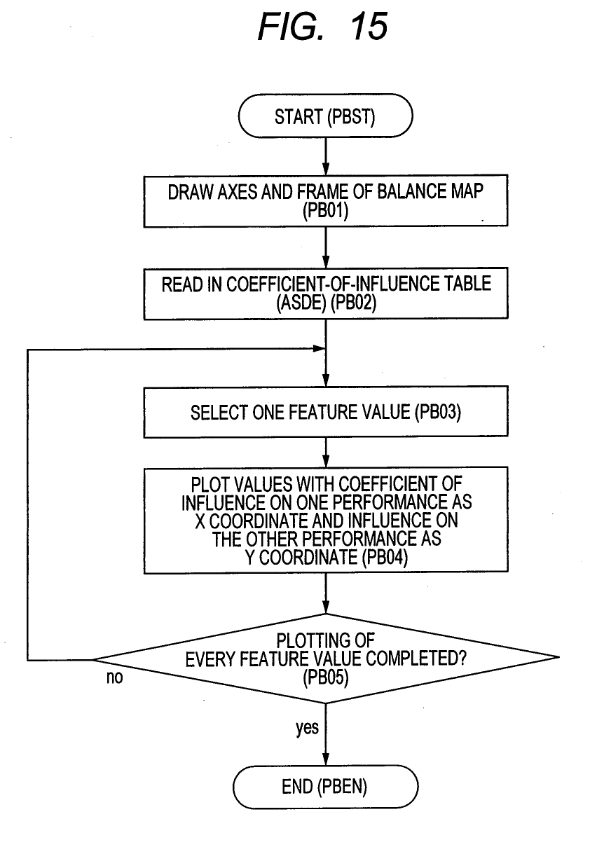

The balance map drawing (ASPB) plots the counts of the coefficients of influence of different feature values, prepares a visual image of a balance map (BM) and sends it to the client (CL). Or it may calculate the values of coordinates for plotting and transmit to the client (CL) only the minimum needed data including those values and colors. The flow chart of the balance map drawing (ASPB) is shown in FIG. 15.

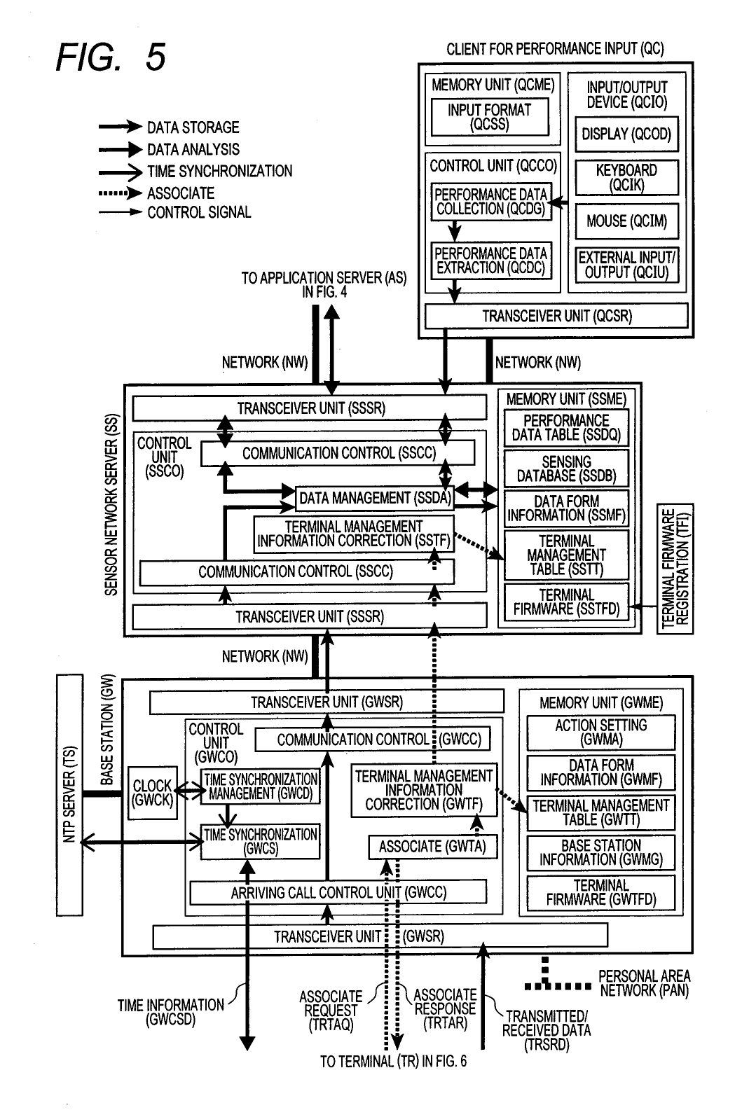

### <FIG. 5: Flow Chart 2) (SS•GW•QC)>

FIG. 5 shows the configuration of the sensor network server (SS), the client for performance inputting (QC) and the base station (GW) in one exemplary embodiment.

### <On Server (SS)>

The sensor network server (SS) manages data collected from all the terminals (TR). More specifically, the sensor network server (SS) stores sensing data sent from the base station (GW) into a sensing database (SSDB), and transmits sensing data in accordance with requests from the application server (AS) and the client (CL). Also, the sensor network server (SS) stores into a performance database (SSDQ) performance data sent from the client for performance inputting (QC), and transmits performance data in response to requests from the application server (AS) and the client (CL). Furthermore, the sensor network server (SS) receives a control command from the base station (GW), and returns to the base station (GW) the result obtained from that control command.

The sensor network server (SS) is provided with a transceiver unit (SSSR), a memory unit (SSME) and a control unit (SSCO). When time synchronization management (not shown) is executed by the sensor network server (SS) instead of the base station (GW), the sensor network server (SS) also requires a clock.

The transceiver unit (SSSR) transmits and receives data to and from the base station (GW), the application server (AS), the client for performance inputting (QC) and the client (CL). More specifically, the transceiver unit (SSSR) receives sensing data sent from the base station (GW) and performance data sent from the client for performance inputting (QC), and transmits the sensing data and the performance data to the application server (AS) or the client (CL).

The memory unit (SSME), configured of a data storing unit, such as a hard disk, stores at least stores a performance data table (SSDQ), the sensing database (SSDB), data form information (SSMF), a terminal management table (SSTT) and terminal firmware (SSTFD). The memory unit (SSME) may further store programs to be executed by the CPU (not shown) of the control unit (SSCO).

The performance data table (SSDQ) is a database for recording, connected with the time or date data, subjective evaluations by the user (US) inputted by the client for performance inputting (QC) and performance data concerting duty performance data.

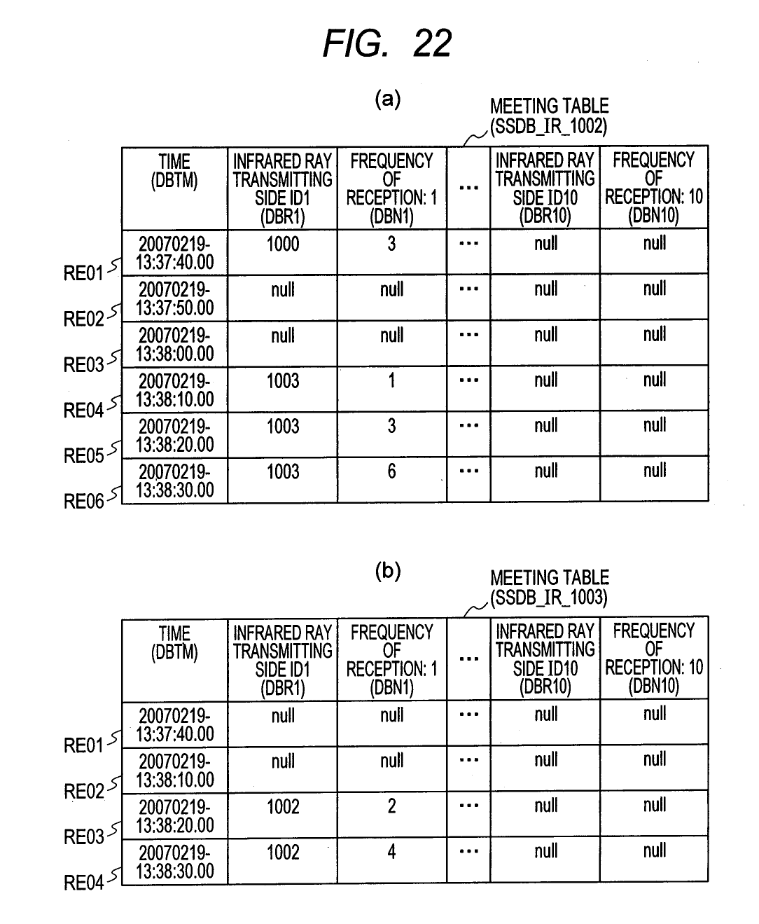

The sensing database (SSDB) is a database for storing sensing data acquired by different terminals (TR), information on the terminals (TR), and information on the base station (GW) which sensing data transmitted from the terminals (TR) have passed. Data are managed in columns each formed for a different data element, such as acceleration or temperature. Or a separate table may as well be prepared for each data element. Whichever the case may be, all the data are managed with terminal information (TRMT), which is the ID of the terminal (TR) of acquisition, and information on the time of acquisition being related to each other. Specific examples of meeting data table and acceleration data table in the sensing database (SSDB) are respectively shown in FIG. 22 and FIG. 25.

The data form information (SSMF) records the data form for communication, the method of separating the sensing data tagged by the base station (GW) and recording the same into the database, the method of responding to a request for data and so forth. After the reception of data and before the transmission of data, this data form information (SSMF) is referenced, and data form conversion and data distribution are carried out.

The terminal management table (SSTT) is a table in which what terminals (TR) are currently managed by the base station (GW) is recorded. When any other terminal (TR) is newly added to the management of the base station (GW), the terminal management table (SSTT) is updated.

The terminal firmware (SSTFD) stores programs for operating terminals. When any terminal firmware registration (TFI) is done, the terminal firmware (SSTFD) is updated, and this program is sent to the base station (GW) via the network (NW) and further to the terminal (TR) via a personal area network (PAN).

The control unit (SSCO), provided with a CPU (not shown), controls transmission and reception of sensing data and recording and retrieval of the same into or out of the database. More specifically, execution by the CPU of a program stored in the memory unit (SSME) causes such processing as communication control (SSCC), terminal management information correction (SSTF) and data management (SSDA) to be executed.

The communication control (SSCC) controls the timing of wired or wireless communication with the base station (GW), the application server (AS), the client for performance inputting (QC) and the client (CL). Also, the communication control (SSCC) converts, on the basis of the data form information (SSMF) recorded in the memory unit (SSME), the data form to be transmitted or received into the data form in the sensor network server (SS) of a data form tailored to the partner in each communication attempt. Further, the communication control (SSCC) reads the header part indicating the data type and assigns the data to the corresponding processing unit. More specifically, the received sensing data and performance data are assigned to the data management (SSDA), and a command to correct terminal management information is assigned to the terminal management information correction (SSTF). The destination of the data to be transmitted is determined to be the base station (GW), the application server (AS), the client for performance inputting (QC) or the client (CL).

The terminal management information correction (SSTF), when it has received from the base station (GW) a command to correct terminal management information, updates the terminal management table (SSTT).

The data management (SSDA) manages correction, acquisition and addition of data in the memory unit (SSME). For instance, sensing data are recorded by the data management (SSDA) into an appropriate column in the database, classified by data element based on tag information. Also when sensing data are read out, necessary data are selected and rearranged in the chronological order or otherwise processed on the basis of time information and terminal information.

### <On Client for Performance Inputting (QC)>

The client for performance inputting (QC) is a unit for inputting subjective evaluation data and performance data, such as duty performance data. Provided with input units such as buttons and a mouse and output units such as a display and a microphone, it presents an input format (QCSS) and causes a value and a response to be inputted. Or it may be caused to automatically acquire duty performance data or an operation log in another PC on the network. The client for performance inputting (QC) may use the same personal computer as the client (CL), the application server (AS) or the sensor network server (SS), or may as well use the terminal (TR). Also, instead of having the user (US) directly operate the client for performance inputting (QC), replies written on a paper form can be collected by an agent, who then inputs them from the client for performance inputting (QC).

The client for performance inputting (QC) is provided with an input/output unit (QCIO), a memory unit (QCME), a control unit (QCCC) and a transceiver unit (QCSR).

The input/output unit (QCIO) is a part constituting an interface with the user (US). The input/output unit (QCIO) has a display (QCOD), a keyboard (QCIK), a mouse (QCIM) and so forth. Another input/output unit can be connected to the external input/output (QCIU) as required. When the terminal (TR) is to be used as the client for performance inputting (QC), buttons (BTN1 through 3) are used as input units.

The display (QCOD) is an image display unit such as a CRT (cathode-ray tube) or a liquid crystal display. The display (QCOD) may include a printer or the like. Also, where performance data are to be automatically acquired, an output unit such as the display (QCOD) can be dispensed with.

The memory unit (QCME) is configured of an external recording unit, such as a hard disk, a memory or an SD card. The memory unit (QCME) stores information in the input format (QCSS). Where the user (US) is to do inputting, the input format (QCSS) is presented to the display (QCOD) and reply data to that question are acquired from an input unit such as the keyboard (QCIK). As required, the input format (QCSS) may be altered in accordance with a command from the sensor network server (SS).

The control unit (QCCC) collects performance data inputted from the keyboard (QCIK) or the like by performance data collection (QCDG), and in performance data extraction (QCDC) further connects each set of data with the terminal ID or name of the user (US) having given it as the reply to adjust the form of the performance data. The transceiver unit (QCSR) transmits the adjusted performance data to the sensor network server (SS).

### <On Base Station (GW)>

The base station (GW) has the role of intermediating between the terminal (TR) and the sensor network server (SS). Multiple base stations (GW) are arranged in consideration of the reach of wireless signals so as to cover areas in the residential rooms, work places and so forth.

the base station (GW) is provided with a transceiver unit (GWSR), a memory unit (GWME) and a control unit (GWCO). When time synchronization management (not shown) is executed by the sensor network server (SS) instead of the base station (GW), the sensor network server (SS) also requires a clock.

The transceiver unit (GWSR) receives wireless communication from the terminal (TR) and performs wired or wireless transmission to the base station (GW). When wire communication is to be done, the transceiver unit (GWSR) is provided with an antenna for receiving wireless signals. It also communicates with the sensor network server (SS).

The memory unit (GWME) is configured of an external recording unit, such as a hard disk, a memory or an SD card. The memory unit (GWME) stores action setting (GWMA), the data form information (GWMF), terminal management table (GWTT), base station information (GWMG) and terminal firmware (GWTFD). The action setting (GWMA) includes information indicating the method of operating the base station (GW). The data form information (GWMF) includes information indicating the data form for communication and information required for tagging sensing data. The terminal management table (GWTT) includes the terminal information (TRMT) on the terminals (TR) under its management currently associated successfully and local IDs distributed to manage those terminals (TR). The base station information (GWMG) includes information such as the own address of the base station (GW). The terminal firmware (GWTFD) stores a program for operating the terminals and, when the terminal firmware is to be updated, receives the new terminal firmware from the sensor network server (SS), and transmits it to the terminals (TR) via the personal area network (PAN).

The memory unit (GWME) may further store programs to be executed by the CPU (not shown) of the control unit (GWCO).

The clock (GWCK) holds time information. That time information is updated at regular intervals. More specifically, the time information of the clock (GWCK) is updated with time information acquired from NTP (Network Time Protocol) server (TS) at regular intervals.

The control unit (GWCO) is provided with a CPU (not shown). By having the CPU execute a program stored in the memory unit (GWME), it manages the timing of reception of sensing data from the terminal (TR), processing of the sensing datum, the timing of transmission and reception to and from the terminal (TR) and the sensor network server (SS) and the timing of time synchronization. More specifically, by having the CPU execute the program stored in the memory unit (GWME), it executes processing including communication control unit (GWCC), associate (GWTA), time synchronization management (GWCD) and time synchronization (GWCS).

The communication control unit (GWCC) controls the timing of wireless or wired communication with the terminal (TR) and the sensor network server (SS). The communication control unit (GWCC) also distinguishes the types of received data. More specifically, the communication control unit (GWCC) distinguishes whether the received data are common sensing data, data for associate, a response to time synchronization or the like, and delivers the sets of date to the respectively appropriate functions.

The associate (GWTA), in response to associate requests (TRTAQ) sent from terminals (TR), gives an associate response (TRTAR) by which an allocated local ID is transmitted to each terminal (TR). When an associate is established, the associate (GWTA) performs terminal management information correction (GWTF) to correct the terminal management table (GWTT).

The time synchronization management (GWCD) controls the intervals and timing of executing time synchronization, and issues an instruction to perform time synchronization. Or by having the control unit (SSCO) of the sensor network server (SS) execute time synchronization management (not shown), the sensor network server (SS) may as well send a coordinated instruction to every base station (GW) in the system.

The time synchronization (GWCS), connected to an NTP server (TS) on the network, requests for and acquires time information. The time synchronization (GWCS) corrects the clock (GWCK) on the basis of the acquired time information. And the time synchronization (GWCS) transmits an instruction of time synchronization and time information (GWCSD) to the terminal (TR).

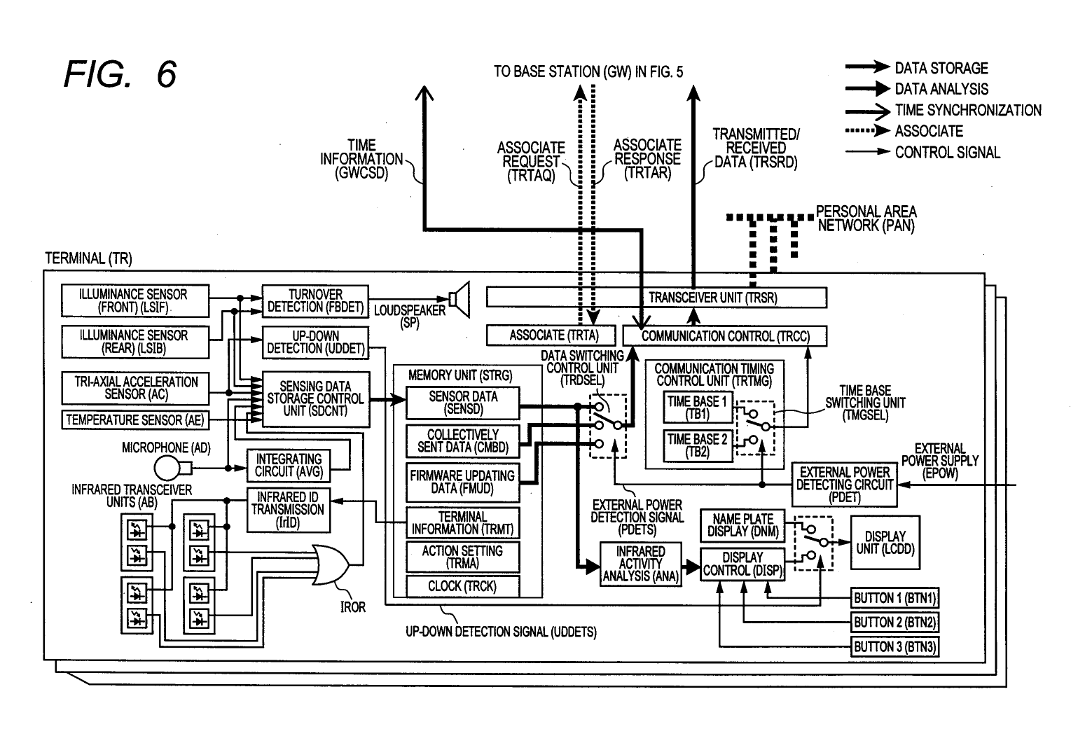

### <FIG. 6: Overall System (3) (TR)>

FIG. 6 shows the configuration of the terminal (TR), which is one example of sensor node. Here, the terminal (TR) is shaped like a name plate and is supposed to be hung from the person's neck, but this is only one example and may be shaped differently. In many cases, multiple terminals (TR) are present in this series of systems, and worn by persons belonging to the organization. The terminal (TR) is mounted with multiple infrared ray transceivers (AB) for detecting the meeting situation of the person and various sensors including a tri-axial acceleration sensor (AC) for detection actions of the wearer, a microphone (AD) for detecting the wearer's speech and surrounding sounds, illuminance sensors (LS1F, LS1B) for detecting the front and rear faces of the terminal and a temperature sensor (AE). These mounted sensors are mere examples, but other sensors may as well be used for detecting the meeting situation and actions of the wearer.

In this exemplary embodiment, four infrared ray transceivers are mounted. The infrared ray transceivers (AB) keep on regularly transmitting in the forward direction the terminal information (TRMT), which is information to uniquely identify the terminal (TR). If a person wearing another terminal (TR) is positioned substantially in front (e.g. right in front or obliquely in front), the terminal (TR) and the other terminal (TR) exchanged each other's terminal information (TRMT) by infrared rays. In this way, it can be recorded who and who are meeting each other.

Each infrared ray transceiver is generally configured of a combination of infrared ray emitting diodes for infrared ray transmission and an infrared ray phototransistors. An infrared ray ID transmitter unit (IrID) generates the terminal information (TRMT), which is its own ID, and transfers it to the infrared ray emitting diode of an infrared ray transceiver module. In this exemplary embodiment, all the infrared ray emitting diodes are turned on simultaneously by transmitting the same data to multiple infrared ray transceiver modules. Obviously, different sets of data may as well be outputted each at its own timing.

Further, data received by the infrared ray phototransistor of the infrared ray transceivers (AB) are subjected to OR operation by an OR circuit (IROR). Thus, at least any one infrared ray receiving unit has optically received an ID, that ID is recognized by the terminal as such. Obviously, the configuration may have multiple independent ID receiver circuits. In this case, since the transmitting/receiving state of each infrared ray transceiver module can be grasped, it is possible to obtain additional information, regarding, for instance, the direction of the presence of the opposite terminal.

Sensing data (SENSD) detected by a sensor is stored into a memory unit (STRG) by a sensing data storage control unit (SDCNT). The sensing data (SENSD) are converted into a transmission packet by a communication control unit (TRCC) and transmitted to the base station (GW) by a transceiver unit (TRSR).

What then takes out the sensing data (SENSD) from the memory unit (STRG) and determines the timing of wireless or wired transmission is a communication timing control unit (TRTMG). The communication timing control unit (TRTMG) has multiple time bases to determine multiple timings.

The data to be stored in the memory unit include, in addition to the sensing data (SENSD) currently detected by sensors, collectively sent data (CMBD) accumulated previously and firmware updating data (FMUD) for updating firmware which is the operation program for terminals.

The terminal (TR) in this exemplary embodiment detects connection of external power supply (EPOW) with an external power connection detecting circuit (PDET), and generates an external power detection signal (PDETS). A time base switching unit (TMGSEL) that switches in response to the external power detection signal (PDETS) the transmission timing generated by a communication control unit (TRTMG) or a data switching unit (TRDSEL) that switches data communicated wirelessly is unique to the configuration of this terminal (TR). FIG. 6 shows, as one example, a configuration in which the time base switching unit (TMGSEL) switches, in response to the external power detection signal (PDETS), transmission timing and two time bases including a time base 1 (TB1) and a time base 2 (TB2), and a configuration in which the data switching unit (TRDSEL) switches, in response to the external power detection signal (PDETS), data to be communicated according to the sensing data (SENSD) obtained from sensors, the collectively sent data (CMBD) accumulated previously and firmware updating data (FIRMU).

The illuminance sensors (LS1F, LS1B) are mounted respectively on the front and rear faces of the terminal (NN). The data acquired by the illuminance sensors (LS1F, LS1B) are stored into the memory unit (STRG) by the sensing data storage control unit (SDCNT) and, at the same time, compared by a turnover detection unit (FBDET). When the name plate is properly worn, the illuminance sensor (LS1F) mounted on the front face receives external light and the illuminance sensor (LS1B) mounted on the rear face, as it comes into a position between the terminal proper and its wear, receives no external light. Then, the illuminance detected by the illuminance sensor (LS1F) takes on a higher value than the illuminance detected by the illuminance sensor (LS1B). On the other hand, when the terminal (TR) is turned over, as the illuminance sensor (LS1B) receives external light and the illuminance sensor (LS1F) faces the wearer, the illuminance detected by the illuminance sensor (LS1B) takes on a higher value than the illuminance detected by the illuminance sensor (LS1F).

Here, by comparing the illuminance detected by the illuminance detected by the illuminance sensor (LS1F) and the illuminance detected by the illuminance sensor (LS1B) with the turnover detection unit (FBDET), the turnover and improper wearing of the name plate node can be detected. When a turnover is detected by the turnover detection unit (FBDET), a loudspeaker (SP) sounds an alarm to notify the wearer.

The microphone (AD) acquires voice information. By the voice information, the surrounding condition can be known, such as whether it is “noisy” or “quiet”. By acquiring and analyzing human voice, communication in meeting can be analyzed as to whether communication is active or standing, mutual conversation is taking place on an equal footing or one part is talking unilaterally or the person or persons are angry or laughing. Furthermore, a meeting situation which the infrared transceivers (AB) were unable to detect on account of the persons' standing positions or any other reason can be supplemented with voice information and acceleration information.

The voice acquired by the microphone (AD) includes both the audio waveform and signals resulting from its integration by an integrating circuit (AVG). The integrated signals represent the energy of the acquired voice.

The tri-axial acceleration sensor (AC) detects any acceleration of the node, namely any movement of the node. For this reason, the vigor of the movement or the behavior, such as walking, of the person wearing the terminal (TR) can be analyzed from the acceleration data. Furthermore, by comparing the degrees of acceleration detected by multiple terminals, the level of activity of communication between the wears of those terminals, their rhythms and correlation between them can be analyzed.

In the terminal (TR) of this exemplary embodiment, the data acquired by the tri-axial acceleration sensor (AC) are stored by the sensing data storage control unit (SDCNT) into the memory unit (STRG) and, at the same time, the direction of its name plate is detected by an up-down detection circuit (UDDET). Herein, the acceleration detected by the tri-axial acceleration sensor (AC) utilizes observation of two kinds of acceleration, including dynamic variations of acceleration due to the wearer's movements and static acceleration due to the acceleration by the gravity of the earth.

A display unit (LCDD), when the terminal (TR) is worn on the chest, displays the wearer's personal information including his affiliation and name. Thus, it behaves as a name plate. On the other hand, when the wearer holds the terminal (TR) in his hand and directs the display unit (LCDD) toward himself, the top and bottom of the terminal (TR) are reversed. Then, in response to an up-down detection signal (UDDET) generated by the up-down detection circuit (UDDET), the contents displayed on the display unit (LCDD) and the functions of the buttons are switched over. With respect to this exemplary embodiment, a case is shown in which the information to be displayed on the display unit (LCDD) is switched between the analytical result of the infrared ray activity analysis (ANA) generated by display control (DISP) and name plate displaying (DNM) in accordance with the value of the up-down detection signal (UDDET).

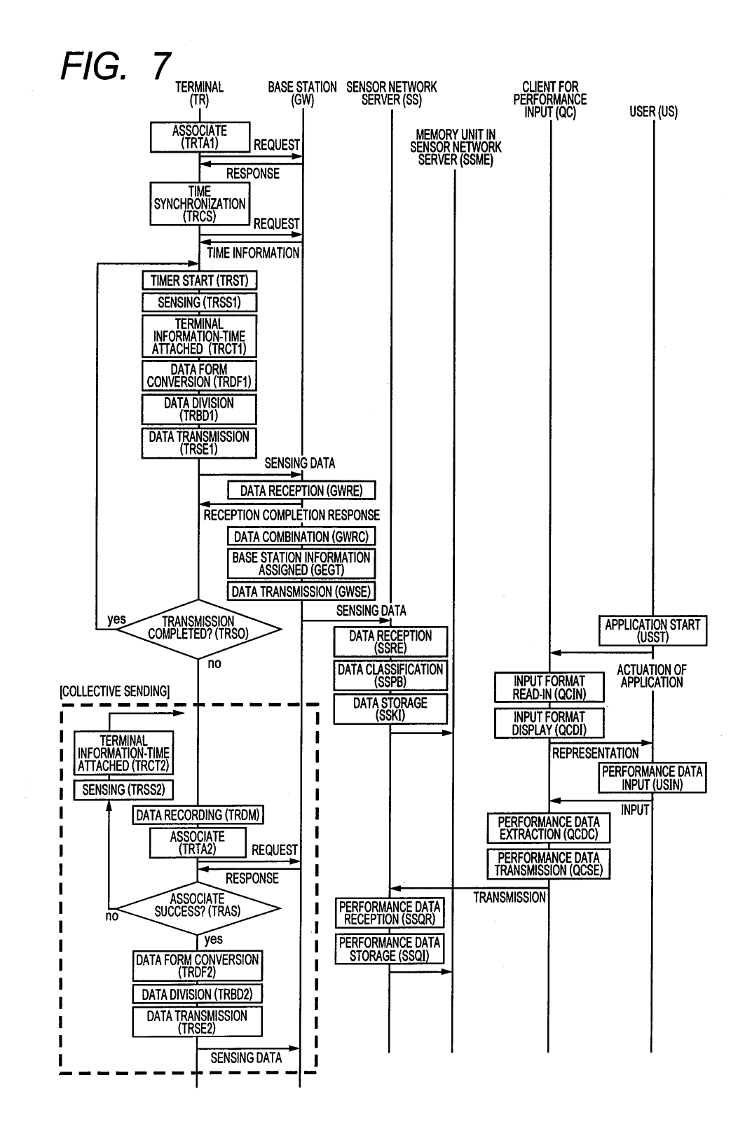

By the inter-node exchange of infrared rays between the infrared transceivers (AB), it is detected whether or not the terminal (TR) has met another terminal (TR), namely whether the person wearing the terminal (TR) has met another person wearing a terminal (TR). For this reason, it is desirable for the terminal (TR) to be worn on the person's front side. As stated above the terminal (TR) is further provided with sensors including the tri-axial acceleration sensor (AC). The process of sensing in the terminal (TR) corresponds to sensing (TRSS1) in FIG. 7.

In many cases, multiple terminals are present, each linked to a nearby base station (GW) to make up a personal area network (PAN).

The temperature sensor (AE) of the terminal (TR) acquires the temperature in the location of the terminal and the illuminance sensor (LS1F), the illuminance counts in the front and other directions of the terminal (TR). The environmental conditions can be thereby recorded. For instance, shifting of the terminal (TR) from one place to another can be known on the basis of temperature and illuminance counts.

As input/output units matching the wearer, the buttons (BTN1 through 3), the display unit (LCDD), the loudspeaker (SP) and so forth are provided.

The memory unit (STRG) in concrete terms is configured of nonvolatile memory unit such as a hard disk or a flash memory, and records the terminal information (TRMT) which is the unique identification number of the terminal (TR), sensing intervals and action settings (TRMA) including the contents of output to the display. Besides these, the memory unit (STRG) can also record temporarily, and is used for recording sensed data.

The communication timing control unit (TRTMG) is a clock for holding the time information (GWCSD) and updating the time information (GWCSD) at regular intervals. The time information, in order to prevent the time information (GWCSD) from becoming inconsistent with other terminals (TR), periodically corrects the time with the time information (GWCSD) transmitted from the base station (GW).

The sensing data storage control unit (SDCNT) controls the sensing intervals and other aspects of the sensors in accordance with the action settings (TRMA) recorded in the memory unit (STRG), and manages acquired data.

The time synchronization acquires time information from the base station (GW) and corrects the clock. The time synchronization may be executed immediately after the associate to be described afterwards, or may be executed in accordance with a time synchronization command transmitted from the base station (GW).

The communication control unit (TRCC), when transmitting or receiving data, controls the transmitting intervals and conversion into a data format matching wireless transmission or reception. The communication control unit (TRCC) may have, if necessarily wired, instead of wireless, communicating function. The communication control unit (TRCC) may perform congestion control to prevent the transmission timing from overlapping with any other terminal (TR).

Associate (TRTA) transmits and receives the associate request (TRTAQ) and the associate response (TRTAR) for forming the personal area network (PAN) with a base station (GW) shown in FIG. 5, and determines the base station (GW) to which are to be transmitted. The associate (TRTA) is executed when power supply to the terminal (TR) has been turned on and, as a result of shifting of the terminal (TR), previous transmission and reception to and from the base station (GW) have been intercepted. As a result of the associate (TRTA), the terminal (TR) is associated with one base station (GW) within the reach of wireless signals from the terminal (TR).

The transceiver unit (TRSR), provided with an antenna, transmits and receives wireless signals. If necessary, the transceiver unit (TRSR) can also perform transmission and reception by using a connector for wired communication. Data (TRSRD) transmitted and received by the transceiver unit (TRSR) are transferred to and from the base station (GW) via the personal area network (PAN).

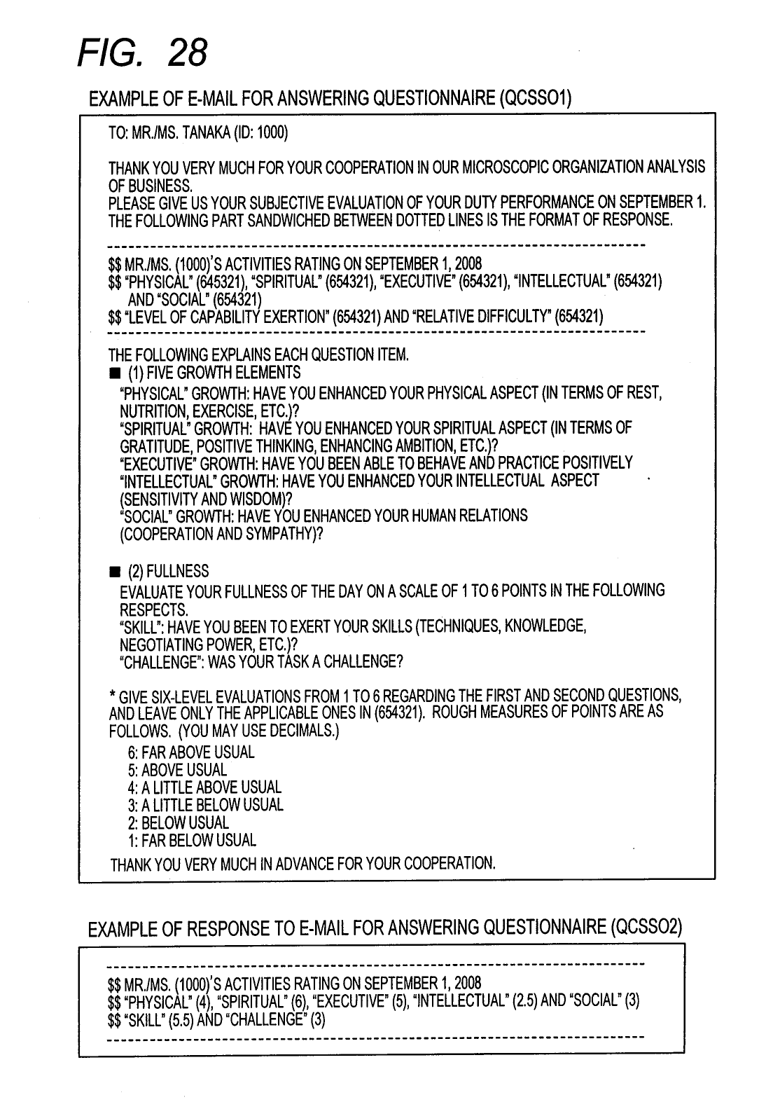

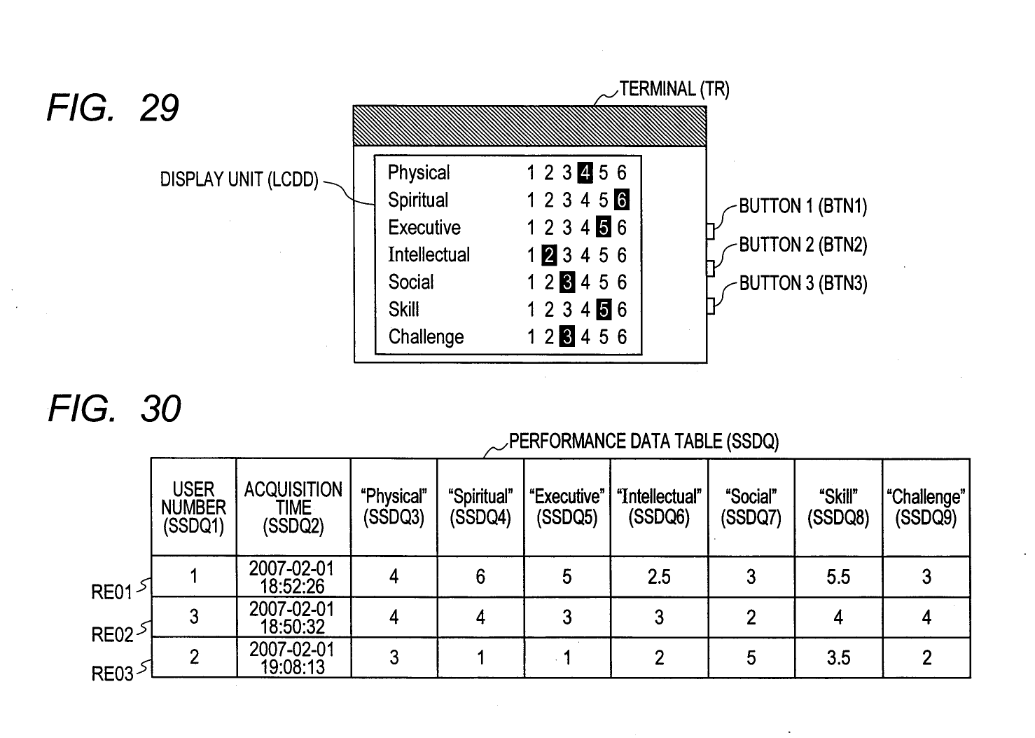

### <FIG. 7, FIG. 28, FIG. 29: Sequence of Data Storage and Example of Questionnaire Wording>

FIG. 7 is a sequence chart that shows the procedure of storing two kinds of data including sensing data and performance data in an exemplary embodiment of the invention.

To begin with, when power supply to the terminal (TR) is on and the terminal (TR) is not in an associate state with the base station (GW), the terminal (TR) performs an associate (TRTA1). The associate means prescribing that the terminal (TR) is in a relationship of communicating a certain base station (GW). By determining the destination of data transmission by the associate, the terminal (TR) is enabled to transmit the data without fail.

When an associate response is received from the base station (GW), resulting in successful associate, the terminal (TR) then performs the time synchronization (TRCS). In the time synchronization (TRCS), the terminal (TR) receives time information from the base station (GW) and sets a clock (TRCK) in the terminal (TR). The base station (GW) is regularly connected to the NTP server (TS) and corrects the time. As a result, time synchronization is achieved among all the terminals (TR). For this reason, by collating time information accompanying the sensing data when analysis is done subsequently, the mutual bodily expressions or exchanges of voice information during communication between persons at the same point of time can also be made analyzable.

Various sensors of the terminal (TR), including the tri-axial acceleration sensor (AC) and the temperature sensor (AE), are subjected to timer start (TRST) at regular intervals, for instance every 10 seconds, and sense acceleration, voice, temperature, illuminance and so forth. (TRSS1). The terminal (TR) detects a meeting state by transmitting and receiving a terminal ID, one item of the terminal information (TRMT), to and from other terminals (TR) by infrared rays. The various sensors of the terminal (TR) may as well perform sensing all the time without being subjected to the timer start (TRST). However, power can be efficiently consumed by actuating them at regular intervals, and the terminal (TR) can be kept in used for many hours without having to be recharged.

The terminal (TR) attaches the time information of the clock (TRCK) and the terminal information (TRMT) to the sensed data (TRCT1). The person wearing the terminal (TR) is identified by the terminal information (TRMT).

In data form conversion (TRDF1), the terminal (TR) assigns tag information including the conditions of sensing to the sensing data, and converts them into a prescribed wireless transmission format. This format is kept in common with the data form information (GWMF) in the base station (GW) and the data form information (SSMF) in the sensor network server (SS). The converted data are subsequently transmitted to the base station (GW).

When a large quantity of consecutive data such as acceleration data and voice data are to be transmitted, the terminal (TR) limits the number of data to be transmitted at a time by data division (TRSD1). As a result, the risk of inviting data deficiency in the transmission process is reduced.

Data transmission (TRSE1) transmits data to the associated base station (GW) via the transceiver unit (TRSR) in conformity with the wireless transmission standards.

The base station (GW), when it has received data from the terminal (TR) (GWRE), returns a reception completion response to the terminal (TR). The terminal (TR) having received the response determines completion of transmission (TRSO).

If no completion of transmission (TRSO) takes place after the lapse of a certain period of time (namely the terminal (TR) receives no response), the terminal (TR) determines the situation as failure to transmit data. In this case, the data are stored into the terminal (TR) and transmitted collectively when conditions permitting transmission are established again. This enables, even when the person wearing the terminal (TR) has moved outside the reach of wireless communication or any trouble in the base station (GW) makes data reception impossible, the data can be acquired without interruption. In this way, the character of the organization can be analyzed from a sufficient volume of data. This mechanism of keeping data whose transmission has failed in the terminal (TR) and retransmitting them is referred to as collective sending.

The procedure of collective sending of data will be described. The terminal (TR) stores the data whose transmission failed (TRDM), and again requests associate after the lapse of a certain period of time (TRTA2). When an associate response is obtained hereupon from the base station (GW) and an associate success (TRAS) is achieved, the terminal (TR) executes data form conversion (TRDF2), data division (TRSD2) and data transmission (TRSS2). These steps of processing are respectively similar to the data form conversion (TRDF1), the data division (TRSD1) and the data transmission (TRSE1). To add, at the time of data transmission (TRSS2), congestion is controlled to prevent collision of wireless communication. After that, the usual processing is resumed.

When no associate success (TRAS) has been achieved, the terminal (TR) regular executes sensing (TRSS2) and terminal information/time information attaching (TRCT2) until it succeeds in associate. The sensing (TRSS2) and terminal information/time information attaching (TRCT2) are processing steps respectively similar to the sensing (TRSS1) and terminal information/time information attaching (TRCT1). The data obtained by these steps of processing are stored in the terminal (TR) until associate success (TRAS) with the base station (GW) is achieved. The sensing data stored in the terminal (TR) are collectively transmitted to the base station (GW) when the environment has become favorable for stable transmission to and reception from the base station has been established after the associate success or charging is being done within the reach of wireless communication.

Further, the sensing data transmitted from the terminal (TR) are received by the base station (GW) (GWRE). The base station (GW) determines whether or not the received data are divided according to a divided frame number accompanying the sensing data. If the data are divided, the base station (GW) executes data combination (GWRC) to combine the divided data into consecutive data. Further, the base station (GW) assigns to the sensing data the base station information (GWMG), which is a number unique to the base station (GWGT), and transmits the data to the sensor network server (SS) via the network (NW) (GWSE). The base station information (GWMG) can be used in data analysis as information indicating the approximate position of the terminal (TR) at that point of time.

The sensor network server (SS), when it receives data from the base station (GW) (SSRE), it classifies with the data management (SSDA) the received data by each of the elements including the time, terminal information, acceleration, infrared rays and temperature (SSPB). This classification is executed by referencing a format recorded as the data form information (SSMF). The classified data are stored into appropriate columns of the records (lines) of the sensing database (SSDB) (SSKI). By storing the data matching at the same point of time onto the same record, searching by the time information and the terminal information (TRMT) is made possible. If necessary then, a table may be prepared for each set of terminal information (TRMT).

Next, the sequence from inputting until storage of performance data will be described. The user (US) manipulates the client for performance inputting (QC) to actuate an application for questionnaire inputting (USST). The client for performance inputting (QC) reads in the input format (QCSS) (QCIN), and displays that question on a display unit or the like (QCDI). The input format (QCSS), namely an example of questions in the questionnaire, is shown in FIG. 28. The user (US) inputs replies to the questions in the questionnaire in the respectively appropriate positions (USIN), and the resultant replies are read into the client for performance inputting (QC).

In the example of FIG. 28, the input format (QCSSO1) is transmitted by e-mail from the client for performance inputting (QC) to the PC of each user (US), and the user enters responses (QCSSO2) into it and returns it to the input format (QCSS). More specifically, in the questionnaire of FIG. 28, the questions are intended to evaluate each on a scale of six levels subjectly regarding duty performance in terms of (1) five growth elements (“physical” growth, “spiritual” growth, “executive” growth, “intellectual” growth and “social” growth) and (2) fullness elements (skill and challenge),

and in the cited case the user evaluates in terms of the five growth elements the “physical” as 4, the “spiritual” as 6, the “executive” as 5, the “intellectual” as 2.5 and the “social” as 3, and the “skill” as 5.5 and the “challenge” as 3. On the other hand, FIG. 29 illustrates an example of screen of the terminal (TR) being used as the client for performance inputting (QC). In this case, answers to the questions displayed on the display unit (LCDD) are inputted by pressing the buttons 1 through 3 (BTN1 through BTN3).

The client for performance inputting (QC) extracts as performance data the required answer results out of the inputted ones (QCDC), and the transmits the performance data to the sensor network server (QCSE). The sensor network server (SS) receives the performance data (SSQR), and distributes and stores them into appropriate places in the performance data table (SSDQ) in the memory unit (SSME).

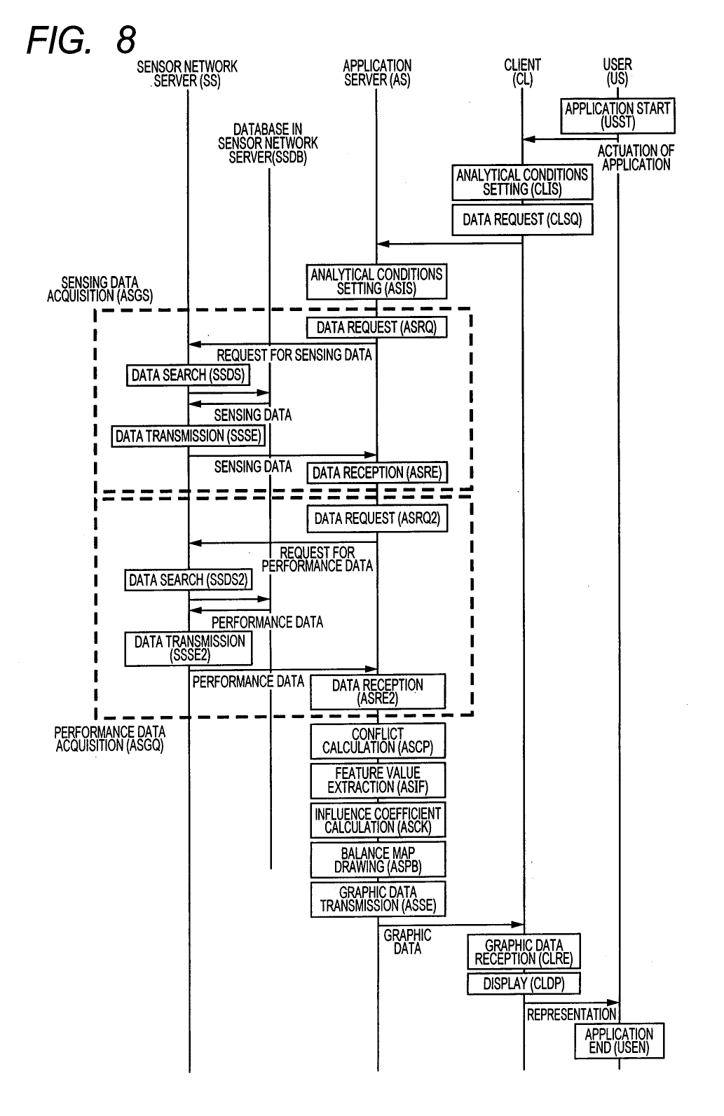

### <FIG. 8: Sequence Chart of Data Analysis>

FIG. 8 illustrates data analysis, namely the sequence until drawing a balance map using the sensing data and the performance data.

Application start (USST) is the start of a balance map display application in the client (CL) by the user (US).

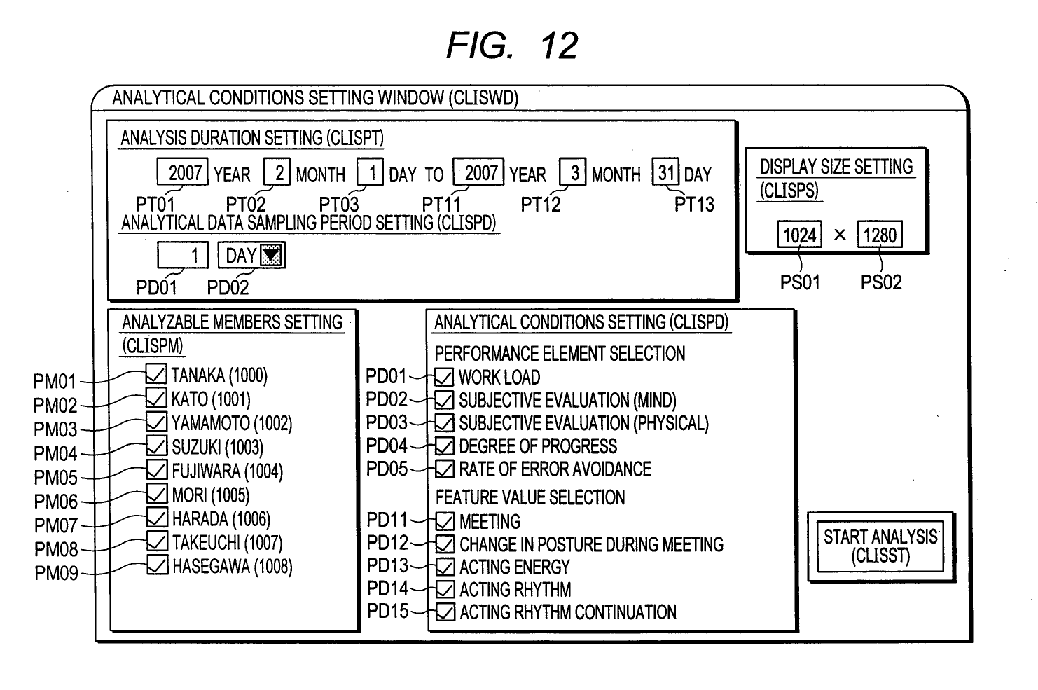

In the analytical conditions setting (CLIS), the client (CL) causes the user (US) to set information needed for presenting a drawing. Information on a window for setting stored in the client (CL) is displayed or information on the window for setting is received from the application server (AS) and displayed, and by inputting by the user (US) the time and terminal information on the data to be displayed and the setting of conditions of the displaying method are acquired. An example of analytical conditions setting window (CLISWD) is shown in FIG. 12. The conditions set here are stored into the memory unit (CLME) as analytical setting information (CLMT).

In a data request (CLSQ), the client (CL) designates the period of data and members to be objects on the basis of the analytical conditions setting (CLIS), and requests the application server (AS) for data or a visual image. In the memory unit (CLME), necessary information items for acquiring the sensing data, such as the name and address of the application server (AS) to be searched, are stored. The client (CL) prepares a command for requesting data, which is converted into a transmission format for the application server (AS). The command converted into the transmission format is transmitted to the application server (AS) via a transceiver unit (CLSR).

The application server (AS) receives the request from the client (CL), sets analytical conditions within the application server (AS) (ASIS), and records the conditions into the analytical conditions information (ASMJ) of the memory unit. It further transmits to the sensor network server (SS) the time range of the data to be acquired and the unique ID of the terminal which is the object of data acquisition, and requests for sensing data (ASRQ). In the memory unit (ASME), information items needed for data signal acquisition, such the name, address, database name and table name of the sensor network server (SS) to be searched are stated.

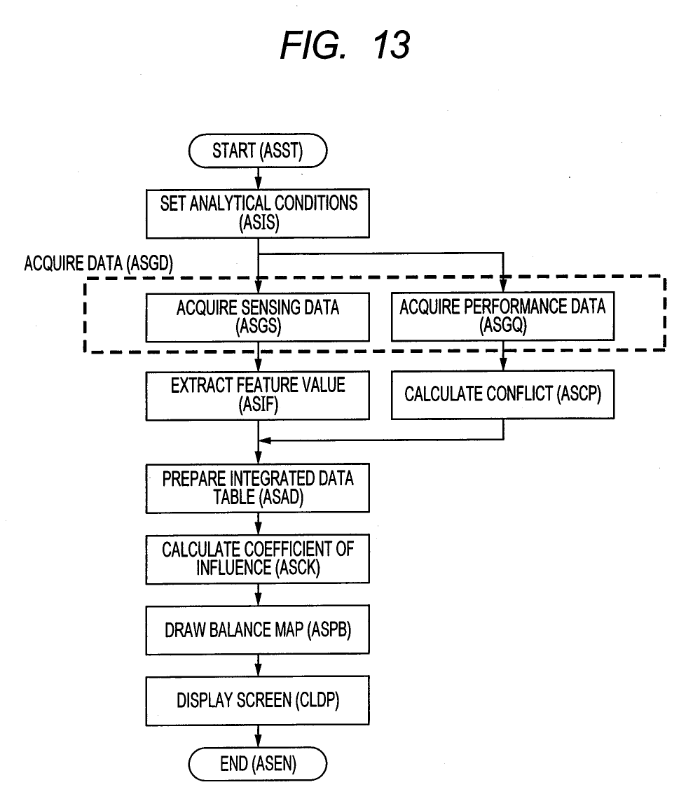

The sensor network server (SS) prepares a search command in accordance with a request received from the application server (AS), searches into the sensing database (SSDB) (SSDS) and acquires the needed sensing data. After that, it transmits the sensing data to the application server (AS) (SSSE). The application server (AS) receives the data (ASRE) and temporarily stores it into the memory unit (ASME). This flow from data request (ASRQ) till data reception (ASRE) corresponds to sensing data acquisition (ASGS) in the low chart of FIG. 13.

Also, in a similar to the acquisition of the sensing data, it acquires performance data. A request for performance data (ASRQ2) is made by the application server (AS) to the sensor network server (SS), and the sensor network server (SS) searches into the performance data table (SSDQ) in the memory unit (SSME) (SSDS2) and acquires the needed performance data. Then it transmits the performance data (SSSE2), and the application server (AS) receives the same (ASRE2). This flow from data request (ASRQ2) till data reception (ASRE2) corresponds to performance data acquisition (ASGQ) in the flow chart of FIG. 13.

Next in the application server (AS), the conflict calculation (ASCP), the feature value extraction (ASIF), the coefficient of influence calculation (ASCK) and the balance map drawing (ASPB) are processed sequentially. The programs for performing these processing steps are stored in the memory unit (ASME) and executed by the control unit (ASCO) to draw a visual image.

The image that has been drawn is transmitted (ASSE), and the client (CL) having received the image (CLRE) displays it on its output device, for instance the display (CLOD) CLDP), Finally, the user (US) ends the application by application end (USEN).

### <FIG. 10: Example of Feature Value List>

FIG. 10 is an example of table (RS_BMF) in which combinations of feature values (BM_F) for use in balance maps, respective calculation methods therefore (CF_BM_F), and examples of corresponding actions (CMBMF) are arranged. According to the invention, such feature values (BMF) are extracted from sensing data or the like, a balance map is prepared for two kinds of performance from the coefficient of influence each feature value has, and effective feature values for performance improvement are found out. By arranging in a readily understandable way, calculation methods (CF_BM_F) and examples of corresponding actions (CM_BMF) as in this list (RS_BMF), guidelines for planning a measure taking note of a given feature value can be obtained. If, for instance, a measure to increase the feature value “(3) Meeting (short)” (BM_F03) is to be planned, one may think of implementing a measure to so alter the layout of desks as to increase instructions, reports and consultations. Examples of action (CM_BM_F) for different feature values may desirably be separately put into a summary of the result of collation of sensing data with the findings of video observation.

The calculation method for each of the feature values (BMF01 through BM_F02) shown in the list (RSBMF) of exemplary feature values of FIG. 10 will be described with respect to Embodiment 2.

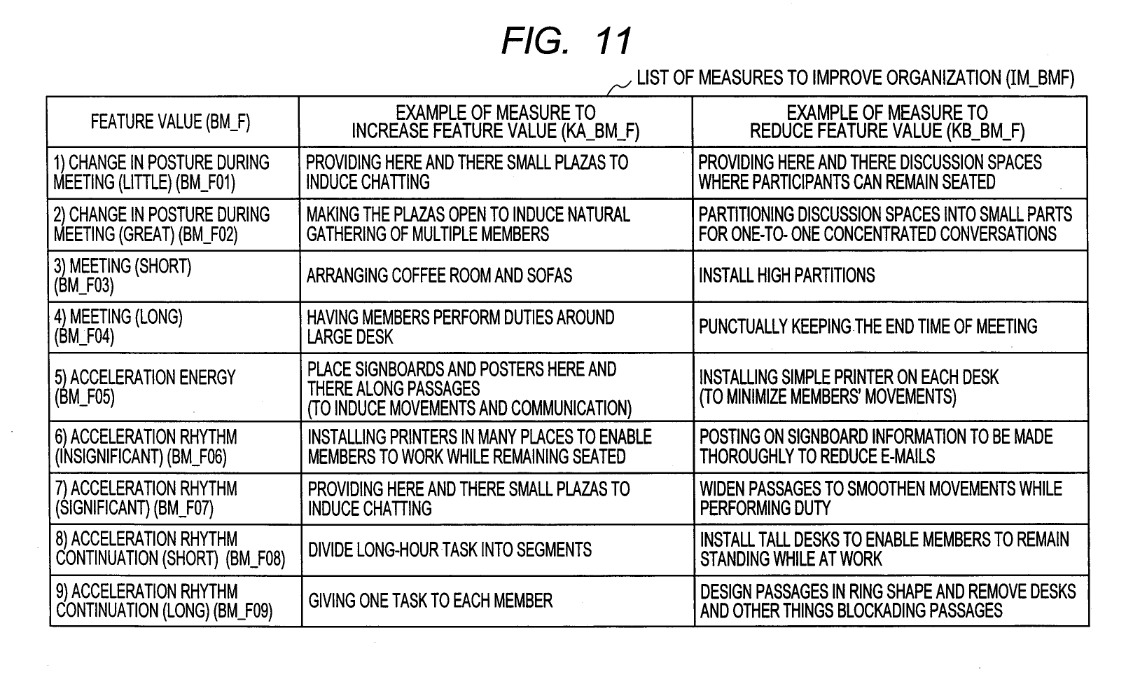

### <FIG. 11: Example of List of Feature Values and Corresponding Improve Measures>

Further, FIG. 11 is an example of list (IM_BMF) of measures to improve organization, in which exemplary measures corresponding to different feature values are collected and arrange. By arranging as know-how in a coordinated way exemplary measures planned on the basis of examples of corresponding actions (CM_BM_F) in FIG. 10, planning of measures can be accomplished more smoothly. The list of exemplary measures to improve organization (IM_BMF) has columns of “Example of measure to increase feature value (KA_BM_F)” and “Example of measure to reduce feature value (KB_BM_F)”. They are useful in planning exemplary measures in conjunction with the results shown in balance maps (BM). If the noted feature value is in the balanced region (BM1) of the first quadrant in the balance map (BM) of FIG. 2, an appropriate value can be selected from the “Example of measure to increase feature value (KA_BM_F)” column because both of two performance elements can be improved by increasing that feature value. Or, if the noted feature value is in the balanced region (BM3) of the third quadrant, an appropriate value can be selected from the “Example of measure to reduce feature value (KB_BM_F)” because both of two performance elements can be improved by reducing that feature value. If it is in the unbalanced region of the second quadrant (BM2) or the fourth quadrant (BM4), it is advisable return to the “Example of corresponding action (CM_BM_F)” in FIG. 10, identify the action giving rise to the conflict and plan a measure not to let the conflict occur because the action corresponding to that feature value contains a factor to make the two performance elements conflict with each other.

The sequence of planning these measures to improve organization is shown in the flow chart of FIG. 16.

### <FIG. 12: Sample of Analytical Conditions Setting Window>

FIG. 12 shows an example of analytical conditions setting window (CLISWD) displayed to enable the user (US) to set conditions in the analytical conditions setting (CLIS) in the client (CL).

In the analytical conditions setting window (CLISWD), setting of the period of data for use in display, namely analysis duration (CLISPT), sampling period setting for the analytical data (CLISPD), setting of analyzable members (CLISPM) and setting of display size (CLISPS) are done, and setting of analysis (CLISPD) is further done.

The analysis duration setting (CLISPT) is intended to set dates in text boxes (PT01 through 03, PT11 through 13) and to designate the data in the range wherein the points of time at which the sensing data are acquired at the terminal (TR) and the days and hours (or the points of time) represented by the performance data as the objects of calculation. If required, additional text boxes in which the range of the points of time are to be set may be provided.

In the analytical data sampling period setting (CLISPD), the period of sampling is set for analysis of data from the text box (PD01) and a pull-down list (PD02). This designation is intended to what period, where many kinds of sensing data and performance data are acquired in different sampling periods, they should be unified. Basically, it is desirable to unify them to the longest sampling period for the data to be analyzed. The same method of equalizing the sampling periods of many kinds of data as in the second exemplary embodiment of the invention is used.

The window of the analyzable members setting (CLISPM) is caused to reflect the user name or, if necessary, the terminal ID read in from the user-ID matching table (ASUIT) of the application server (AS). The person to be set by using this window sets the data of what member are to be used in analysis by marking or not marking checks in check boxes (PM01 through PM09). Members to be displayed may as well be collectively designated according to such conditions as predetermined grouping or age bracket instead of directly designating individual members.

In the display size setting (CLISPS), the size in which the visual image that has been drawn is to be displayed is designated by inputting it into text boxes (PS01, PS02). In this exemplary embodiment, a rectangular shape is presupposed for the image to be displayed on the screen, but some other shape would also be acceptable. The longitudinal length of the image is inputted to a text box (PS01) and the lateral length, to another text box (PS02). Some unit of length, such ax pixel or centimeter, is designated as the unit of the numerical counts to be inputted.

In the analytical conditions setting (CLISPD), a candidate for the performance element and the feature value to be used in analysis are selected. Each is selected by checking the corresponding one of the check boxes (PD01 through PD05, PD11 through PD15).

When all the inputs have been completed, finally the user (US) presses a display start button (CLISST). This causes these analytical conditions to be determined, and the analytical conditions to be recorded into the analytical setting information (CLMT) and to be transmitted to the application server (AS).

### <FIG. 13: Flow Chart of Overall Processing>

FIG. 13 is a flow chart showing the overall processing executed in the first exemplary embodiment of the invention from the start-up of the application until the presentation of the display screen to the user (US).

After the start (ASST), the analytical conditions setting (ASIS) is done and next, the steps from sensing data acquisition (ASGS) to the feature value extraction (ASIF) and from performance data acquisition (ASGQ) to the conflict calculation (ASCP) are performed in parallel. The feature value extraction (ASIF) is processing to count the number of times of emergence of a part having a specific pattern in sensing data including the acceleration data, meeting data and voice data. Further, the performance data combination to be used for balance maps (BM) in the conflict calculation (ASCP) is determined.

The feature values and sets of performance data obtained here are classified by the point of time to prepare an integrated data table (ASTK) (ASAD). As the method of preparing the integrated data table from the feature value extraction (ASIF), the method of Embodiment 2 can be preferably used. And next, by using the integrated data table (ASTK), the coefficient of influence calculation (ASCK) is conducted. In the coefficient of influence calculation (ASCK), coefficients of correlation or partial regression coefficients are figured out and used as coefficients of influence. Where coefficients of correlation are to be used, the coefficient of correlation is figured out for every combination of a feature value and a performance data item. In this case, the coefficient of influence can represent the one-to-one relation of the feature value and the performance data item. Or where partial regression coefficients are to be used, multiple regression analysis is carried out in which every feature value is used as the explanatory variable and one of the performance data sets, as the object variable. In this case, partial regression coefficients can indicate relative strength, namely how much stronger each matching feature value is than other feature values and how much more strongly influences the performance data item. Incidentally, the multiple regression analysis is a technique by which the relations between one object variable and multiple explanatory variables are represented by the following multiple regression equation (1). The partial regression coefficients (a1, . . . , ap) represent the influences of the matching feature values (x1, . . . , xp) on the performance y.

[Equation 1]

y=a₁x₁+a₂x₂+ . . . +aₚxₚ+a₀ (1)

y: Object variable

x1, 22, . . . , xp: Explanatory variables

p: Number of explanatory variables

a1, a2, . . . , ap: Partial regression coefficients

a0: Constant term

On this occasion, only the useful feature values may be selected by using a stepwise method or the like and used in balance maps.

Next, the coefficients of influence that have been figured out are plotted with respect to the X axis and the Y axis to draw a balance map (BM) (ASPB). Finally, that balance map (BM) is put to representation (CLDP) on the screen of the client (CL) to end the sequence (ASEN).

### <FIG. 14: Flow Chart of Conflict Calculation>

FIG. 14 is a flow chart showing the flow of processing the conflict calculation (ASCP). In the conflict calculation (ASCP), after start (CPST), first the performance data table (ASDQ) such as shown in FIG. 18 is read in (CP01), one set is selected out of the table (CP02), and the coefficient of correlation of this set is figured out (CP03) and outputted to the performance correlation matrix (ASCM) in FIG. 19. This sequence is repeated until processing of every performance combination is completed (CP04), and finally a performance set of which the coefficient of correlation is negative and the absolute value is the greatest is selected to end the sequence (CPEN). In the performance correlation matrix (ASCM) of FIG. 19 for instance, as the element whose coefficient of correlation has a value of −0.86 (CM_01-02) is negative and has the highest absolute value, the performance data combination of the work load (DQ01) and the questionnaire (response to “spiritual”) (DQ02) is selected.

By selecting a performance having a high negative correlation in this way, it is made possible to find a performance combination of which the constituent elements are hardly compatible, namely apt to give rise to conflict. In the balance map drawing (ASPB) afterwards, with these two performance elements represented on the axes, analysis to make them compatible is performed and thereby contributions are made to improving the organization.

### <FIG. 15: Flow Chart of Balance Map Drawing>

FIG. 15 is a flow chart showing the flow of processing of the balance map drawing (ASPB).

After start (PBST), the axes and frame of the balance map are drawn (PB01), and values in the coefficient-of-influence table (ASDE) are read in (PB02). Next, one feature value is selected (PB03). The feature value has a coefficient of influence with respect to each of the two kinds of performance. One of the coefficients of influence being taken as the X coordinate and the other coefficient of influence, as the Y coordinate, values are plotted (PB04). This step is repeated until plotting of every feature value is completed (PB05) to end the processing (PBEN).

This displaying having coefficients of influence on the two axes, it is made easier to understand what characteristic each feature value has in comparison with other feature values than looking at numerical counts. It this way, it is made understandable that a feature value positioned at coordinates particularly far from the origin have stronger influences on both of the two performance elements. Thus, prospects are gained that duty performance is highly likely to be improved by implementing a measure taking note of this feature value. It is also known that feature values positioned close to each other resemble in characteristic. In such a case, there are more options for improvement measures because a measure taking note of which ever feature value would give a similar result.

### <FIG. 16: Flow Chart of Planning Measures to Improve Organization>

FIG. 16 is a flow chart showing the flow of processing until a measure to improve the organization is planned by utilizing the result of balance map (BM) drawing. However, as this is a procedure done by the analyzing person but not automatically accomplished by a computer or the like, it is not covered by the overall system diagram of FIG. 4 or the flow chart of FIG. 13.

First, after start (SAST), the feature value farthest from the origin in the balance map is selected (SA01). This is because the farther the feature value is the stronger its influence on performance and accordingly implementation of an improving measure taking note of that feature value is likely to prove highly effective. Further, if there is a particular purpose to resolve conflict between two performance elements, the feature value positioned farthest from the origin among the feature values in the unbalanced regions (the first quadrant and the third quadrant) may as well be selected.

After the feature value is selected, next the region in which that feature value is position is taken note of (SA02). If it is an unbalanced region, further a scene in which the feature value appears is separately analyzed (SA11) and the factor that causes the feature value to invite the imbalance is identified (SA12). This enables what action by the object organization or person gives rise to conflict between two performance elements to be identified by, for instance, comparing the feature value data with video-recorded moving pictures with time indications.

To cite an easy-to-understand example, it is supposed that a balance map result has revealed, as a feature value X, great up-and-down fluctuations of the acceleration rhythm, namely frequent changes between moving and stopping, helps improve work efficiency but increases the perceived fatigue of the worker. The points of time at which this feature value X emerges are represented in bar graphs or the like and compared with video data. As a result, it is known that when a worker has many different tasks and is engaged with them in parallel, the feature value X appears, and especially repetition of alternate standing/walking and seating invite up-and-down fluctuations of the acceleration rhythm are apt to occur. In this case, though work efficiency demands parallel accomplishment of different tasks, the accompanying changes in bodily motion increase the perceived fatigue. Therefore, a conceivable measure to improve organization may be to reduce fluctuations of the acceleration rhythm by so scheduling the tasks as to make ones similar in action and or place consecutive in terms of a task to be done by a standing worker, one by a seated worker, one by a worker in a conference room and one by a worker in his regular seat.

On the other hand at step (SA02), if the feature value is positioned in a balanced region, classification is further made to locate it in the first quadrant or the third quadrant (SA03). If is in the first quadrant, as that feature value can be regarded as having positive influences on both of the two performance elements, the two performance elements can be improved by increasing the feature value. Therefore, a measure suitable for the organization is selected from the “Examples of measure to increase feature value (KA_BM_F)” in the list of measures to improve organization (IM_BMF) as in FIG. 11 (SA31). Or a new measure may as well be planned with reference to this information. If at step (SA03) if it is found in the third quadrant, that has negative influences on both of the two performance elements, the two performance elements can be improved by reducing the feature value. Therefore, a measure suitable for the organization is selected from the “Examples of measure to reduce feature value (KB_BM_F)” in the list of measures to improve organization (IM_BMF) (SA21).

Or a new measure may as well be planned with reference to this information.

In this way, the measure to be implemented to improve the organization is determined (SA04) to end the processing (SAEN). Obviously, it is desirable after that to implement the determined measure, sense the worker's activities again to make sure that his action matching each feature value has changed as expected.

By sequentially determining the noted feature value and its region in the balance map (BM) along the list of measures, it is possible to smoothly plan appropriate measures to improve the organization. Obviously, some other measure not included in the list may be planned, but referencing the result of analysis using the balance map (BM) makes possible management not deviating from the problems the organization is faced with and its objectives.

### <FIG. 17: User-Id Matching Table (ASUIT)>

FIG. 17 is a diagram illustrating an example of form of the user-ID matching table (ASUIT) kept in the memory unit (ASME) within the application server (AS). In the user-ID matching table (ASUIT), user numbers (ASUIT1), user names (ASUIT2), terminal IDs (ASUIT3) and groups (ASUIT4) are recorded correlated to one another. The user number (ASUIT1) is intended for prescribing the order of precedence among the users (US) in a meeting matrix (ASMM) and the analytical conditions setting window (CLISWD). Further, the user name (ASUIT2) is the name of a user belonging to the organization, displayed on, for instance, the analytical conditions setting window (CLISWD). The terminal ID (ASUIT3) indicates terminal information the terminal (TR) owned by the user (US). This enables sensing data obtained from a specific terminal (TR) to grasp and analyze as information representing the action of that user (US). The group (ASUIT4) denotes the group the user (US) belongs to, a unit performing common duties. The group (ASUIT4) is a dispensable column if not required in particular, but it is required when communicating actions with persons inside and outside the group should be distinguished between each other as in Embodiment 4. Further, some more columns of information on other attributes, such as the age, can be added. In the event of any change in the organization membership of the group the user belongs to, the change can be reflected in analytical results by rewriting the user-ID matching table (ASUIT). Also, the user name (ASUIT2), which is personal information, may as well be refrained from being placed in the application server (AS), but a table of correspondence between the user name (ASUIT2) and the terminal ID (ASUIT3) may be separately provided in the client (CL), wherein members to be analyzed are set, and only the terminal ID (ASUIT3) and the user number (ASUIT1) may be transmitted to the application server (AS). In this way, the application server (AS) is relieved from the need to handle personal information, and accordingly, where the application server (AS) manager and the manager of the client (CL) are different, it is made possible to avoid the complexity of personal information managing procedure.

By figuring out coefficients of influence by the use of common feature values obtained from sensor data for two kinds of performance data between which conflict can occur, conflict among multiple performance elements in duty performance can be resolved, and obtainment of guidelines on measures to improve both is facilitated. In other words, quantitative analysis can be made effective in realizing overall optimization of duty performance.

### Embodiment 2

A second exemplary embodiment of the present invention will be described with reference to drawings.

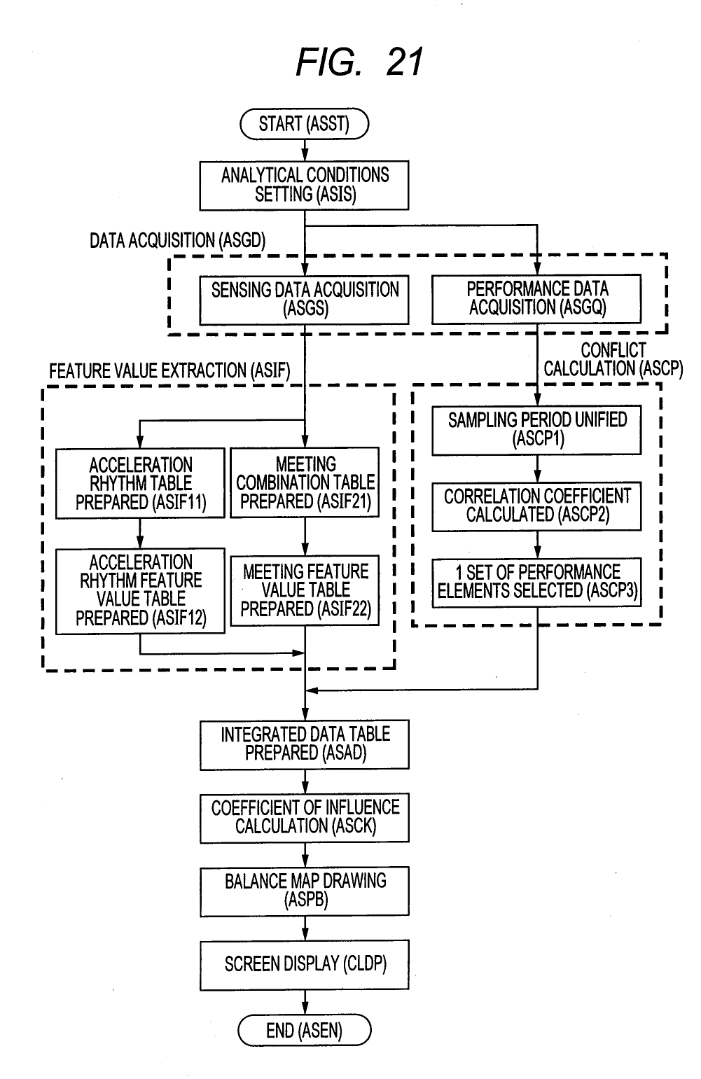

The second exemplary embodiment of the invention, even if performance data and sensing data are acquired in different sampling periods or are imperfect, involving deficiencies, unifies the sampling periods and durations of those sets of data. In this way, balance map drawing for well balanced improvement of the two kinds of performance is accomplished.

<FIG. 21 through FIG. 27: Flow Chart of Drawing>

FIG. 21 is a flow chart showing the flow of processing in the second exemplary embodiment of the invention from the start-up of the application until the presentation of the display screen to the user (US). Although the overall flow is similar to the flow chart (FIG. 13) of the first exemplary embodiment of the invention, the method of unifying the sampling periods and durations in the feature value extraction (ASIF), the conflict calculation (ASCP) and the integrated data table preparation (ASAD) will be described in greater detail. Regarding system diagrams and sequence charts, the same ones as those for the first exemplary embodiment will be used.

In the feature value extraction (ASIF), the sampling period differs with the type even for sensing data, which are raw data. It is uneven, for instance, 0.02 second for the acceleration data, 10 seconds for the meeting data and 0.125 millisecond for the voice data. This is because the sampling period is determined according to the characteristic of information desired to be obtained from each sensor. Regarding the occurrence or non-occurrence of meeting between persons, discernment in the order of seconds is sufficient, but where information on the frequency of sounds is desired, sensing in the order of milliseconds is required. Especially, as the determination of the surrounding environment according to the rhythm and sound of the accelerated motions is highly likely to reflect the characteristics of the organization and actions, the sampling period at the terminal (TR) is set short.

However, in order to analyze multiple kinds of data in an integrated way, it is necessary to unify the sampling periods of different kinds of data. Also, it is necessary to accomplish integration while maintaining the needed characteristics of each kind of data instead of simply thin out the different kinds of data.

In this description, a process to extract feature values regarding acceleration and meeting is take up as example to described the process of unifying the sampling periods. For the acceleration data, importance is attached to the characteristics of the rhythm, which is the frequency of acceleration, and the sampling periods are unified without sacrificing the characteristics of the up-and-down fluctuations of the rhythm. For meeting data, the processing takes note of the duration of the meeting. Incidentally, it is supposed that questionnaire forms, one kind of performance data, are collected once a day, and the sampling periods of feature values are ultimately unified to one day. Generally, it is advisable to align the sampling periods to the longest one for sensing data and performance data.

### <Method of Calculating Feature Value of Acceleration>

First regarding the acceleration data for the feature value extraction (ASIF), a stepwise method is used in which the rhythm is figured out in a prescribed time unit (for instance in minutes) from raw data of 0.02 second in sampling period, and feature values regarding the rhythm are further counted in the order of days. Incidentally, the time unit for figuring out the rhythm can as well be set to a value other than a minute according to the given purpose.

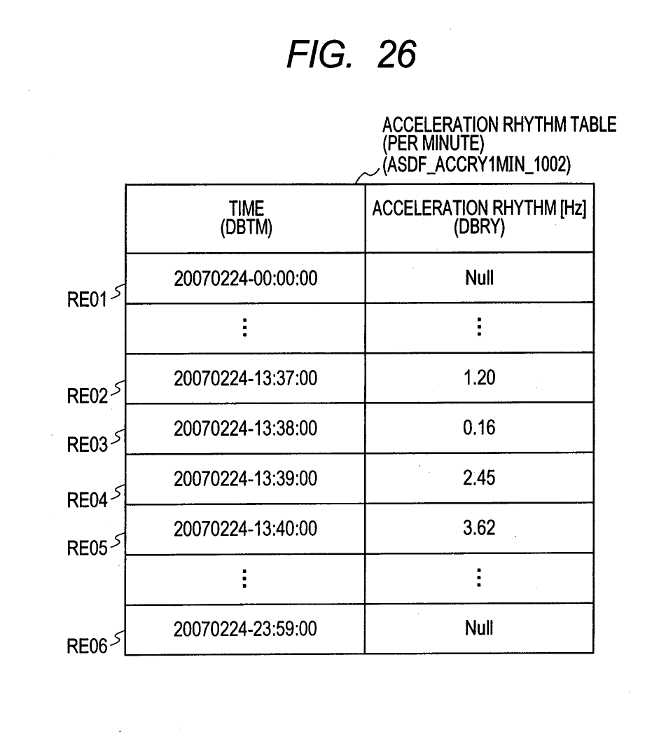

An example of acceleration data table (SSDB_ACC_1002) is shown in FIG. 25, an example of acceleration rhythm table (ASDF_ACCTY1MIN_1002) in the order of minutes in FIG. 26, and an acceleration rhythm feature value table (ASDF_ACCRY1DAY_1002) n the order of days in FIG. 27. It is supposed here that the tables are prepared only from data on the terminal (TR) whose terminal ID is 1002, but data from data on multiple terminals can be used in a single table for its preparation.

First, the acceleration rhythm table (ASDF_ACCTY1MIN_1002) is prepared in which the acceleration rhythm is counted in minutes from the acceleration data table (SSD_BACC_1002) regarding a certain person (ASIF11). The acceleration data table (SSDB_ACC_1002) is merely a result of conversion of data sensed by the acceleration sensor of the terminal (TR) into a [G] unit basis. Thus, it can be regarded as stating raw data. The sensed time information and the values of the X, Y and Z axes of the tri-axial acceleration sensor are stored correlated to each other. If powered supply to the terminal (TR) is cut off or data become deficient on the way of transmission, the data are not stored, and therefore the records in the acceleration data table (SSDB_ACC_10022) are not always at 0.02-second intervals.

When preparing the per-minute acceleration rhythm table (ASDF_ACCTY1MIN_1002), processing to compensate for such lost time is done at the same time. If no raw data are contained in a minute, the acceleration rhythm table (ASDF_ACCTY1MIN_1002) inputs that absence as Null. This causes the acceleration rhythm table (ASDF_ACCTY1MIN_1002) to be made a table in which 0:00 until 23:59 of a day is wholly covered at one-minute intervals.

The acceleration rhythm is the numbers of positive and negative swings of the values of acceleration in the X, Y and Z within a certain length of time, namely the frequency of oscillation. It is obtained by counting and totaling the numbers of swings in those directions within a minute in the acceleration data table (SSDB_ACC_1002). Or the calculation may be simplified by using the number of times temporally consecutive data have passed 0 (the number of cases in which multiplication of the value of the point of time t and the value of the point of time t+1 gives a minus product; referred to as the number of zero crosses).

To add, a one-day equivalent of the acceleration rhythm table (ASDF_ACCTY1MIN_1002) is provided for each terminal (TR).

Next, values in each daily edition of the minutely acceleration rhythm table (ASDF_ACCTY1MIN_1002) are processed to prepare an acceleration rhythm feature value table (ASDF_ACCRY1DAY_1002) on a daily basis (ASIF12).

In the daily acceleration rhythm feature value table (ASDF_ACCRY1DAY_1002) of FIG. 27, a case in which feature values of “(6) acceleration rhythm (insignificant)” (BMF06) and “(7) acceleration rhythm (significant)” (BM_F07) are stored in the table is shown. The feature value “(6) acceleration rhythm (insignificant)” (BM_F06) represents the total length of time in a day during which the rhythm was no more than 2 [Hz]. This is a numerical count obtained by counting the number of times at which the acceleration rhythm (DBRY) was not Null and was less than 2 Hz in the minutely acceleration rhythm table (ASDF_ACCTY1MIN_1002) and multiplying the number by 60 [seconds]. Similarly, the feature value “(7) acceleration rhythm (significant)” (BMF07) obtained by counting the number of times of not Null and not less than 2 Hz and multiplying the number by 60 [seconds]. The reason for the use of 2 Hz as the threshold here is that past analytical results have made known that the boundary between calm personal motions of working on a PC or thinking and more active motions of walking around or of contact with others, such as talking to them, is at approximately 2 Hz.

In the acceleration rhythm feature value table (ASDF_ACCRY1AY_1002) prepared in this way, the sampling period is one day and the duration is consistent with the analysis duration setting (CLISPT). Data outside the duration of analysis are deleted.

Further the calculation method for the feature values (BM_F05, BM_F08, BM_F09) included in the List of examples of feature value (RS_BMF) of FIG. 10 will be described below. “(8) Acceleration rhythm continuation (short) (BM_F08)” and “(9) Acceleration rhythm continuation (long) (BM_F09)” are the counts of the number of times that near rhythm values have continued for a certain length of time in the minutely acceleration rhythm table (ASDF_ACCTY1MIN_1002) of FIG. 26. Divisions of rhythm are determined in advance such as not less than 0 [Hz] but less than 1 [Hz] or not less than 1 [Hz] but less than 2 [Hz], and distinguishes the range to which each minutely rhythm value belongs. If five or more values in the same range come consecutively, the count is increased by 1 as the feature value of “(9) Acceleration rhythm continuation (long) (BM_F09)”. If the number of consecutive values is less than five, the count is increased by 1 as the feature value of “(8) Acceleration rhythm continuation (short) (BM_F08)”. Further, “(5) Acceleration energy (BM_F05)” is obtained by squaring the rhythm value of each record in the minutely acceleration rhythm table (ASDF_ACCTY1MIN_1002), figuring out their daily total and dividing the total by the number of non-Null data.

### <Method of Calculating Feature Value of Meeting>

On the other hand, in the feature value extraction (ASIF) regarding meeting data, a two-party meeting combination table is prepared (ASIF21), and a meeting feature value table (ASIF22). Raw meeting data acquired from terminals are stored person by person in a meeting table (SSDBIR) as shown in FIG. 22 (a) or FIG. 22 (b). Incidentally, if the table has a terminal ID column, it may cover multiple persons in a mixed way. In the meeting table (SSDBIR), multiple pairs each of an infrared ray transmission side ID1 (DBR1) and the frequency of reception 1 (DBN1) and the point of time of sensing (DBTM) are stored in one record. The infrared ray transmission side ID (DBR1) is the ID number of another terminal the terminal (TR) has received by infrared rays (namely the ID number of the terminal that has been met), and the number of times the ID number was received in 10 seconds is stored in the frequency of reception 1 (DBN1). Since multiple terminals (TR) may be met in 10 seconds, multiple pairs of the infrared ray transmission side ID1 (DBR1) and the frequency of reception 1 (DBN1) (10 pairs in the example of FIG. 22) can be accommodated. If powered supply to the terminal (TR) is cut off or data become deficient on the way of transmission, the data are not stored, and therefore the records in the meeting table (SSDBIR) are not always at 10-second intervals. In this respect, too, adjustment should be made at the time preparing the meeting combination table (SSDB_IR_CT1002-1003).

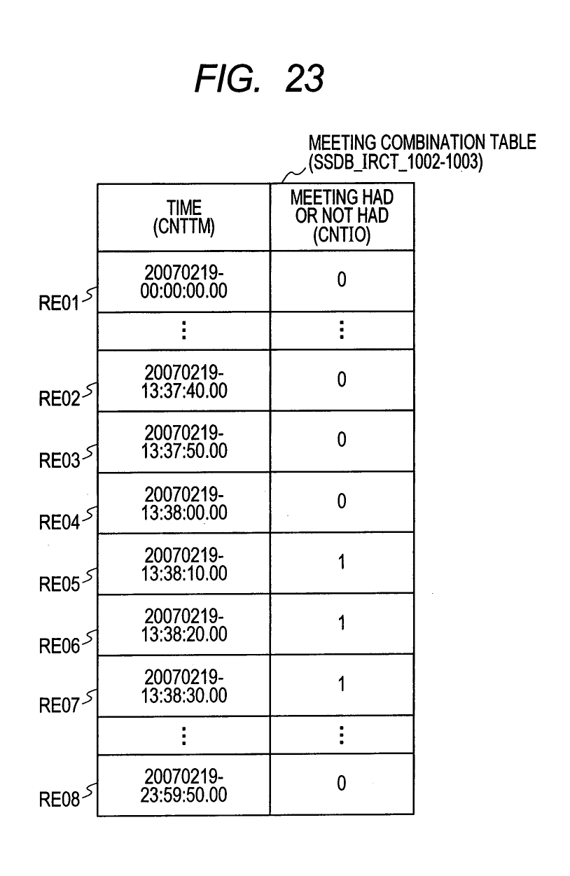

Further, according to raw data, the terminal (TR) of only one of the two persons having met has received infrared rays. Therefore, a meeting combination table (SSDB_IRCT_1002-1003) in which only whether a given pair of persons has met or not is indicated at 10-second intervals is prepared. An example of it is shown in FIG. 23. A meeting combination table (SSDB_IRCT) is prepared for every combination of persons. This table need not be prepared for any pair of persons having never met each other. The meeting combination table (SSDB_IRCT) has columns of time (CNTTM) information and information indicating whether the two have met or not (CNTIO); if they have met at a given time, a value of 1 is stored or if they have not met, a value of 0 is stored.

In the processing to prepare the meeting combination table (SSDB_IRCT_1002-1003), time (DBTM) data are collated between meeting tables (SSDB_IR_1002, SSDB_IR_1003) regarding the persons, and the infrared ray transmission side ID at the same or the nearest time are checked. If the other party's ID is contained in either table, the two persons are determined to have met, 1 is inputted to the column of whether the two have met or not (CNTIO), together with the time (CNTTM) datum, in the applicable record of the meeting combination table (SSDB_IRCT_1002-1003). Determination of their having met may use another criterion, such as the frequency of infrared ray reception was at or above the threshold or both persons' tables contain each other's ID. However, as the experience tells that meeting data tend to detect less frequent meetings than the persons feel to have met, the method adopted here assumes that if detected at least on one side, the two are assumed to have met. Further, by supplementing a meeting combination table (SSCB_IRCT) by the method of Embodiment 5, deficiencies in the meeting data can be further compensated for and the accuracy about whether the two persons have met or not and the duration of any meeting can be further enhanced.

As described so far, a meeting combination table is prepared for each day regarding the combinations of every member.

Further, on the basis of the meeting combination table, a meeting feature value table (ASDF_IR1DAY_1002) such as the example shown in FIG. 24 is prepared regarding a given person (ASIF22). The sampling period of the meeting feature value table (ASDF_IR1DAY_1002) is one day, and its duration coincides with the analysis duration setting (CLISPT). Data outside the duration of analysis are deleted. In the example of FIG. 24, the feature value “(3) Meeting (short)” (BM_F03) is the total number of times 1 has been consecutive for two or more but less than 30 times, namely consecutive meetings of 20 seconds or more but less than 5 minutes, in the value of the column of whether the two have met or not (CNTIO) in the meeting combination table (SSDB_IRCT) in one day regarding the terminal (TR) of 1002 in terminal ID number and all other terminals (TR). At this time, what has resulted from supplementation of the meeting combination table by a method such as what is shown in Embodiment 4 may as well be used for counting. Also, the feature value “(4) Meeting (long)” (BM_F04) similarly is the total number of times 1 has been consecutive for 30 or more times, namely consecutive meetings of no less than 5 minutes, in the value of the column of whether the two have met or not (CNTIO).

As hitherto described, feature values are figured in such a stepwise manner as to make the sampling period become successively longer. In this way, a series of data unified in sampling period can be made available while maintaining the needed characteristics of each kind of data for analysis. A conceivable non-stepwise manner is to calculate one value by averaging raw data on acceleration for one day, but such a method is highly likely to even up the daily data to make ambiguous the different characteristics of the day's activities. Thus, stepwise division makes possible determination of feature values maintaining their characteristics.

<FIG. 28 through FIG. 30: On Performance Data>

Regarding performance data, processing to unify the sampling periods (ASCP1) is accomplished at the beginning of the conflict calculation (ASCP). The questionnaire form as shown in FIG. 28 or an e-mail, or data of reply to a questionnaire inputted by using the terminal (TR) shown in FIG. 29, is assigned the acquisition time (SSDQ2) and the answering user's number (SSDQ1) as in the performance data table (SSDQ) of FIG. 30 and stored. If there are performance data regarding duty performance, they are also contained in the performance table (SSDQ). The frequency of colleting performance data may be once a day or more. In sampling period unification (ASCP), original data in the performance data table (SSDQ) are divided tables, one for each user and, if there is a day when no reply has come in, it is supplemented with Null data to make the sampling period one day.

On the basis of those data, by using a similar to the method shown in the flow chart of FIG. 14 for Embodiment 1, the coefficients of correlation between performance elements in every combination are calculated (ASCP2), and the performance of the combination involving the greatest conflict is selected (ASCP3).

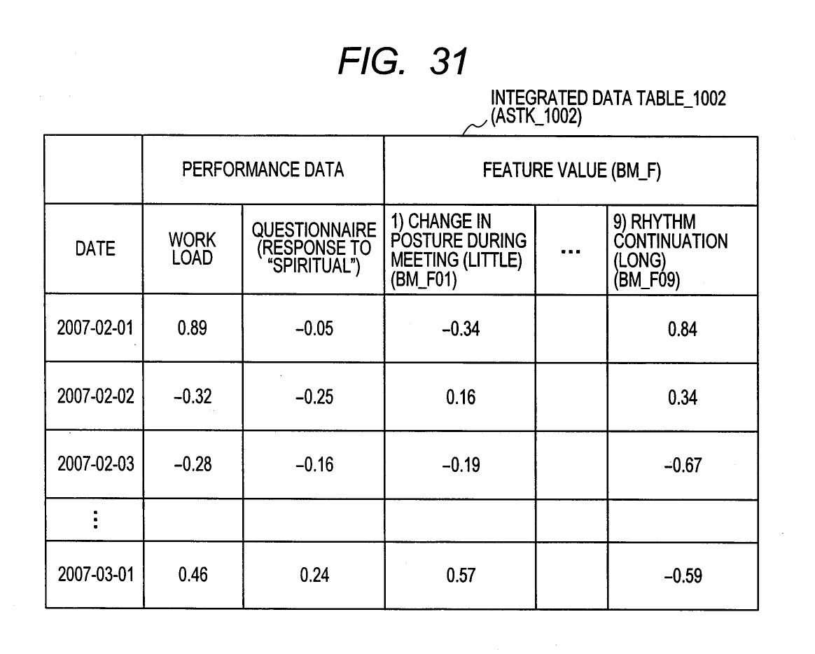

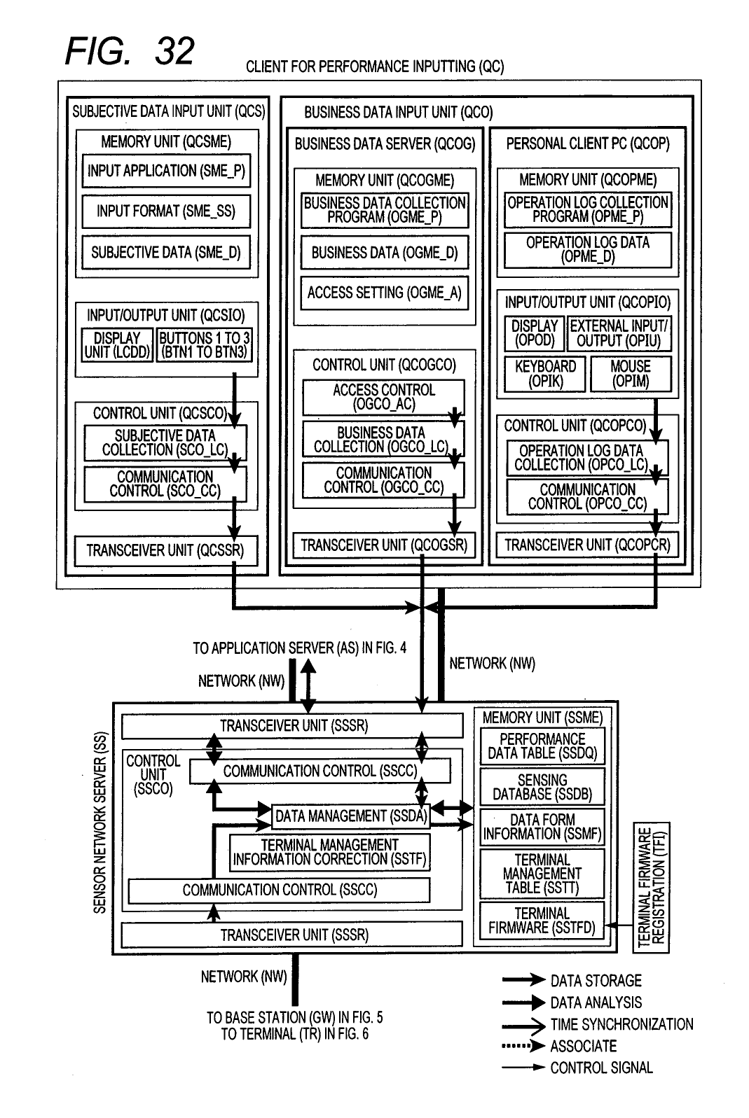

### <FIG. 31: Integrated Data Table>

FIG. 31 shows an example of integrated data table (ASTK_1002) outputted by the integrated data table preparation (ASAD). The integrated data table (ASTK) is a table in which sensing data and performance data of which the durations and the sampling periods are unified, obtained by the feature value extraction (ASIF) and the conflict calculation (ASCP) and strung together by dates.

Values in the integrated data table (ASTK_1002) are converted into Z-score in advance with respect to each column (feature value or performance). Z-score means values so standardized as to cause the data distribution in the column to have an average value of 0 and a standard deviation of 1.

A value (Xi) in a given column X is standardize by the following Equation (2), namely converted into Z-score (Zi).

$${Z}_{i} = \frac{{X}_{i} - \overline{X}}{S} \qquad [ Equation 2 ]$$

X: Average value of data in column x

S: Standard deviation of data in column x

This processing enables the calculation of influences on multiple kinds of performance data and feature value, differing in data distribution and in the unit of value, to be collectively handled by multiple regression analysis.

By so conducting processing as to unify in this way the sampling period and data duration of multiple kinds of sensing data and performance data, differing in original sampling period, the data are enabled in influence calculation to be introduced in equations as homogeneous data. Regarding the acceleration data on the other hand, by using a stepwise manner in which the rhythm is first figured out on a short time basis and extracted as a feature value on a daily basis, a feature value far better reflecting daily characteristics can be obtained than by trying to directly figure out the feature value on a full day basis. Regarding the meeting data on the other hand, information on mutual meeting between multiple persons is simplified in feature value extraction process by advance unification into the simple meeting combination table (SSDB_IRCT). Furthermore, processing in compensating for deficient data can be accomplished in a simple way by using the method of Embodiment 5 or the like.

### Embodiment 3

A third exemplary embodiment of the present invention will be described with reference to drawings.

The third exemplary embodiment of the invention collects subjective data and objective data as performance data and prepares balance maps(BM). The subjective performance data include, for instance, employees' fullness, perceived worthwhileness and stress, and customers' satisfaction.

The subjective data are an indicator of the inner self of a person. Especially in intellectual labor and service industries, high quality ideas or services cannot be offered unless each individual employee is highly motivated and spontaneously perform his duties. From customers' point of view as well, unlike in the mass production age, they no longer pay for substantial costs such as the material cost of the product and the labor cost, but are coming to pay for experience the value added including the joy and excitement accompanying the product or service. Therefore, in trying to achieve the objective of the organization to improve its productivity, data regarding the subjective mentality of persons have to be obtained. In order to obtain subjective data, employees who are the users of terminals (TR) or customers are requested to answer questionnaires. Or, as in Embodiment 7, it is also possible to analyze sensor data obtained from the terminals (TR) and handle the results as subjective data.

On the other hand, the use of objective performance data is also meaningful in its own way. Objective data include, for instance, sales, stock price, time consumed in processing, and the number of PC typing strokes. These are indicators traditionally measured and analyzed for the purpose of managing the organization, and have the advantages of their clearer basis of data values than subjective evaluations and the possibility of automatic collection without imposing burdens on the users. Moreover, the final productivity of the organization even today is measured by such quantitative indicators as sales and stock price, raising these indicators is always called for. In order to obtain objective performance data, available methods include acquisition of required data through connection to the organization's business data server and keeping records in the operation log with PCs which the employees regularly use.

Thus, both subjective data and objective data are necessary information items. By architecting a system permitting collective processing of these data together with a sensor network system, the organization can be analyzed both subjectively and objectively to enable the organization to improve its productivity comprehensively.

### <FIG. 32: System Diagram>

FIG. 32 is a block diagram illustrating the overall configuration of a sensor network system for realizing the third exemplary embodiment of the invention. It differs from the first exemplary embodiment of the invention in only the client for performance inputting (QC) illustrated in FIG. 4 through FIG. 6. Illustration of other parts and processing is dispensed with because similar items to the counterparts in the first exemplary embodiment of the invention are used.

In the client for performance inputting (QC), a subjective data input unit (QCS) and an objective data input unit (QCO) are present. It is supposed here that subjective data are obtained by the sending of replies to a questionnaire via the terminal (TR) worn by the user. A method by which the questionnaire is answered via an individual client PC used by the user may as well be used. On the other hand, as objective data, a method will be described as an example by which duty performance data which are quantitative data of the organization and the operation log of the individual client PC personally used by each user individual are collected. Other objective data can also be used.

The subjective data input unit (QCS) have a memory unit (QCSME), an input/output unit (QSCIO), a control unit (QCSCO) and a transceiver unit (QCSSR). Herein, the function of the subjective data input unit (QCS) is supposed to be concurrently performed by one or more terminals (TR). The memory unit (QCSME) stores programs of an input application (SMEP) which is software to let questionnaires to be inputted, an input format (SME_SS) which sets the formats of the questions of and replay data to the questionnaires, and subjective data (SMED) which are inputted answers to the questionnaire.

Further, the input/output unit (QCSIO) has the display unit (LCDD) and buttons 1 through 3(BTN1 through BTM3). These are the same as the counterparts in the terminal (TR) of FIG. 6 and FIG. 29.

The control unit (QCSCO) carries out subjective data collection (SCO_LC) and communication control (SCO_CC), and the transceiver unit (QCSSR)transmits and receives data to and from the sensor network server and the like. When conducting the subjective data collection (SCO_LC), similarly to FIG. 29, questions are displayed on the display unit (LCDD), and the user (US) inputs replies by pressing the buttons 1 through 3(BTN1 through BTM3). With reference to the input format (SME_SS), needed ones are selected out of inputted data sets, the terminal ID and input time are assigned to subjective data (SME_D) and the data are stored. These sets of data are transmitted by communication control (SCOCC) to the sensor network server (SS) matched with the data transmitting/reception timing of the terminal (TR).

In the objective data input unit (QCO), a duty performance data server (QCOG) for managing duty performance data of the organization and an individual client PC (QCOP) personally used by each user are provided. One or more units of each item are present.

The duty performance data server (QCOG) collects necessary information from information on sales and stock price existing within the same server or in another server in the network. Since information constituting the organization's secret information may be included, it is desirable to have a security mechanism including access control. Incidentally, a case of acquiring duty performance data from a different server is illustrated in the diagram for the sake of convenience as being present in the same duty performance data server (QCOG). The duty performance data server (QCOG) has a memory unit (QCOGME), a control unit (QCOGCO) and a transceiver unit (QCOGSR). Although the transceiver unit is not illustrated in the diagram, a transceiver unit including a keyboard is required when the person on duty is to directly input duty performance data into the server.

The memory unit (QCOGME) has a duty performance data collection program (OGMEP), duty performance data (OGME_D) and access setting (OGMEA) set to decide whether or not to permit access from other computers including the sensor network server (SS).

The control unit (QCOGCO) transmits duty performance data to the transceiver unit (QCOGSR) by successively conducting access control (OGCOAC) that judges whether or not duty performance data may be transmitted to the destination sensor network server (SS), duty performance data collection (OGCO_LC) and communication control (OGCOCC). In the duty performance data collection (OGCO_LC) it selects necessary duty performance data and acquires the same paired with time information corresponding thereto.

The individual client PC (QCOP) acquires log information regarding PC operation, such as the number of typing strokes, the number of simultaneously actuated windows and the number of typing errors. These items of information can be used as performance data regarding the user's personal work.

The individual client PC (QCOP) has a memory unit (QCOPME), an input/output unit (QCOPIO), a control unit (QCOPCO) and a transceiver unit (QCOPSR). In the memory unit (QCOPME), an operation log collection program (OPMEP) and collected operation log data (OPME_D) are stored. The input/output unit (QCOPIO) includes a display (OPOD), a keyboard (OPIK), a mouse (OPIM) and other external input/output units (OPIU). Records of having operated the PC with the input/output unit (QCOPIO) are collected by operation log collection (OPC_OLC), and only the required out of the records are transmitted to the sensor network server (SS). At the time of transmission, the transmission is accomplished from the transceiver unit (QCOPSR) via communication control (OPCO_CC).

These sets of performance data collected by the client for performance inputting (QC) are stored through the network (NW) into the performance data table (SSDQ) in the sensor network server (SS).

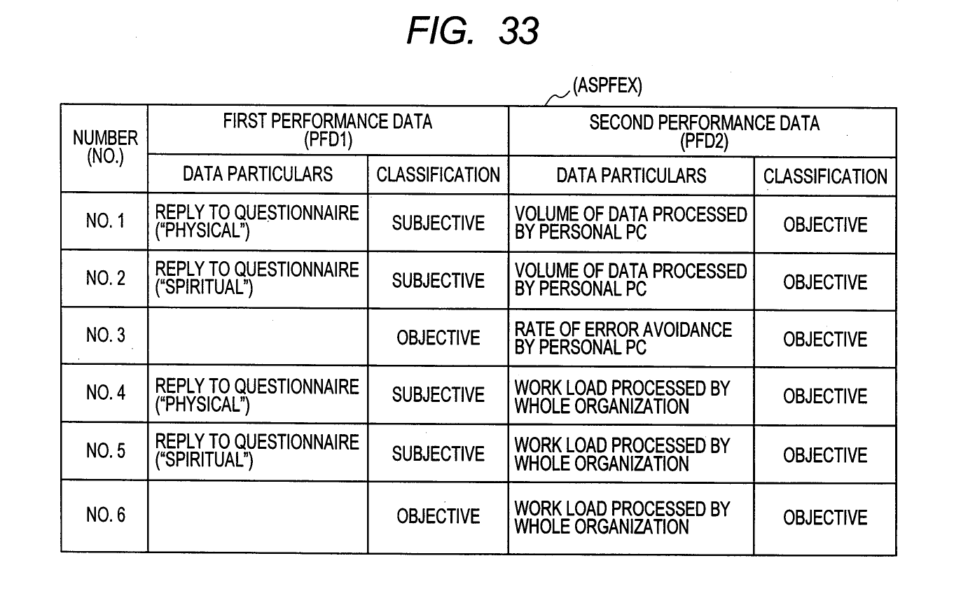

### <FIG. 33: Example of Performance Combination>

FIG. 33 shows an example of performance data combination (ASPFEX) plotted against the two axes of a balance map (BM). Regarding first performance data (PFD1) and second performance data (PFD2), the contents of data and classification between subjective and objective are shown. For the first and second performance data sets, either may be plotted against the X axis.

Performance data that can be collected by the use of the system shown in FIG. 32 include subjective data regarding individuals, objective data regarding duty performance in the organization and objective data regarding individuals' duty performance. Combinations apt to run into conflict may be selected out of many kinds of performance data in a similar way to the conflict calculation (ASCP) of Embodiment 1 shown in FIG. 14, or one combination of performance data matching the purpose of intended improvement of the organization may as well be selected.

The points of effectiveness in improving the organization by analysis using each performance data combination in FIG. 33 will be described below.

In the No. 1 combination, a balance map (BM) between the items of “physical” in the reply to the questionnaire, which are subjective data, and the quantity of data processing by the individual's PC, which are objective data, is prepared. Increasing the quantity of data processing means raising the speed of the individual's work. However, preoccupation with speeding-up may invite physical disorder. Therefore, by analyzing this balance map (BM), measures to raise the speed of the individual's work while maintaining the physical condition can be considered. Similarly, by analyzing the “spiritual” in the reply to the questionnaire and the quantity of data processing by the individual's PC in the No. 2 combination, measures to raise the speed of the individual's work without bringing down his spiritual condition, namely motivation, can be considered.

Further in the No. 3 case, the selected performance data are both objective data sets, moreover both operation logs of the individual's PC operation, namely his typing speed and rate of typing error avoidance. This is because of the generally perceived conflict that raising the typing speed invites an increase in errors, and the purpose is to search for a method to resolve that conflict. In this case, though both sets of performance data are log information on PC, selection of feature values to be plotted on the balance map (BM) are so made as to include the acceleration data and meeting data acquired from the terminal (TR). Analysis in this way may identify loss of concentration due to frequent talks directed to the person or impatience due to hasty moves as factors relevant to typing errors.

In the No. 4 case, a combination of “physical” in the reply to the questionnaire and the overall volume of duty performance in the organization is selected, while in the No. 5 case, the “spiritual” in the reply to the questionnaire and the overall volume of duty performance in the organization is selected. Corporate management may often ignore individuals' sentiment or health in pursuit of higher overall productivity (the volume of duty performance) in the organization. In view of this point, by conducting analysis combining the individual's subjective data and the organization's objective data as in No. 4 and No. 5, management to make each individual worker's sentiment and health compatible with the productivity of the organization is made possible. Moreover, since sensing data reflecting employees' actions are used as feature values, management taking note of changes in employees' actions can be realized.

Further in the No. 6 case, a combination of the organization's whole communication quantity and the whole quantity of duty performance in organization according to sensing data is selected. In this case, both are objective data. Between the communication quantity and the duty performance quantity, conflict presumably occur in some cases and not in other cases. In a type of duty performance calling for sharing of information, these factors will not come into conflict, but in performing duty of a basically manual work type, there may occur conflict that a smaller communication quantity would contribute to increasing the duty performance quantity. However, communication in an organization is a necessary element in a long term perspective that fosters the attitude of cooperation among employees and helps creation of new ideas. In view of this point, analysis using a balance map (BM), or analysis of actions that give rise to conflict and actions that do not, management that makes the duty performance quantity effective on a short term basis compatible with the communication quantity effective in a long term outlook can be realized.

By realizing a system that collects subjective performance data and objective performance data and processing them collectively in conjunction with sensing data, the organization can be analyzed in both aspects, including the psychological aspect of the persons concerned and the aspect of objective indicators, and the productivity of the organization can be improved in comprehensive dimensions.

### Embodiment 4

A fourth exemplary embodiment of the present invention will be described with reference to drawings.

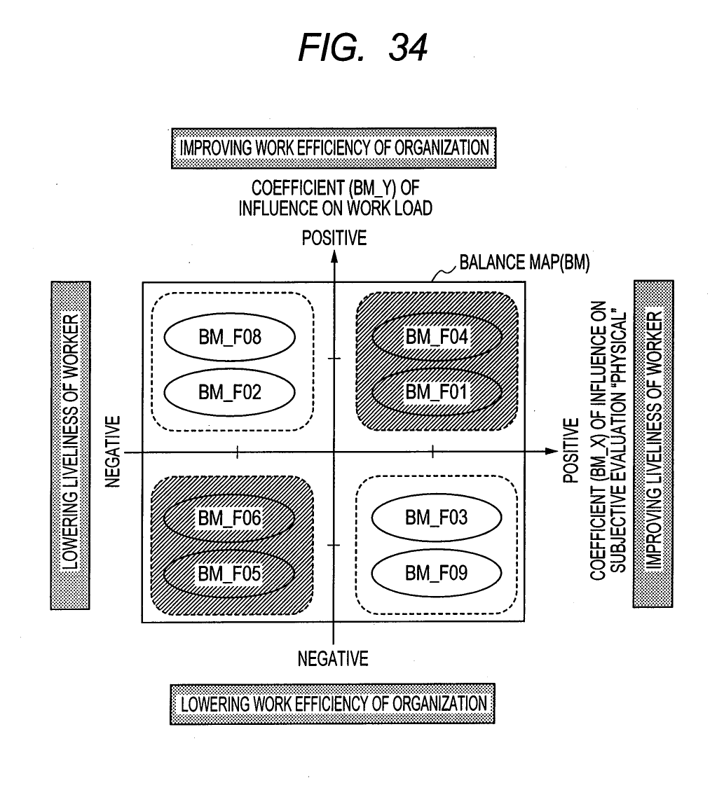

### <FIG. 34: Balance Map>

FIG. 34 shows an example of the fourth exemplary embodiment of the invention. The fourth exemplary embodiment of the invention is a method of representation by which, in the balance maps of the first through third exemplary embodiments of the invention, only the quadrant in which each feature value is positioned is taken note of and the name of the feature value is stated in characters in each quadrant. The name need not be directly represented, but any other method of representation that makes recognizable the correspondence between the name of each feature value and the quadrant can as well be used.

The method of plotting the coefficient of influence counts on a diagram as shown in FIG. 3 is meaningful to analyzers engaged in detailed analysis, but when the result is feedback to general users, the users will be preoccupied with understanding the meaning of the counts and find it difficult to understand what the result means. In view of this problem, only the information on the quadrant in which each feature value is positioned, which is the essence of this balance map. On that occasion, since feature values one of whose coefficients of influence is closed to 0, namely those plotted near the X axis or the Y axis in the balance map of FIG. 3, are not clear as to the quadrant in which they are positioned and cannot be regarded as important indicators in the balance map, they are not represented. In this connection, a threshold of the coefficient of influence for representation is prescribed, and a process to select only those feature values whose coefficients of influence on the X axis and the Y axis are at or above the threshold are selected is added.

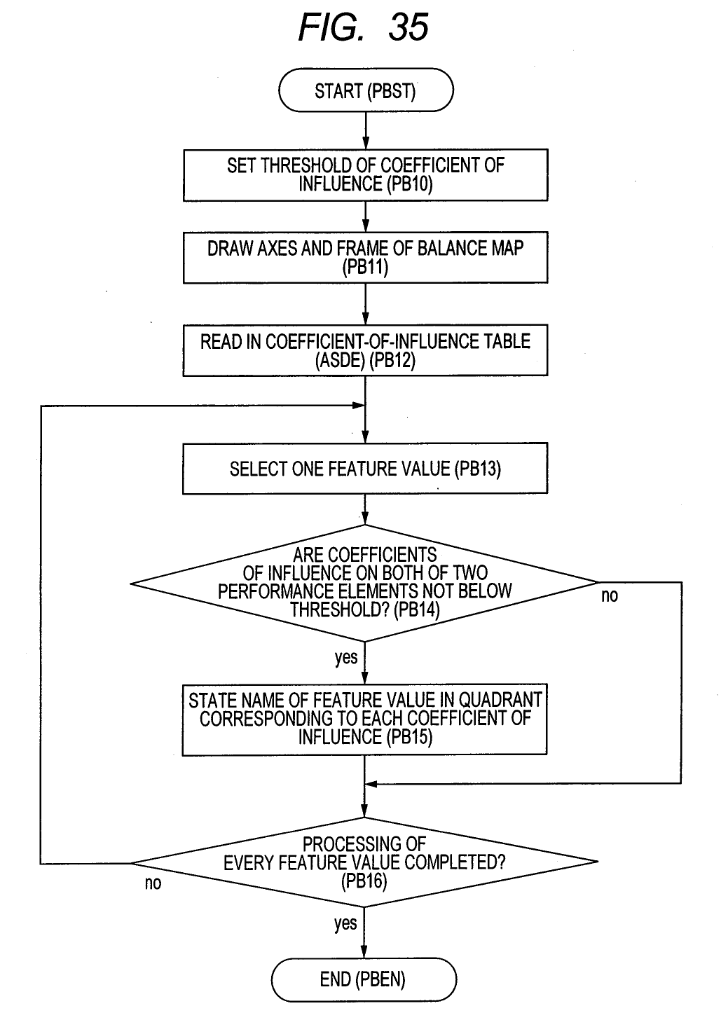

### <FIG. 35: Flow Chart>

FIG. 35 is a flow chart showing the flow of processing to draw the balance map of FIG. 34. As the overall process from the acquisition of sensor data till the displaying of a visual image on the screen, a similar procedure to that for Embodiment 1 illustrated in FIG. 13 is used. Only the procedure for the balance map drawing (ASPB) is replaced by what is shown in FIG. 35.

After start (PBST), first, in order distinguish positioning in a balanced region or an unbalanced region, a threshold for the coefficient of influence is set (PB10). Next, the axes and frame of the balance map are drawn (PB11), and the coefficient-of-influence table (ASDE) is read in. Then, one feature value is selected (PC 13). The process (PB11 through PB13) is carried out by the same method as in FIG. 15. Next, regarding the selected feature value, it is judged whether or not the coefficients of influence on the two performance elements of that feature value are at or above the threshold (PB14). If they are found at or above the threshold, the corresponding quadrant is judged from the positive/negative combination of those coefficients of influence, and the name of feature value is entered into that quadrant (PB15). This process is repeated until the processing of every feature value is completed (PB16) to end the processing (PBEN).

In this way, by representing on the balance map (BM) only what region of the four quadrants each feature value belongs to by the name of the feature value, the minimum required information, namely the characteristics each feature value has is made simply readable. This is useful in explaining the analytical result to general users or the like, who require no detailed information, such as the counts of the coefficients of influence.

### Embodiment 5

A fifth exemplary embodiment of the present invention will be described with reference to drawings. The fifth exemplary embodiment of the invention is processing to extract meeting and change in posture during meeting ((BM_F01 through BM_F04) in the list of examples of feature value (RS_BMF) in FIG. 10), which is one example of feature value for use in the first through fourth exemplary embodiments of the invention. It corresponds to the processing of the feature value extraction (ASIF) shown in FIG. 13.

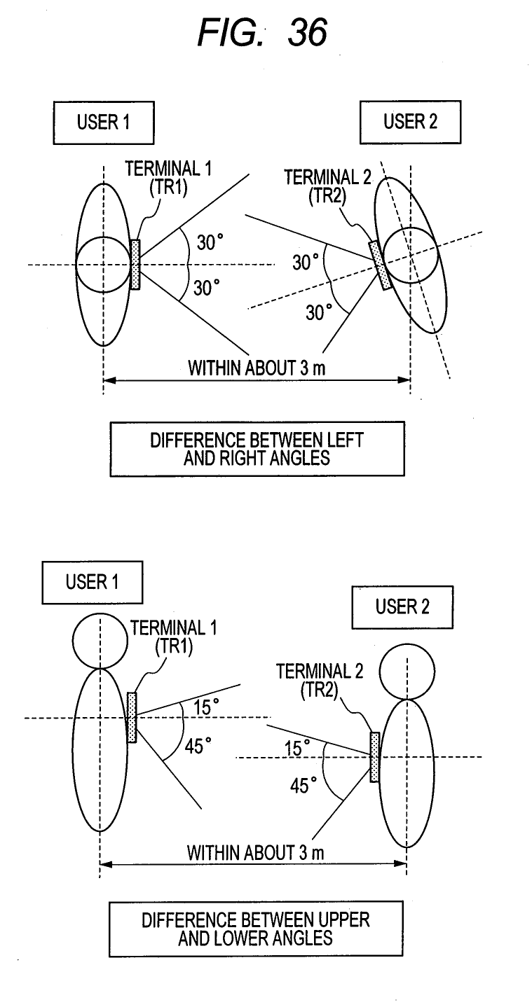

### <FIG. 36: Detection Range of Meeting Data>

FIG. 36 is a diagram showing an example of detection range of meeting data in the terminal (TR. The terminal (TR) has multiple infrared transceivers, which are fixed with angle differences up and down and right and left to permit detection in a broad range. As these infrared transceivers, as they are intended to detect a meeting state in which persons face and converse with each other, their detecting range, for instance, is 3 meters, and detecting angle is 30 degrees each right and left, 15 degrees upward and 45 degrees downward. These features embody considerations for capability to detect meeting in a state in which the persons are not fully opposite each other, namely they are facing obliquely, between persons differing in height, or where one is seated and the other is standing upright.

In analyzing relevance to productivity in an organization, the types of communication desired to be detected ranges from reports or liaison taking around 30 seconds to conferences continuing for around two hours. Since the contents of communication differs with the duration of the communication, the beginning and ending times of the communication and its duration should be correctly sensed.

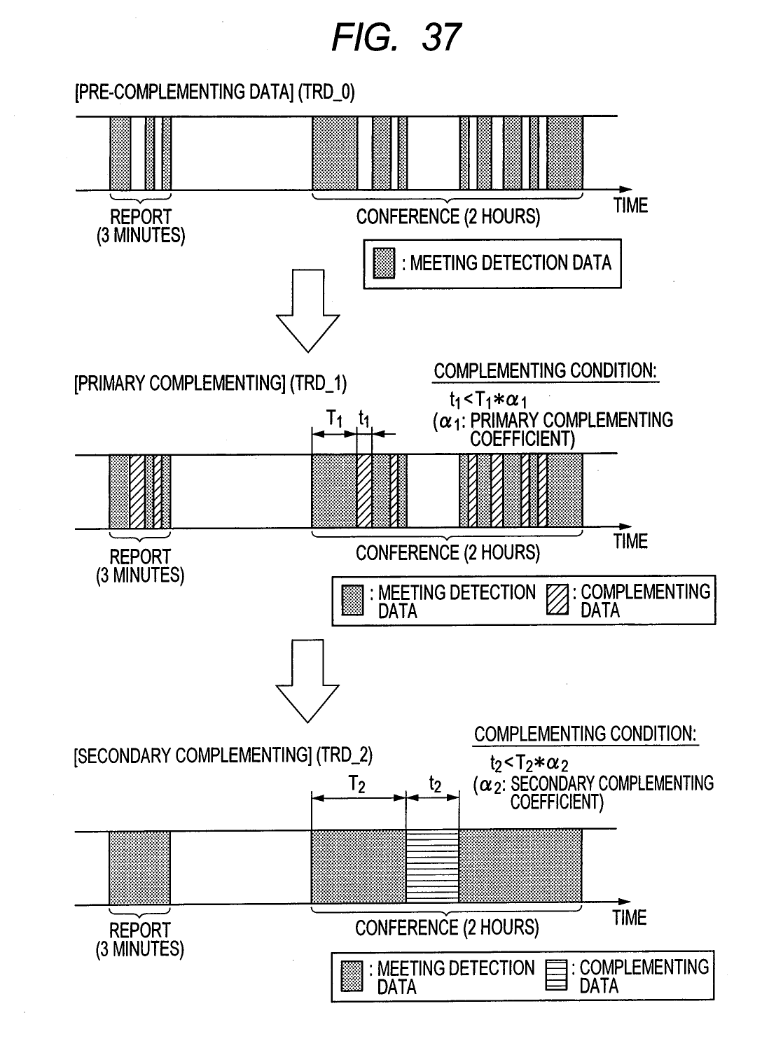

However, though whether meeting took place or not is discerned in the order of 10 seconds in meeting data, if a series of consecutive entries of meeting data is counted as one communication event, short meetings are counted as more and long ones will be counted less than the actual number of communication events. Meeting detection data often come in small lots as do pre-complementing data (TRD_O) in FIG. 37, for instance. A presumable reason for this is that, as a person often moves his body when he is speaking, and the maximum moving range right and left then is 30 degrees or more, the whole duration of meeting is not detected by infrared transceivers. Also, in long conferences, long silences in the order of minutes occur between persons positioned face to face. This presumably is because during a conference there are periods of varied bodily direction as the speaker changes or the listener watches slides.

Then, it is necessary to appropriately complement blanks in meeting detection data. However, where an algorithm that complements any blank time not longer than a certain threshold is used, if the threshold is too high, meeting detection data which should concern another event will become integrated; if, conversely, the threshold is too low, there will emerge a problem that a long meeting event is split. Therefore, by utilizing the characteristic that a particularly long meeting event there often exist long consecutive meeting detection data, blanks are divided into two stages, short and long ones, and each is complemented separately. Incidentally, complementing may as well be made in three or more stages.

### <FIG. 37: Two-Stage Complementing Method>

FIG. 37 shows a diagram illustrating a process of two-stage complementing of meeting detection data. The fundamental rule of complementing is that completing should be done where the blank time width (t1) is smaller than a certain multiple of the continuous duration width (T1) of the meeting detection data immediately before. The coefficient that determines the conditions of that complementing is represented by α, and the same algorithm is made usable for complementing two-stage complementing, including complementing of short blanks and complementing of long blanks by varying the primary complementing coefficient (α1) and secondary complementing coefficient (α2). Further, for each stage of complementing, the maximum blank time width to be complemented is set in advance. By temporary complementing (TRD_1), a short blank is complement. This enables blanks in short meeting, such as reporting of around three minutes' length, to be filled to make the event continuous. Also for conferences of around two hours, fragmental meeting detection data are complemented to produce large meeting blocks and blank blocks. Further, secondary complementing (TRD_2) complements even large blank blocks during conferences. Although it was stated in this context that whether to complement or not was to be determined in proportion to the continuous duration (T1) of the meeting immediately before the blank time width (t1), it can as well be determined in proportion to the continuous duration of the meeting immediately after the blank time. Also, it can be determined according to both, immediately before and immediately after. In this case, it is made proportional to the sum of durations immediately before and immediately after, or there also is a method by which the method proportional to immediately before and that proportional to the immediately after are executed twice. Where the method proportional to immediately before or immediately after is used, the time length of execution and the quantity of memory use can be saved. The method of determination using both immediately before and immediately after has the advantage of permitting the duration of meeting with high precision.

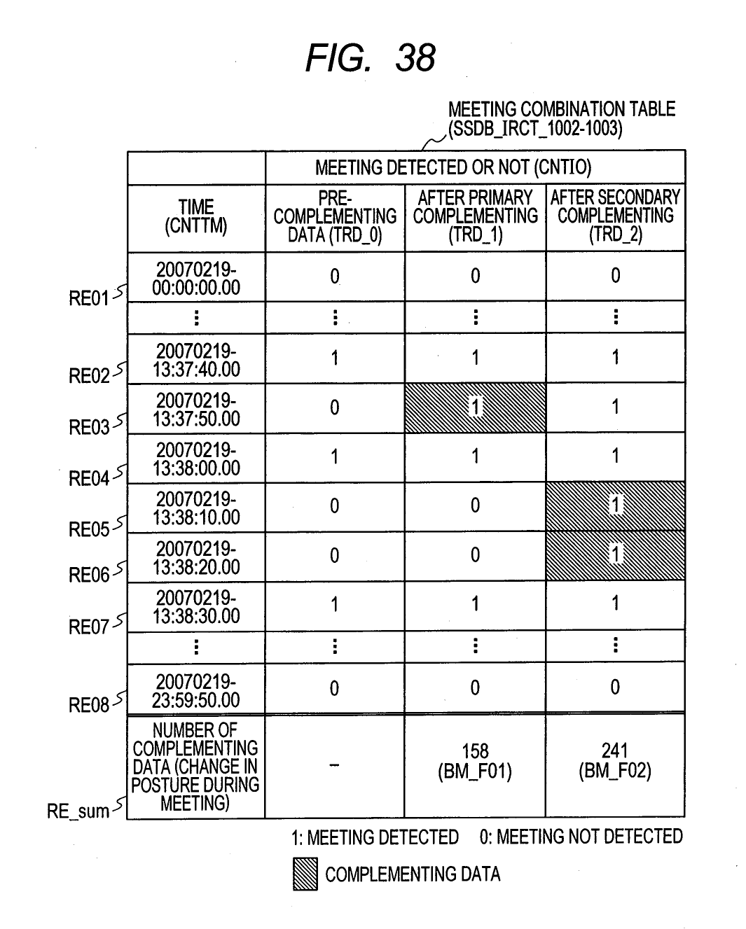

FIG. 38 shows a case in which the complementing process shown in FIG. 37 is represented by changes in values in the meeting combination table (SSDB_IRCT_1002-1003) for one actual day. Further in each of the primary and secondary complementing procedures, the number of complemented data is counted, and the counts are used as feature values “(1) Change in posture during meeting (insignificant) (BMF01)” and “(2) Change in posture during meeting (significant) (BMF02)”. This is because the number of deficient data is supposed to reflect the number of times of posture change. Further by counting, in the meeting combination table (SSDB_IRCT_1002-1003) having gone through secondary complementing, the number of continuation of meeting detection data for a certain length of time, the feature values “(3) Meeting (short)” (BM_F03) and “(4) Meeting (long)” (BMF04) are extracted.

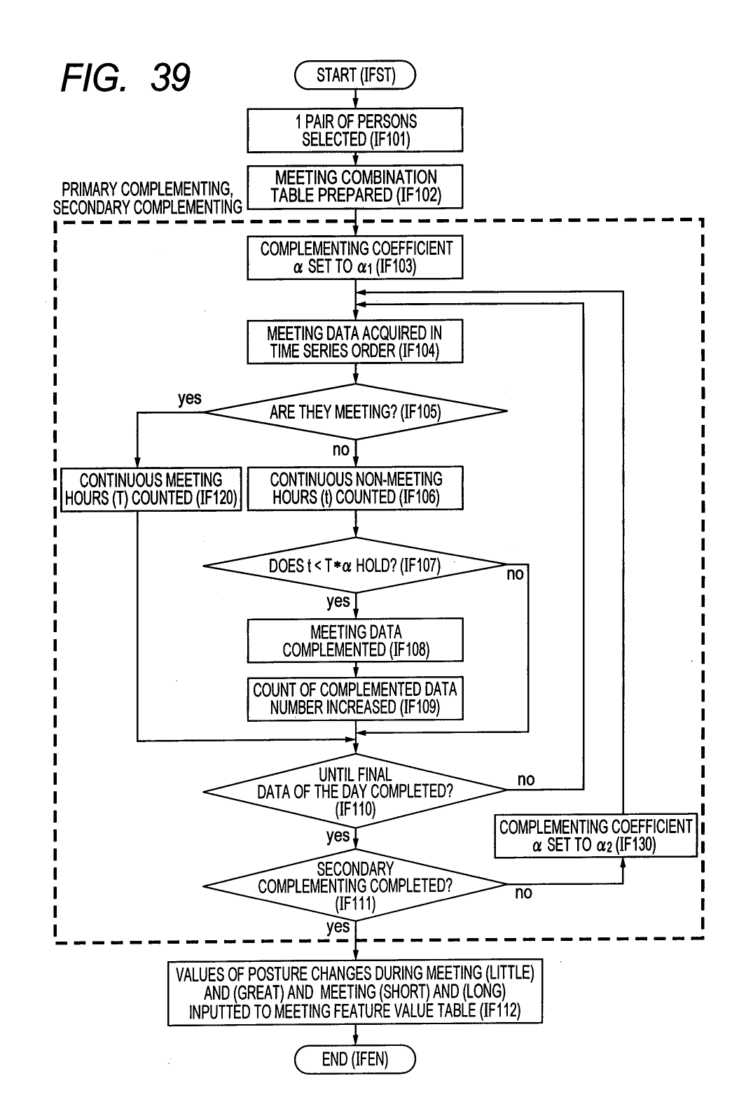

FIG. 39 is a flow chart that shows the flow of processing from complementing of meeting detection data until extraction of “(1) Change in posture during meeting (insignificant) (BMF01)”, “(2) Change in posture during meeting (significant) (BMF02)”, “(3) Meeting (short)” (BM_F03) and “(4) Meeting (long)” (BMF04). This is one of the steps of processing in the feature value extraction (ASIF) in Embodiments 1 through 4.

After start (IFST), one pair of persons are selected (IF101), and the meeting combination table (SSDB_IRCT) between those persons is prepared. Next, in order to conduct primary complementing, the complementing coefficient α is set to α=α1 (IF103). Next, meeting data are acquired from he meeting combination table (SSDB_IRCT) in the order of time series (IF104) and, if there is meeting (namely the count is 1 in the table of FIG. 38) (IF105), the length of duration of meeting (T) therefrom is counted and stored (IF120). Or if there is no meeting, the duration (t) of continuous absence of meeting therefrom is counted (IF106). Then the product of multiplication of the duration of continuous meeting (T) immediately before by the complementing coefficient α is compared with the duration of non-meeting (t) (IF107), and if t<T*α holds, the data equivalent to that blank time are replaced by 1. Thus, the meeting detection data are complemented (IF108). Also, the number of complemented data is counted here (IF109). The number counted here is used as the feature value “(1) Change in posture during meeting (insignificant) (BM_F01)” or “(2) Change in posture during meeting (significant) (BMF02)”. And the processing of (IF104 through IF109) is repeated until that of the day's final data is completed (IF110). Upon completion, the primary complementing is deemed to have been completed and, setting the complementing coefficient α to α=α2, the secondary complementing is accomplished by similar processing (IF104 through IF110). Upon completion of the secondary complementing (IF111), the counts of the feature values “(1) Change in posture during meeting (insignificant) (BMF01)”, “(2) Change in posture during meeting (significant) (BMF02)”, “(3) Meeting (short)” (BM_F03) and “(4) Meeting (long)” (BMF04) are figured out, and each is inputted to the appropriate place in a meeting feature value table (ASDF_IR1DAY) (IF112) to end the processing IFEN).

By two-stage complementing of meeting data with different thresholds in this way, both short meeting events and long meeting events can be extracted with high precision. Furthermore, by using the number of complemented data here as the feature value of change in posture during the meeting, the time length of processing can be shortened and the quantity of memory use can be saved.

### Embodiment 6

A sixth exemplary embodiment of the present invention will be described with reference to drawings.

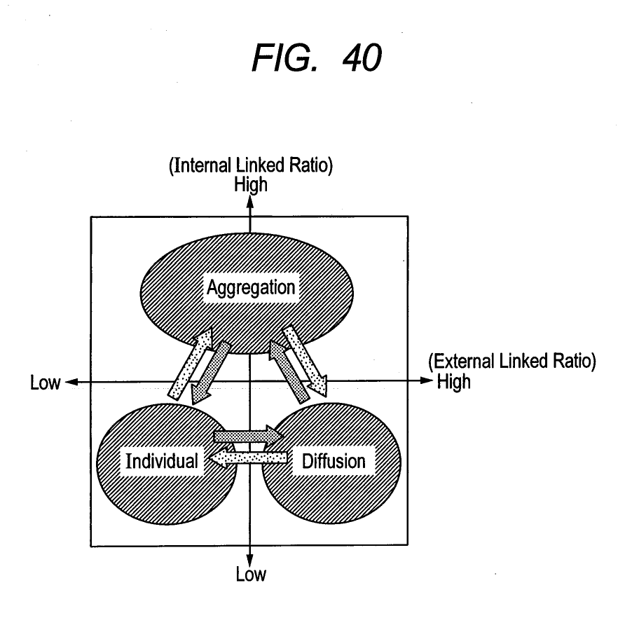

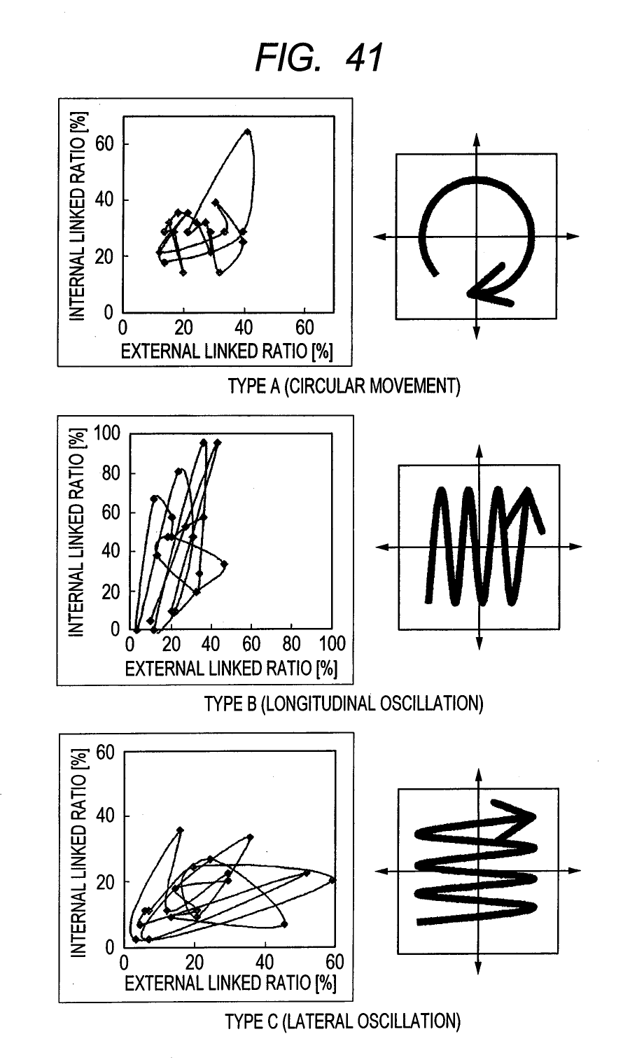

### <FIG. 40 and FIG. 41: Outline of Communication Dynamics>

FIG. 40 is a diagram illustrating the outline of phases in the communication dynamics in the sixth exemplary embodiment of the invention.

In an organization where creativity is particularly required, appropriate changes are necessary instead of allowing duty performance in the same way from day to day. Especially regarding the relationship between communication and creativity, it is necessary to seek well-balanced obtainment of new information and receiving stimulus through communication with many persons with whom there is no usual contact (Diffusion), have in-depth discussions among colleagues until decision making (Aggregation) and enhance the quality of output by thinking alone and putting ideas into writing (Individual).

The sixth exemplary embodiment of the invention is intended to visualize the dynamics of these characters of communication by using meeting detection data with the terminal (TR). An in-group linked ratio, which is the number of times a given person or organization has met persons within the same group and an extra-group linked ratio, which is the number of times of meeting with persons of another group are taken from meeting detection data as the two coordinate axes. More accurately, as a certain reference level is determined for the number of persons and the ratio of the number of persons to the reference level is plotted, it is called the link “ratio”. In practice, if external communication is represented on one axis and communication with the inner circle is on the other, some other indicators may be represented on the axes.

By representation on the two axes as in FIG. 40, the phases can be classified in a relative way, such as the phase of “Aggregation” when the in-group linked ratio is high, the phase of “Diffusion” when the extra-group linked ratio is high but the in-group linked ratio is low, and the phase of “Individual” when both ratios are low. Further by plotting the values of the two axes at regular intervals, such as every day or every week and linking the locuses with a smoothing line, the dynamics can be visualized.

FIG. 41 shows an example of representation of communication dynamics, together with a schematic diagram in which different shapes of dynamics are classified.

The circular movement pattern of Type A is a pattern in which the phases of aggregation, diffusion and individual are passed sequentially. An organization or a person leaving behind such a locus can be regarded as skillfully controlling each phase of knowledge creation.

The longitudinal oscillation pattern of Type B is a pattern in which only the phases of aggregation and individual are repeated. Thus, an organization or a person leaving behind such a locus is alternately repeating discussions in the inner circle and individual work. If this way of working is continued for a long period, it will involve the risk of losing opportunities to known new ways of thinking in the outer world, and therefore an opportunity for communication with external persons should be made from time to time.

The lateral oscillation pattern of Type C is a pattern in which only the phases of diffusion and individual are repeated. Thus, an organization or a person leaving behind such a locus is alternately repeating contact with persons outside and individual work, and the teamwork conceivably is not very powerful. If this way of working is continued for a long period, it will become difficult for members to share one another's knowledge and wisdom, and therefore it is considered necessary for the members of the group to have an opportunity form time to time to get together and exchange information.

By visualizing and classifying the patterns of dynamics in this way, it is made possible to find problems that organization or individual is faced in the daily process of knowledge creation. By planning appropriate measures to address those problems, buildup of a more productive organization can be realized.

To add, Types A through C are classified by the inclination of the smoothing line connected with the shape of the distribution of plotted points. For each type, the shape of the distribution of points is determined and classified into round, longitudinally long and laterally wide shapes and the inclination of the smoothing line, into a mixture of longitudinal and lateral, dominantly longitudinal and dominantly lateral ones.

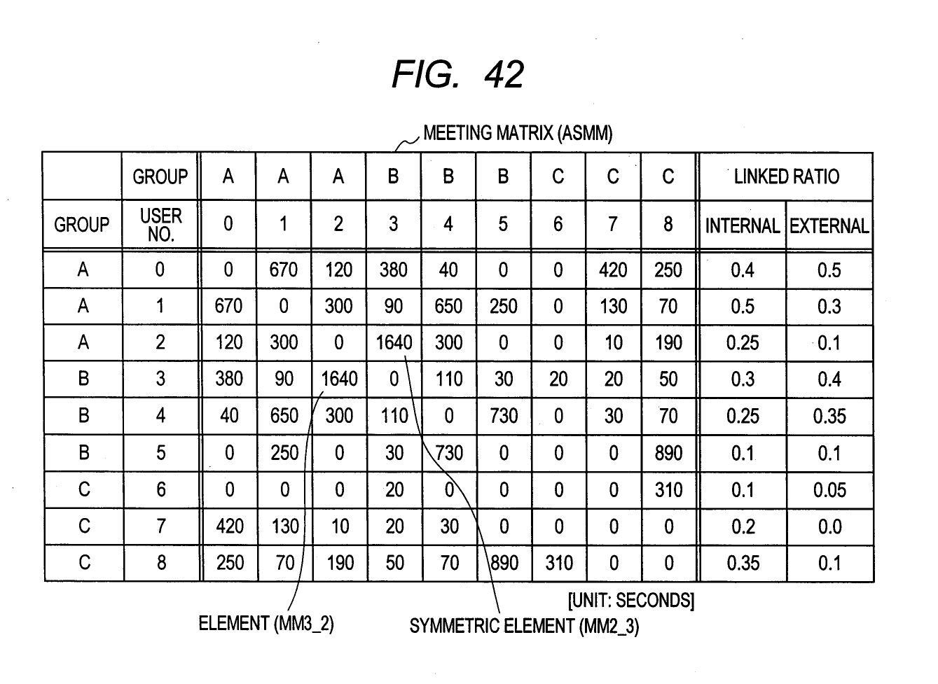

### <FIG. 42: Meeting Matrix>

FIG. 42 is an example of meeting matrix (ASMM) in a certain organization. It is used for calculating the linked ratio between the axis of ordinates and the axis of abscissas in communication dynamics. When points are to be plotted day by day in communication dynamics, one meeting matrix is prepared per day. In the meeting matrix (ASMM), a user (US) wearing a terminal (TR) is positioned on each line and each row, and the value of elements where they cross represent the time of meeting between the users in a day. By preparing a meeting combination table (SSDBIRCT) of FIG. 23 for every combination of persons and figuring out the total length of time of their meeting each other in a day, the meeting matrix (ASMM) is prepared. Further, by referencing the user-ID matching table (ASUIT) of FIG. 17, distinction is made between meeting another person in the same group and meeting with a person in another group, and the in-group linked ratio and the extra-group linked ratio are calculated.

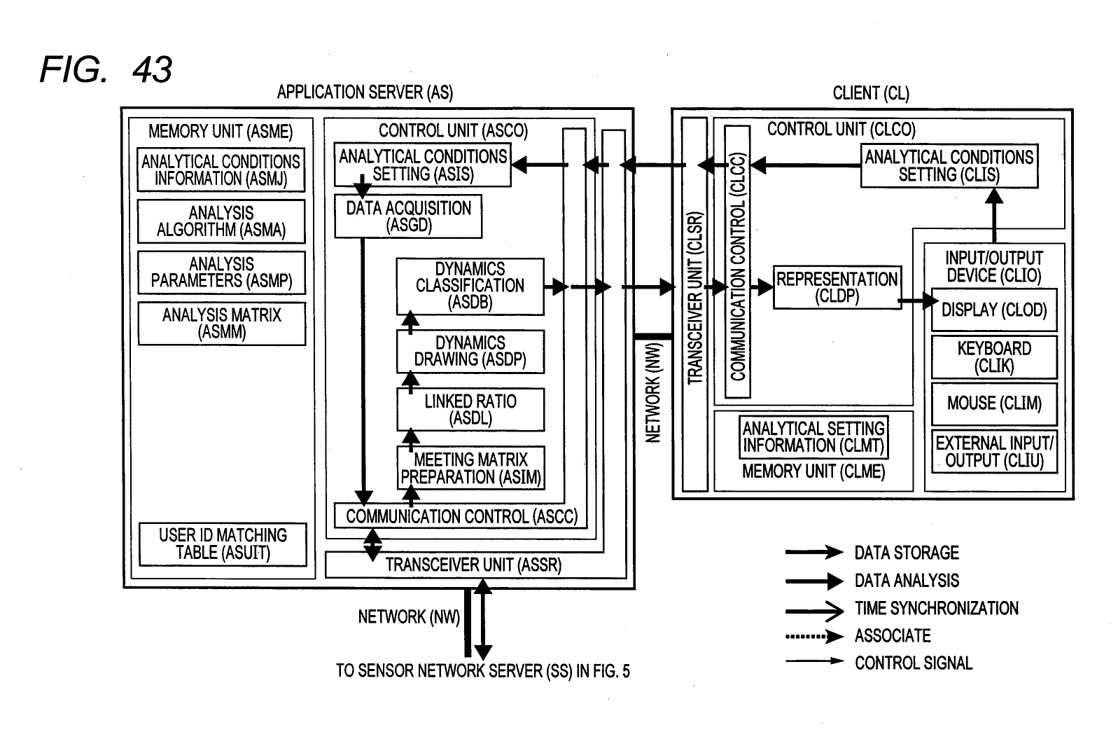

### <FIG. 43: System Diagram>

FIG. 43 is a block diagram illustrating the overall configuration of a sensor network system for drawing communication dynamics, which is the sixth exemplary embodiment of the invention. It only differs in the configuration of the application server (AS) in the first exemplary embodiment of the invention as shown in FIG. 4 through FIG. 6. Illustration of other parts and processing is dispensed with here because items similar to those in the first exemplary embodiment of the invention are used. Further, as no performance data are used, the client for performance inputting (QC) is dispensable.

In the memory unit (ASME) in the application server (AS), the meeting matrix (ASMM) is present as a new constituent element. In the control unit (ASCO), after the analytical conditions setting (ASIS), necessary meeting data are acquired by the data acquisition (ASGD) from the sensor network server (SS), and a meeting matrix is daily prepared by using the data (ASIM). And the in-group and extra-group linked ratios are calculated (ASDL), and the dynamics is drawn (ASDP). In the dynamics drawing (ASDP), the values of the in-group and extra-group linked ratios are represented on the two axes and plotted. Further, the points are linked with a smoothing line in the order of time series. And processing is done in a procedure of classifying the patterns of dynamics (ASDB) by the shape of dot distribution and the inclination of the smoothing line.

By representing in this way on the two axes the in-group linked ratio and the extra-group linked ratio figured out of the meeting data of the terminal (TR) and plotting changes in time series, the dynamic pattern of phase changes of the organization or the individual can be visualized and analyzed. This makes possible discovery of any problem in the knowledge creating process of the organization or individual and planning of appropriate measures against the problem to contribute to further enhancement of creativity.

### Embodiment 7

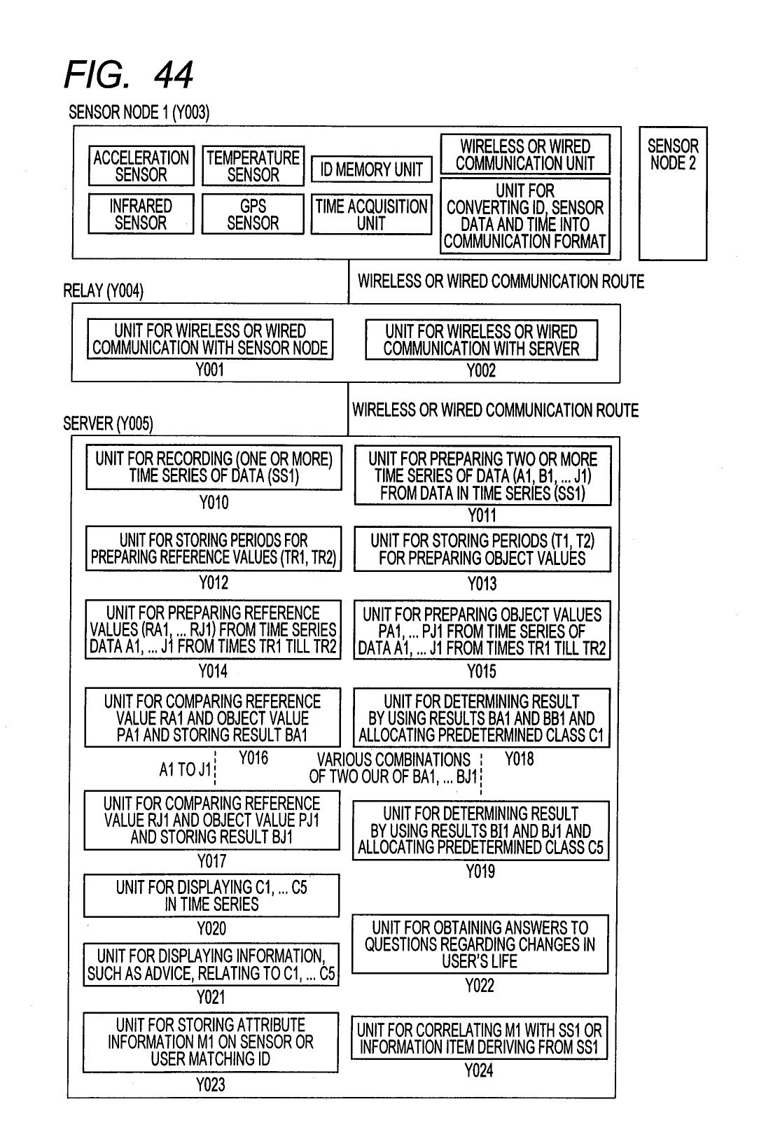

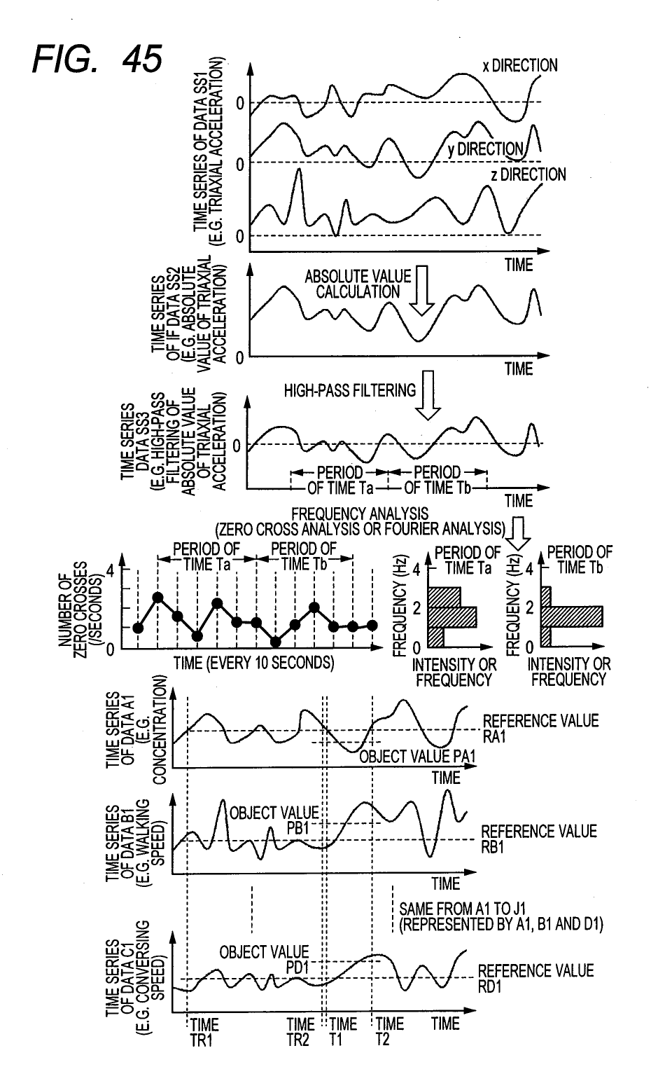

A seventh exemplary embodiment of the present invention will be described with reference to drawings. With reference to FIG. 44 through FIG. 53, Embodiment 7 will be described.

<FIG. 44 through FIG. 45: System Configuration and Process of Data Processing>

The overall configuration of the sensor network system for realizing the exemplary embodiment of the invention will be described with reference to the block diagram of FIG. 44.

There are multiple sensor nodes and each of the sensor nodes (Y003) is provided with the following: an acceleration sensor for detecting motions of the user and the direction of the sensor node; an infrared rays sensor for detecting any meeting between users; a temperature sensor for measuring the ambient temperature of the user; a GPS sensor for detecting the position of the user; a unit for storing IDs for identifying this sensor node and the user wearing it; a unit for acquiring the current point time, such as a real time clock; a unit for converting IDs, data from the sensors and information on the current point of time into a format suitable for communication (for instance, converting data with a microcontroller and firmware), and a wireless or wired communication unit. As the sensor nodes, what were described in connection with another exemplary embodiment of the invention can be used.

Data obtained from sensors, such as the acceleration sensor by sampling, time information and IDs are sent by the communication unit to a relay (Y004) and received by a communication unit Y001. The data are further sent to a server (Y005) by a unit Y002 for wireless or wired communication with the server.

In the following, description will be made with reference to FIG. 45 with respect to sensor data acquired by the acceleration sensor by way of example, but the invention is extensively applicable to other sensor data and other data varying in time series as well.

Data arrayed in time series (SS1, as an example of this set of data, the acceleration data in the x, y and z axial directions of the tri-axial acceleration sensor are used) are stored into the storage unit of Y010. Y010 can be realized with a CPU, a main memory and a memory unit such as a hard disk or a flash memory and by controlling these items with software. Multiple time series of data obtained by further processing of the time series of data SS1 are prepared. This preparing unit is denominated Y011. In this exemplary embodiment, 10 time series of data A1, B1, . . . J1 are generated. How to figure out A1 will be described below.

From the tri-axial acceleration data, their absolute values are calculated. The magnitude of acceleration is thereby expressed. Time series of data SS2 of 0 or positive in value are obtained. By further having SS2 pass through a high-pass filter, conversion into a waveform (time series of data) that rises or falls centering on 0 is achieved. This is to be denoted by SS3.

Further at fixed intervals of time (this is referred to as Ta or Tb in the drawing; at five minutes' intervals for instance), this series of waveform data are analyzed, and a frequency intensity (frequency spectrum or frequency distribution) is obtained therefrom. As a way to achieve this, FFT (fast Fourier transform) can be used. Another way, for instance, of analyzing the waveform at about 10 seconds' intervals and counting the number of zero crosses of the waveform can also be used. By putting together this frequency distribution of the number of zero crosses for the five minutes' period, the illustrated histogram can be obtained. Putting together such histograms at 1 Hz intervals also gives a frequency intensity distribution. This distribution obviously differs between the time Ta and the time Tb.

When a person becomes absorbed and wholeheartedly devoted to an activity beside himself, he enters into a state of great fullness, which is called “flow” in psychological terminology.

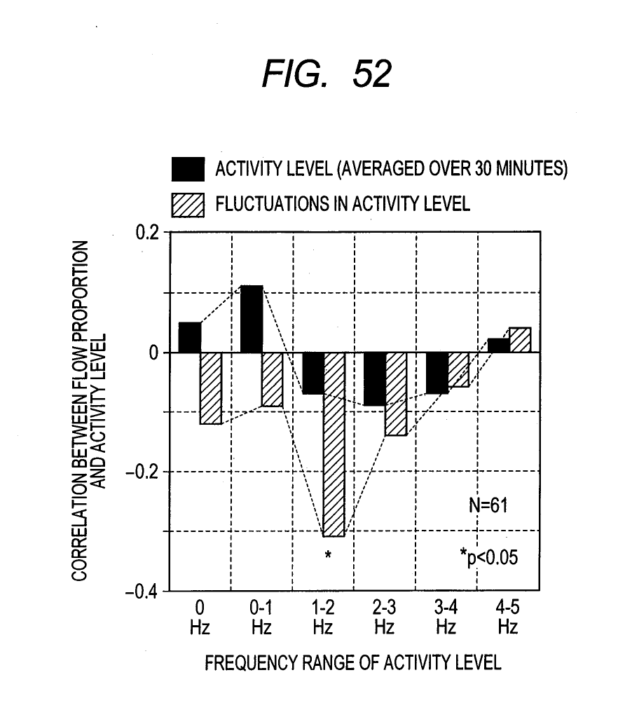

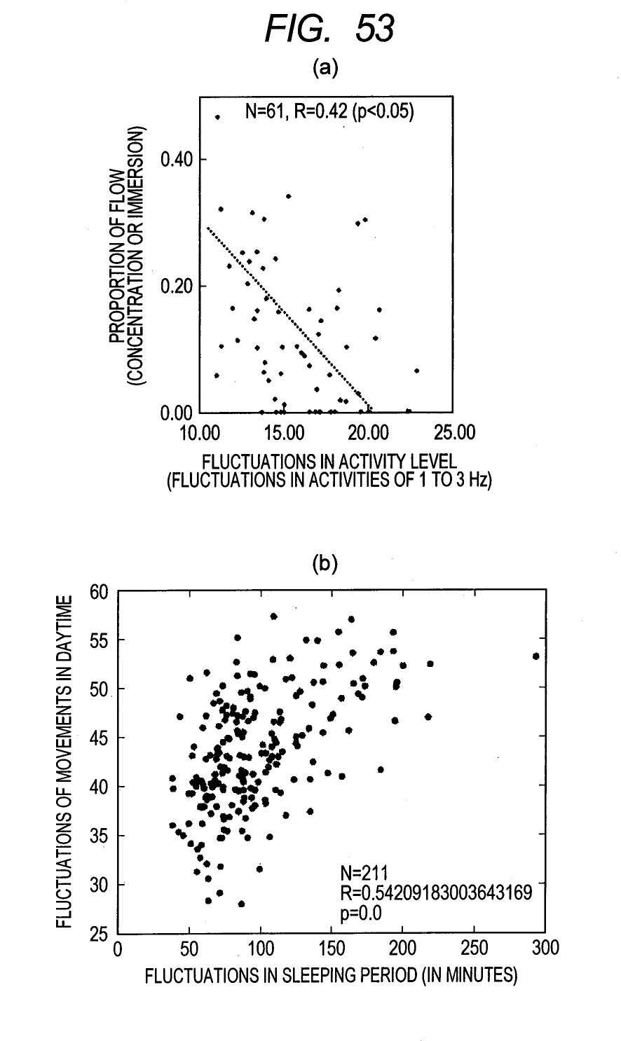

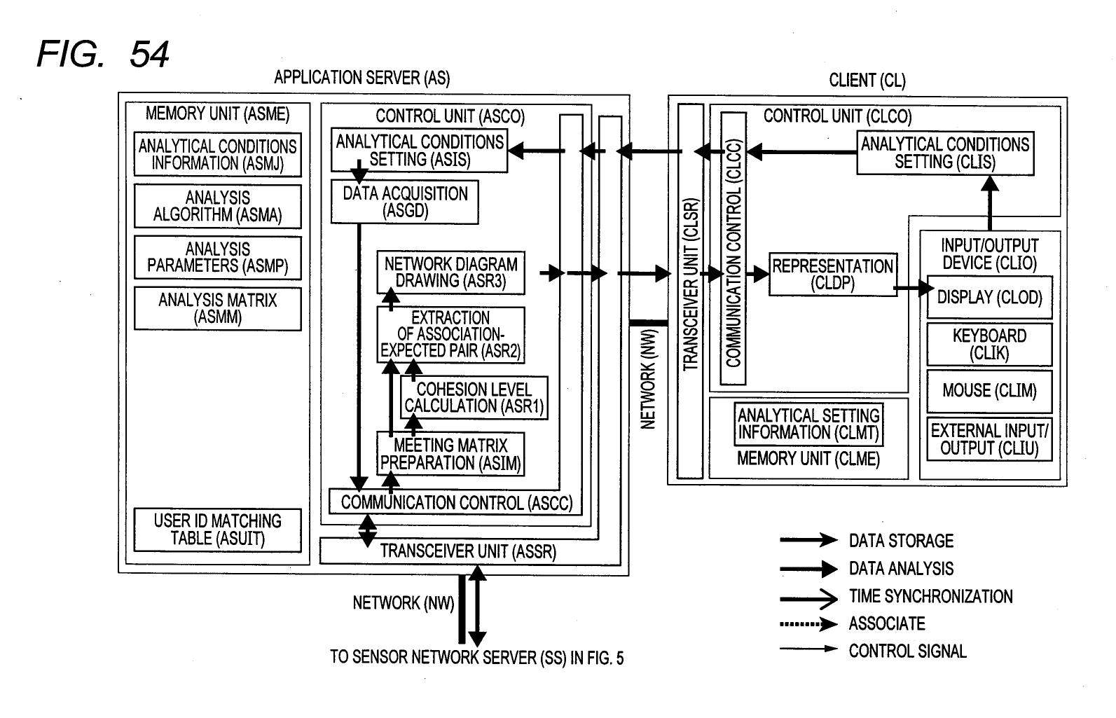

Traditionally, whether one is in a flow state or not has been studied by means of interview or questionnaire, but no method of measuring it with hardware has been known. As measurement results in FIG. 52 and FIG. 53 (a) indicate, we discovered a strong correlation between flow and fluctuations in activity level.

FIG. 52 shows the correlation between an activity level and fluctuations in activity level obtained by analyzing flow (fullness, perceived worthwhileness, concentration and immersion) obtained by a questionnaire survey and data from the acceleration sensor. The activity level in this context indicates the frequency of activities within each frequency band (measured for 30 minutes), and the fluctuations in activity level are representations in standard deviation of how much this activity level varies in a period of a half day or longer. As a result of analysis of data on 61 persons, the correlation between the activity level and flow was found insignificant, about 0.1 at the maximum. By contrast, the correlation between fluctuations in activity level and flow was significant. Especially, fluctuations of motions in the frequency band of 1 to 2 Hz (which were measured by a name plate placed on the body, but this frequency finding was similar in any other form or from placement of the plate in any other region) manifested a correlation of minus 0.3 or more with flow. Besides this study, acquisition of many sets of data resulted in the world's first discovery by the inventor of a correlation of motions of 1 to 2 Hz or 1 to 3 Hz with flow.

Thus it was found that especially fluctuations of 1 to 3 Hz motions or unevenness of motions make flow difficult to emerge and, conversely, insignificant fluctuations, namely consistency, of 1 to 3 Hz motions would readily lead to flow. In order for a person to perceive fullness, a person further to enjoy his work, a person further to achieve growth and a person further to work with high productivity, flow is known to be important. By measuring the fluctuations (or conversely consistency) of motions as noted above, a person's perception of fullness or productivity improvement can be supported.

As shown in FIG. 53 (b), the inventor further found fluctuations or unevenness of motions in the daytime (the smaller the more conducive to flow) by measuring many subject persons 24 hours a day for one year or longer correlated to fluctuations in the length of sleep. This finding makes it possible to increase flow by controlling the length of sleep. Since flow constitutes the source of a person's perceived fullness, it an epochal discovery that changes in specific activity could enhance perceived fullness. Like fluctuations in the length of sleep, quantitative fluctuations related to sleep, such as fluctuations in the time of getting up and fluctuations in the time of going to bed, similarly affect flow. Enhancing flow, a personal sense of fullness, perceived worthwhileness or happiness in life by controlling sleep or urging sleep control is included in the scope of the invention.

By utilizing this correlation, replacement of what describes flow, or concentration or consistency of (insignificant fluctuations in) motions in the following description with consistency of (or, conversely, fluctuations in) sleep or quantities related to sleep also is included in the scope of the invention.

This exemplary embodiment is characterized in that it detects a time series of data relating to human motions and, by converting that time series of data, figures out indicators regarding fluctuations, unevenness or consistency of human motions, determines from those indicators insignificance of fluctuations or unevenness or significance of consistency and thereby measures the flow.

And, on the basis of that result of determination, it visualizes the desirable state of a person or of an organization to which the person belongs. The indicators of these fluctuations, unevenness or consistency of motions will be described below.

For representation of fluctuations in motion, time-to-time fluctuations (or variations) in frequency intensity can be used. In particular for that indicator, variations in intensity can be recorded, for instance, every five minutes, and differences at five minutes' intervals can be used. Besides this, an extensive range of indicators relating to fluctuations in motion (or acceleration) can be used. Furthermore, variations in ambient temperature or illuminance or ambient sounds around a person reflect the person's motions, such indicators can also be used. Or it is also possible to figure out fluctuations in motion by using positional information obtained from GPS.

The time series information on this consistency of motion (the reciprocal of the fluctuations of frequency intensity, for instance, can be used) is denoted by A1.

Next, how to figure out time series of data B1 will be described. The walking speed, for instance, is used as B1.

To calculate the walking speed, what has a frequency component of 1 to 3 Hz is taken out of the waveform data figured out at SS3, and a waveform region having a high level of periodic repetitiveness in this component can be deemed to be walking. In this calculation, the pitch of footsteps of walking can be figured out from the period of repetition. This is used as the indicator of the person's walking speed. It is denoted by B1 in the diagram.

Next, how to figure out time series of data C1 will be described. As an example of C1, outing is used. Namely, being out of the person's usual location (for instance, his office) is detected.

As regards outing, the user is requested to wear a name plate type sensor node (Y003) and to insert this sensor node into a cradle (battery charger) before going out. By detecting the insertion of the sensor node into the cradle, the outing can be detected. By inserting the sensor into the cradle, the battery can be charged during the outing. At the same time, the data accumulated in the sensor node can be transmitted to the relay station and the server. By using BPS, the outing can also be detected from a required position. The outing duration thereby figured out is denoted by C1.

Next, how to how to figure out time series of data D1 will be described. As an example of D1, conversation is used. As regards conversation, an infrared ray sensor incorporated into a name plate type sensor node (Y003) is used to detect whether the node is meeting another sensor node, and this meeting time can be used as the indicator of conversation. Further, from the frequency intensity figured out from the acceleration sensor, we discovered that, among multiple persons meeting one another, the one having the highest frequency component was the speaker. By using this discovery, we can analyze the duration of conversation in more detail. Moreover, by incorporating a microphone into the sensor node, conversation can be detected by using voice information. The indicator of the conversation quantity figured out by the use of these techniques is denoted by D1.

Next, how to figure out time series of data E1 will be described. As an example of E1, walking is used. Description of the detection of walking is dispensed with as it was already described. While the earlier description focused on the walking speed, the duration of walking is used as the indicator here.

Next, as an example of time series of data F1, rest is taken up. The duration of being at rest is used as the indicator. For this purpose, the intensity or the duration of a low frequency of about 0 to 0.5 Hz resulting from the already described frequency intensity analysis can be figured out for use as the indicator.

Next, as an example of time series of data G1, conversation is taken up. Since conversation was already described as D1, any more description is dispensed with here.

Next, as an example of time series of data H1, sleep is taken up. Sleep can be detected by using the result of frequency intensity analysis figured out from the acceleration described above. Since a person scarcely moves when sleeping, when the frequency component of 0 Hz has surpassed a certain length of time, the person can be judged to be sleeping. When the person is sleeping, if a frequency component other than rest (0 Hz) appears and no return to the rest state 0 Hz occurs after the lapse of a certain length of time, the state is deemed to be getting up, and getting up can be detected as such. In this way, the start and end points of time can be specified. This sleep duration is denoted by H1.

Next, as an example of time series of data I1, outing is taken up. The method of detecting outing was already described.

Finally, as an example of time series of data J1, concentration is taken up. The method of detecting concentration was already described as A1, and the reciprocal of the fluctuations of frequency intensity is used.

As described so far, by using six quantities, duplications excluded, including sleep (or walking speed), rest, concentration, conversation, walking and outing, the situation of this subject person can be expressed. What performs this is a unit (Y011) that prepares from the original time series of waveforms (or a group of waveforms) SS1 these six times series of variables (A1, B1, . . . J1).

Here, even if the consideration is limited to these six quantities, as each can take consecutive values, the state of the subject person can be represented by one point in a six-dimensional space, and there is a very broad freedom in combining these quantities.

However, the inventor has recognized the problem that too broad a freedom made interpretation of its meaning difficult. As a result, there is a problem that, in spite of a large quantity of available data, its meaning is not yet fully appreciated. Awareness of this problem has led him to a search for a method of interpreting the meaning of changes in state.

The inventor discovered that the state of a person would reveal itself in variations in these values, namely their ups and downs. Thus, he is concerned about whether the length of sleep has increased or decreased. Or his concern is about whether concentration is increasing or decreasing. In this way, he discovered that the state of a person could be classified, by using the ups and downs of these six quantities, into the sixth power of two states, namely 64 different states, and meanings permitting expression in words could be assigned to these 64 states. It was a truly original discovery that, by using these six quantities, a broad range of persons' states could be expressed. The method of doing it will be described below.

First, the length of time between points of time T1 and T2 is taken up. Changes in variables in this period are figured out. More specifically, for instance the waveform of an indicator A1 representing the insignificance of fluctuations in motion or the consistency of motion is taken up, and its waveforms between points of time TR1 and TR2 are sampled to find a representative value of that waveform (which is called the reference value RA1). For instance, the average of A1 values in this period is figured out. Or, to eliminate the influence of outliers, the median may be calculated instead. In the same way, a representative of the values from T1 and T2, which are the objects, is figured out (which is called the reference value PA1). Then, PA1 is compared with RA1 as to its relative magnitude and, if PA1 is greater, an increase is recognized or, if PA1 is smaller, a decrease is. This result (if 1 or 0 is allocated to the increase or decrease, this is 1-bit information) is called BA1.

To implement this procedure, a unit (Y012) to store and memorize the period in which the reference values TR1 and TR2 are prepared is needed. Also, a unit (Y013) to store and memorize the period in which the object values T1 and T2 are prepared is needed. It is Y014 and Y015 that read in these values from Y012 and Y013 and calculate the reference values and representative values. Further, units (Y016 and Y0173) to compare the reference values and object values resulting from the above and store the results are needed.

The relations between T1 and T2 and between TR1 and TR2 can take various values according to the purpose. For instance, if it is desired to characterize the state during one given day, T1 to T2 shall represent the beginning to end of the day. By contrast, TR1 to TR2 can represent one week retroactively from the day before the given day. In this way, a feature characterizing the given day can be made conspicuous relative to the reference value hardly affected by variations over a week. Or TR1 to T2 may represent one week and TR1 and TR2 may be set to represent the three preceding weeks. In this way, a feature characterizing the object week in a recent period of about one month can be made conspicuous. In the case taken up here the T1-T2 period and the TR1-TR2 period do not overlap, but it is also conceivable to make them overlap each other. In this way, positioning in the context of future influences in the object period T1-T2 can be expressed. At any rate, this setting can be flexibly done according to the object desired to be achieved, and any would come under the coverage of the invention.

Similarly, by comparing the reference value RB1 and the object value PB1 regarding the walking speed B1 as well, the intended result of increase or decrease (expressed in one bit) BB1 can be figured out.

Similarly, by comparing the reference value RC1 and the object value PC1 regarding the outing C1 as well, the intended result of increase or decrease (expressed in one bit) BC1 can be figured out.

Similarly, by comparing the reference value RD1 and the object value PD1 regarding the conversation D1 as well, the intended result of increase or decrease (expressed in one bit) BD1 can be figured out.

Similarly, by comparing the reference value RE1 and the object value PE1 regarding the walking E1 as well, the intended result of increase or decrease (expressed in one bit) BE1 can be figured out.

Similarly, by comparing the reference value RF1 and the object value PF1 regarding the rest F1 as well, the intended result of increase or decrease (expressed in one bit) BF1 can be figured out.

Similarly, by comparing the reference value RG1 and the object value PG1 regarding the conversation B1 as well, the intended result of increase or decrease (expressed in one bit) BG1 can be figured out.

Similarly, by comparing the reference value RH1 and the object value PH1 regarding the sleep H1 as well, the intended result of increase or decrease (expressed in one bit) BH1 can be figured out.

Similarly, by comparing the reference value RI1 and the object value PI1 regarding the outing I1 as well, the intended result of increase or decrease (expressed in one bit) BI1 can be figured out.

Similarly, by comparing the reference value RJ1 and the object value PB1 regarding the concentration J1 as well, the intended result of increase or decrease (expressed in one bit) BJ1 can be figured out.

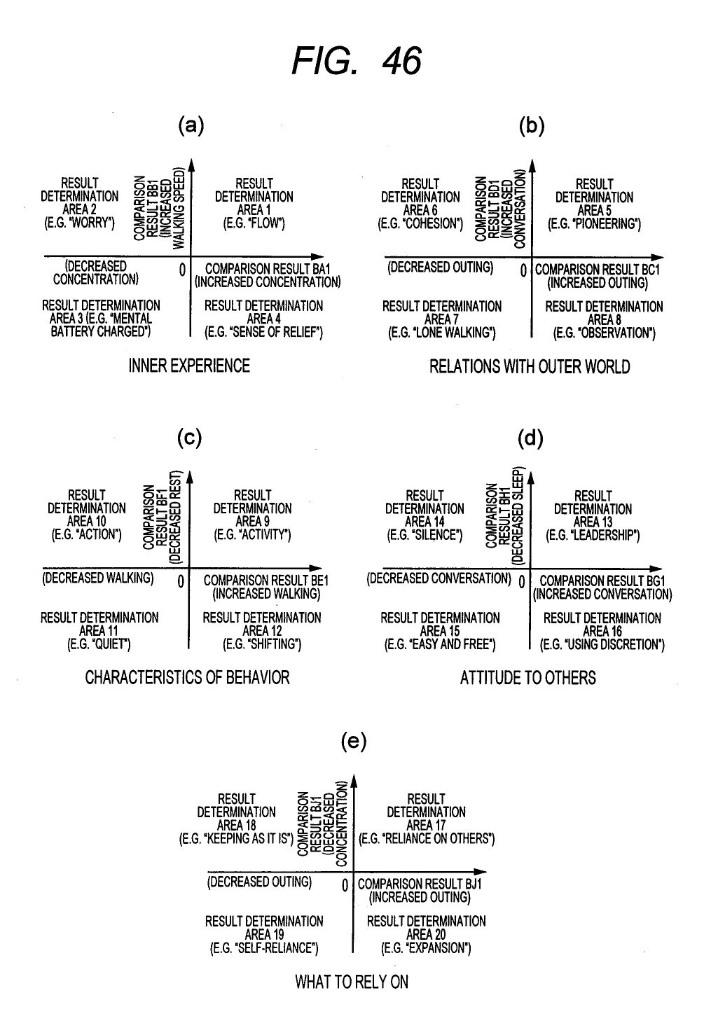

### <FIG. 46: Expression in Four Quadrants>

As described so far, increases or decreases in the six values (increases or decreases in the 10 values including duplications) were figured out. By combining them, detailed meanings can be found out from these variations.

First as shown in FIG. 46 (a), a diagram of four quadrants can be drawn with BA1 representing increases or decreases in concentration on the axis of abscissas and BB1 representing increases or decreases in walking speed on the axis of ordinates. This is a situation where concentration increases and walking speed also increases in the first quadrant, namely the result determination area 1. In more abstract terms, this means that while the grasp of activity and the exertion of capability increase, at the same time the sense of tension and challenging spirit also rise. This state is called flow.

The second quadrant, namely the result determining area 2, is called worry, the area 3 is called mental battery charged and the area 4 is called sense of relief.

This enables the quality of the inner experience of the person wearing this sensor node Y003 to be figured out. More specifically, it can be known from the time series of data whether he is in a state of flow where both the sense of tension and the grasp are high or, conversely, he is in a mental battery charged state where both are low, or in a state of worry where only the tension is high, or in a state of sense of relief where only the grasp is high. The possibility to give a meaning in words understandable by humans, advancing from the time series of data which were a mere series of numerical counts, is a significant feature of the invention.

This technique of configuring four quadrants with combinations of two variables and assigning a meaning and a name to each of the quadrants enables rich meanings to be derived from the time series of data.

Already, methods of classifying many sets of measured data into a number of predetermined categories are known. For instance, among multivariate analyses, a method of allocating data to multiple categories by a technique known as discriminant analysis is known. By this method, however, “thresholds” and boundary lines, which serve as the boundaries of discrimination, have to be prescribed. In this case, a method by which data to serve as the correct answer in determination are given to determine these thresholds and boundary lines is known. Yet, it still is difficult to find conditions that give a 100% correct answer. Therefore, there was the problem of poor reliability of the result.

The present invention has a first time series of data, a second time series of data, a first reference value and a second reference value; has a unit that determines whether the first time series of data or a value resulting from conversion of the first time series is greater or smaller than the first reference value; has a unit that determines whether the second time series of data or a value resulting from conversion of the second time series is greater or smaller than the second reference value; has a unit that determines a status 1 in which the first time series of data is greater than the first reference value and the second time series of data is greater than the second reference value; has a unit that determines a status other than the status 1 or a non-status 1 in a specific status limited in advance to be in a status 2; and has a unit that stores two names respectively representing at least two predetermined statuses and matches these two names with the status 1 and the status 2; and has a unit that displays the fact of being in either of these status 1 and status 2, whereby variations in the status combining the first and second time series of data are visualized.

As this configuration supposes determination to be made by combining the relation of magnitude differences from reference values prepared from time series of data, there is no need to prescribe boundaries to match correct answer data. Therefore the reliability of results is dramatically improved. This makes possible conversion of a wide spectrum of time series of data into a word (or a series of words). This is an epochal invention permitting translation of a large quantity of time series of data into a language understandable by humans.

Regarding the external relations of the subject person (FIG. 46 (b)), BC1 and BD1 can be used to reveal whether he is in a pioneering orientation in which both outing and conversation are increasing, an observing orientation in which outing is increasing but conversation is decreasing, a cohesive orientation in which outing is decreasing but conversation (with colleagues) is increasing or in a lone walking orientation in which both outing and conversation are decreasing.

Regarding the characteristics of behavior of the subject person (FIG. 46 (c)), BE1 and BF1 can be used to reveal whether he is in a shifting orientation in which both walking and rest are increasing, an activity orientation in which walking is increasing but rest is decreasing, a quiet orientation in which walking is decreasing but rest is increasing, or an action orientation in which both walking and rest are decreasing.

Regarding the attitude to others of the subject person (FIG. 46 (d)), BG1 and BH1 can be used to reveal whether he is in a using discretion orientation in which both conversation and sleep are increasing, a leadership orientation in which conversation is increasing but sleep is decreasing, an easy and free orientation in which conversation is decreasing but sleep is increasing, or a silence orientation in which both conversation and sleep are decreasing.

Regarding the characteristics of what to rely on of the subject person (FIG. 46 (e)), BI1 and BJ1 can be used to reveal whether he is in an expansive orientation in which both outing and concentration are increasing, a reliance on others orientation in which outing is increasing but concentration is decreasing, a self-reliance orientation in which outing is decreasing but concentration is increasing, or in a keeping as it is orientation in which both outing and concentration are decreasing.

Regarding the processing so far described, as stated with regard to Y018 through Y019, predetermined classes C1 (namely one of flow, worry, mental battery charged and sense of relief) through C5 can be obtained.

By the process hitherto stated, we succeeded in finding meanings understandable by humans consecutively in large quantities of sensor data, namely time series of waveform data. This is an unprecedented epochal invention.

Further this exemplary embodiment has a unit that determines a status 1 in which variations in a first quantity relating to the user's life or duty performance increase or are great and variations in a second quantity increase or are great; has a unit that determines from variations in the first and second quantities the fact of being in a status other than the status 1 or a further pre-limited specific status 2 among other statuses than the status 1; has a unit that determines a status 3 in which variations in a third quantity increase or are great and variations in a fourth quantity increase or are great; has a unit that determines from variations in the third and fourth quantities the fact of being in a status other than the status 3 or a further pre-limited specific status 4 among other statuses than the status 3; has a unit that supposes a status that is the status 1 and is the status 3 to be a status 4, supposes a status that is the status 1 and is the status 4 to be a status 6, supposes a status that is the status 2 and is the status 3 to be a status 7, supposes a status that is the status 2 and is the status 43 to be a status 8, stores four names representing at least four predetermined statuses and matches these four names with the status 5, the status 6, the status 7 and the status 8; and has a unit that displays the fact of being in one of these status 5, the status 6, the status 7 and the status 8, whereby variations in the status of the person or organization combining the first, second, third and four quantities are visualized.

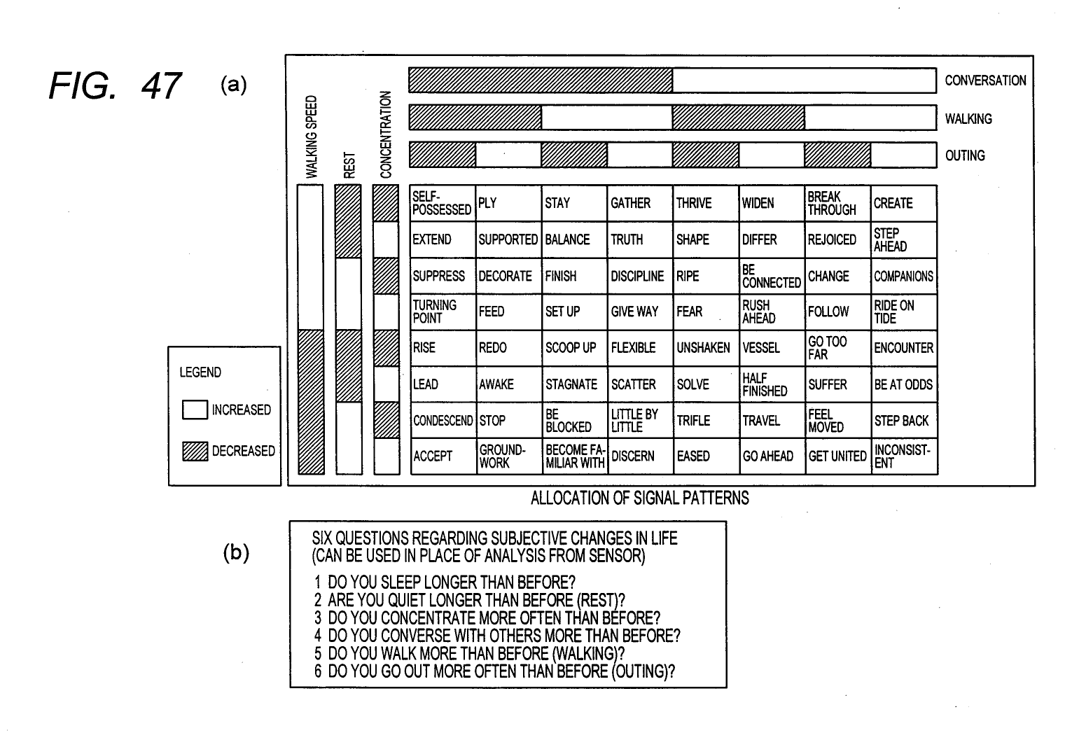

This configuration makes possible more detailed analysis of statuses and permits a broad spectrum time series of data into words. Thus, it permits translation of a large quantity of time series of data into an understandable language.

<FIG. 47: Classification of Statuses into 64 Types: Example of Questionnaire>

By using increases or decreases of these six variables, the statuses of a person can be classified into 64 types (the sixth power of two). What results from giving meanings to this by combining these meanings is shown in FIG. 47 (a). For instance, if conversation is decreasing and walking and outing are increasing while walking speed, rest and concentration are increasing, a status of “yield” comes in. This is flow, an observing orientation and a shifting orientation. At the same time it is a silence orientation combined with an expanding orientation, and it is made possible to notice these characteristics and express that status.

In the foregoing, the status of the subject was expressed by using increases or decreases of the six variables and classification into 64 types, but it is also possible to express the status of the subject by using increases or decreases of two variables and classification into four types. Or it is also possible to do so by using three variables and classification into eight types. In these cases, classification becomes rough, but it has a feature of simpler and easier-to-understand classification. Conversely, more detailed status classification can also be accomplished by using increases or decreases of seven or more variables.

Although the use of data from sensor nodes has been described so far as exemplary embodiments, the invention can provide similarly useful effects with time series of data from something else than sensor nodes. For instance, the operating state of a personal computer can reveal the presence or outing of its user, and this can conceivably be used as one of the variables discussed above.

Or it is also possible to obtain indicators of conversation from the call records of a mobile phone. By using the GPS records of a mobile phone, indicators of outing can also be obtained. The number of electronic mails (transmitted and received) by a personal computer or a mobile phone can also be an indicator.

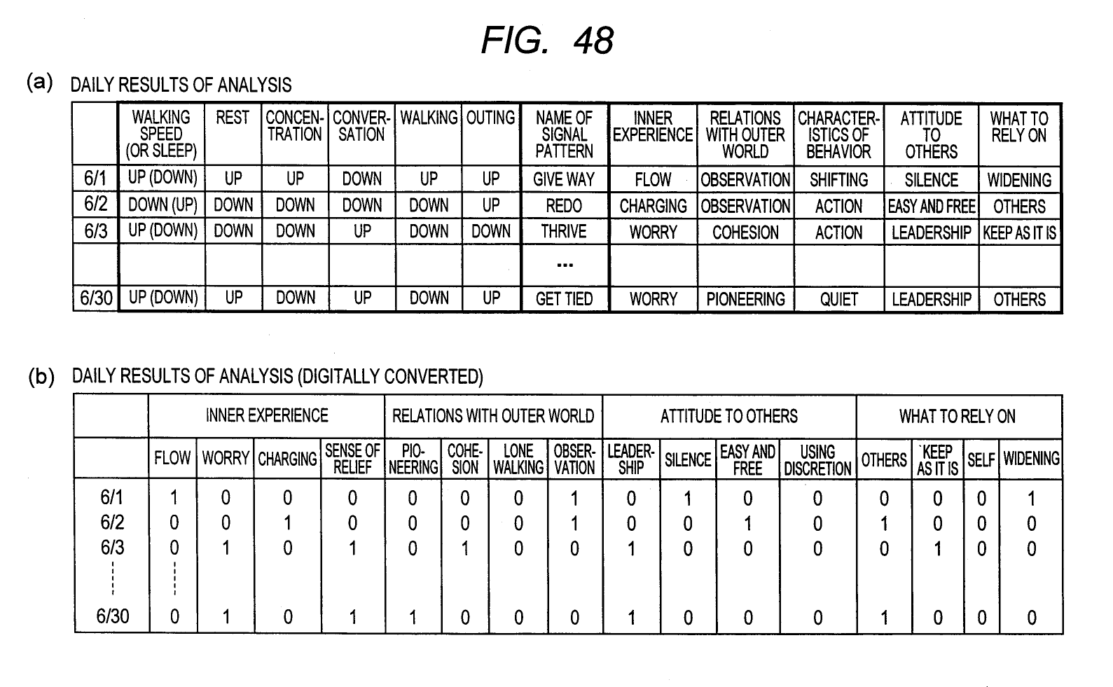

Further, instead of expressly using time series of data, ups and downs of variables can be known by asking questions as shown in FIG. 47 (b) to replace part or the whole of the acquisition of variables described above. The analysis described above can be accomplished by, for instance, having these questions inputted on a website of the Internet and having the server (Y005) user's inputs via a network (the unit to handle this process is denoted by Y002). As this alternative relies on human memory, it lacks accuracy of measurement, but has the advantage of simplicity and convenience.

<FIG. 48 through FIG. 51: Examples of Analytical Results

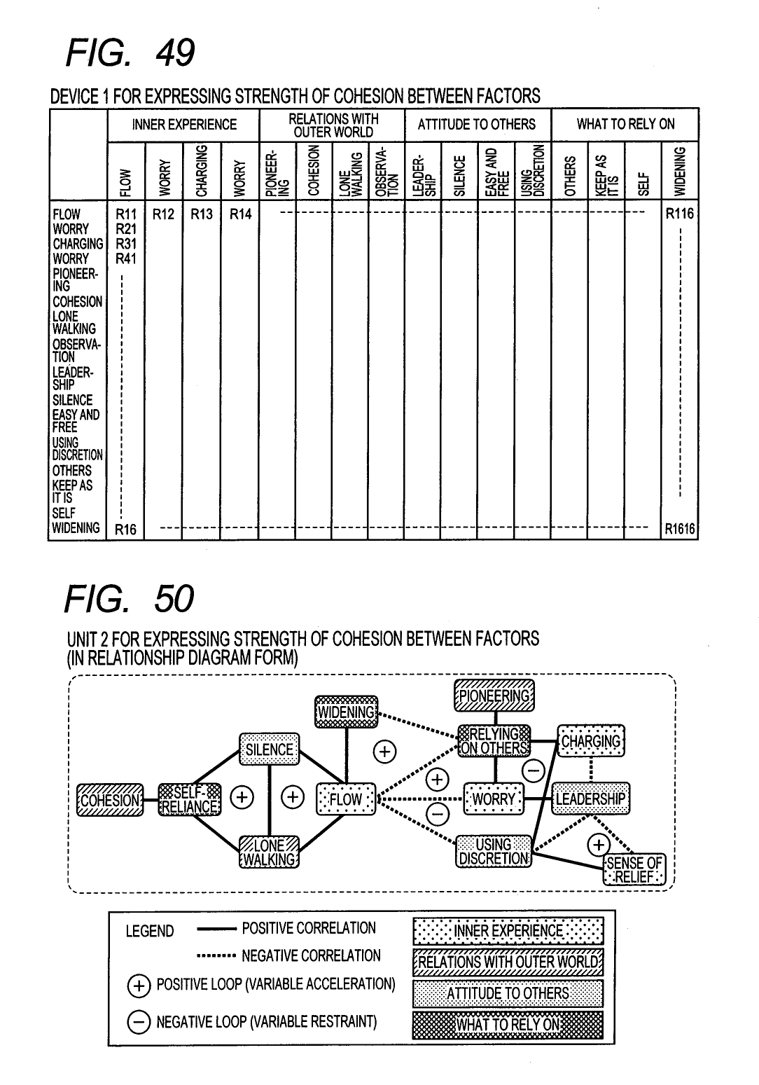

These sensor data or time series of data or the result of a questionnaire survey can reveal features of a given day. Continuation of such attempts for days would make available a matrix as shown in FIG. 48 (a), and it is further possible to have it displayed on a display unit connected by Y020 to be presented to the user. Digital representation of this in a classification into four quadrants could give a matrix as shown in FIG. 48 (b). By using these numerical data, the coefficients of correlation between the columns of the matrix can be calculated. These coefficients of correlation, denoted by R11 through R1616, are tabulated in FIG. 49 (where only four of the five quadrant diagrams are used for the sake of simplicity). This table represents correlations of status expressions in a day. To make it even easier to understand, a threshold (for instance, 0.4 is chosen as the threshold for evident correlations) is provided, and any level surpassing the threshold is determined as mutual connection of status expression while failure to surpass the threshold is determined as non-connection of status expression; by linking connected status expressions with lines, the structure of the person's life can be visualized (FIG. 50).

In the example of this drawing, loops of elements mutually connected by positive correlation (a circular route of return to the original point) are marked with plus and minus signs. This means a feedback by which, if the pertinent variable varies, the variation is further expanded. For instance in this example, once flow occurs, the silence orientation and the lone walking orientation are strengthened, resulting in a feedback loop of a further increase in flow. Or a loop having an odd number of negative correlaions denoted by minus signs means a feedback to suppress variations. It is seen that, for instance, if flow increases, the using discretion orientation weakens, the leadership orientation is intensified, and worry increases, resulting in weakened flow. In this case, the initial flow suppresses increasing variations.

While this analysis was made on a daily basis, obviously it can be accomplished in other time units, such as semi-daily, hourly, or weekly or monthly.

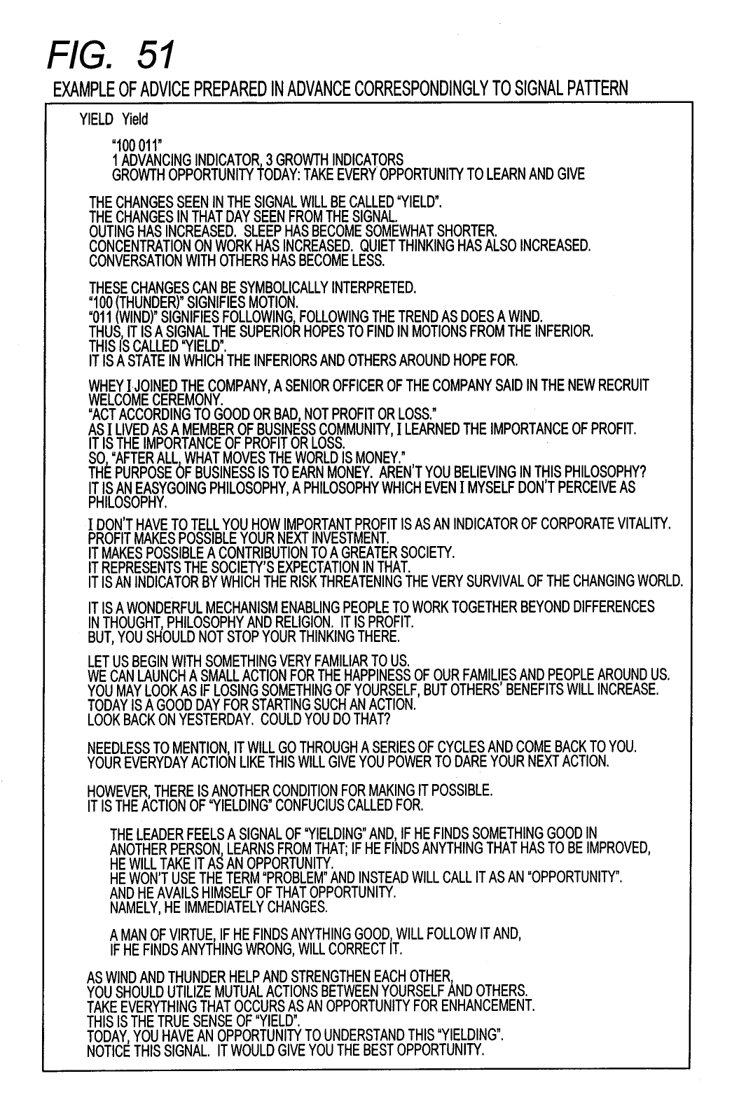

Once a large quantity of time series of data reveals the structure determining human behavior to this extent, advice for improvement of the person's private life or duty performance can be given specifically. An advice point is entered in advance in the matching one of the 64 classification boxes in FIG. 47 (a) and, if any of the classified states is determined to have occurred, the pertinent advice point can be displayed on the display unit or otherwise to automatically provide advice based on sensor data. This processing to display advice information is accomplished by Y021. An example of advice to be present when a “yield” state has been determined is shown in FIG. 51.

When any of these results is to be displayed, as the ID put on the sensor node is difficult to recognize, the ID and attribute information M1 on that person (further his sex, occupational status, position and so on) are linked together, and combined displaying of these results will make it easier to understand (these are denoted by Y023 and Y024).

Although the foregoing description referred to characterization of the status of a person in words, what characterizes the invention is not limited to individual humans. It can be similarly applied to a wide range of objects including organizations, families, the state of automobiles being driven and the operating state of equipment.

### Embodiment 8

An eighth exemplary embodiment of the present invention will be described with reference to drawings.

The eighth exemplary embodiment of the invention finds, by analyzing data on the quantity of communication between existing persons, a pair of persons whose communication should desirably be increased and causes a display or an instruction to be given to urge the increase.

As data indicating the quantity of communication between persons, meeting time data obtained from the terminal (TR), the reaction time of voices available from a microphone, and the number of transmitted and received e-mails obtained from the log of a PC or a mobile phone can be used. Or data having a specific character relevant to the quantity of communication between persons, if not data directly indicating the quantity of communication, can be similarly used. For instance, if meeting between the pertinent persons is detected and the mutual acceleration rhythm is not below a certain level, such time data can as well be used. A meeting state in which the acceleration rhythm level is high is a state of animated conversation, such as brain storming. Thus, if such data are used, the state between persons who are silent and just letting the conference time lapse is not analyzed, but the structure linking persons engaged in animated conversation (network structure) can be recognized to permit extraction of a pair of persons whose conversation is to be increased. In the following description, as data on the communication quantity, information on the meeting time obtained from the terminals (TR) is supposed to be used.

In order to find a pair of persons whose communication should be increased, relations among three persons is the organization are taken note of. In a case in which, among given persons X, A and B, person X and person A are linked (communicating) with each other and, though person X and person B are also linked, person A and person B are not, compared with a case in which person A and person B are also linked, a request by person X to each of person A and person B to do a task would result in poorer efficiency and quality of the work because persons A and B cannot understand each other's circumstances and particulars of work. In view of this possibility, a trio in which two pairs are linked but the remaining one pair is not is found, and a representation is made to urge the unlinked pair to establish a link. In order to find such a trio, the meeting matrix (ASMM) described with reference to the sixth exemplary embodiment of the invention is used.

FIG. 54 is a block diagram illustrating the overall configuration of a sensor network system to realize the eighth exemplary embodiment of the invention. It only differs in the application server (AS) in the first exemplary embodiment of the invention shown in FIG. 4 through FIG. 6. Illustration of other parts and processing is dispensed with here because items similar to those in the first exemplary embodiment of the invention are used. Further, as no performance data are used, the client for performance inputting (QC) is dispensable.

The configurations of the memory unit (ASME) and the transceiver unit in the application server (AS) are similar to those used in the sixth exemplary embodiment of the invention. Further in the control unit (ASCO), after the analytical conditions setting (ASIS), required meeting data are acquired by the data acquisition (ASGD) from the sensor network server (SS), and a meeting matrix is prepared from those data every day (ASIM). Processing is done in a procedure in which association-expected pair extraction (ASR2) is carried out and finally network diagram drawing (ASR3) is done. The product of drawing is transmitted to the client (CL) for representation (CLDP) on a display or the like.

In the association-expected pair extraction (ASR2), all the trios in which only one pair is not associated, and the unlinked pairs are listed up as association-expected pairs.

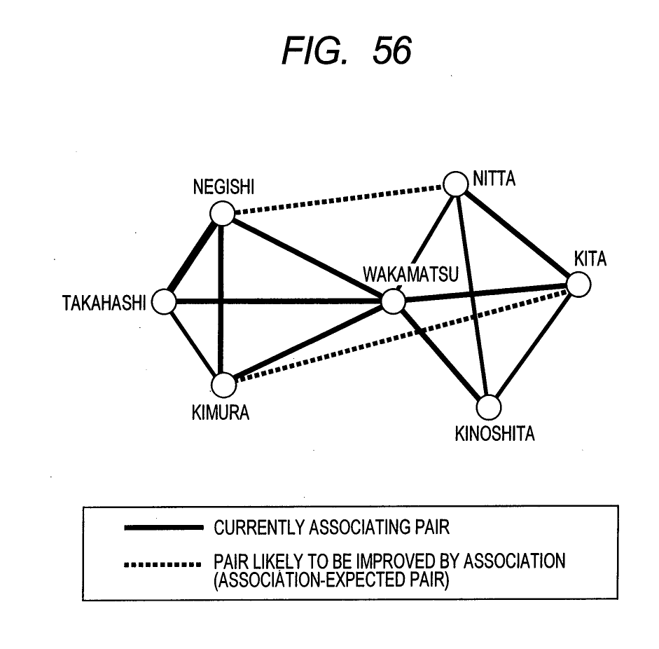

In the network diagram drawing, some out of the list of association-expected pairs are selected and caused to be emphatically displayed, overlapping the network diagram showing the scene of association among all the persons. An example of display is shown in FIG. 56. In this way, persons whose increased association can be expected to contribute to improving the organization are specifically identified. It is thereby made possible to implement measures to cause the persons to associate with others, for instance, having them join the same group and work together.

Also, the use of the level of cohesion, an indicator of the relative closeness of mutual links among persons around one given person, will give a still better effect. Before the association-expected pair extraction (ASR2), the level of cohesion calculation (ASR1) is done, and note is taken of a person lower in the level of cohesion (namely a person weaker in links with other persons around). And by extracting an association-expected pair out of trios involving that person, a pair to contribute to the optimization of the whole organization can be achieved, and a further improvement in productivity can be expected. Furthermore, since there is no longer necessary to determine the form of three-party links for every combination, there is an advantage of shortening the time spent on processing. This is particularly effective for an organization having a large workforce. In the following paragraphs, a specific method of carrying out a process using the level of cohesion will be described in specific terms. Where the level of cohesion is not used, only the step of level of cohesion calculation (ASR1) is dispensed with, and all other steps can be implemented in the same way.

In an organization, the indicator known as the level of cohesion (Cohesion) is particularly relevant to productivity. The level of cohesion is an indicator representing the degree of communication among multiple persons communicating with a given person X. When the level of cohesion is high, persons around the given person well understand one another's circumstances and particulars of work and can work together through spontaneous mutual help, the efficiency and quality of work are improved. By contrast, where the level of cohesion is low, the efficiency and quality of work can be regarded as being apt to fall. Thus, the level of cohesion is an indicator representing in numerical count the degree of the lack of communication in the aforementioned three party relations where two members are not communicating with the other one but the relations are desired to be expanded to one versus three or more. As it is known that the higher the level of cohesion, the higher the productivity, this indicator can be relied upon in trying to improve the organization. Therefore, according to this exemplary embodiment, specific advice will be given on combinations of persons desired to have more communication on the basis of the level of cohesion as indicator. This will make possible planning of measures to facilitate strategic selection of pairs more effective in contributing to productivity improvement of the organization and to increase such pair links.

Next, the sequence of processing in the control unit (ASCO) in the application server (AS) will be described with reference to the block diagram of FIG. 54. The configuration is the same as in Embodiment 6 except for the control unit (ASCO).

First, the analytical conditions setting (ASIS), the data acquisition (ASGD) and meeting matrix preparation (ASIM) are accomplished by the same method as in the sixth exemplary embodiment of the invention.

The level of cohesion calculation (ASR1) figures out of the level of cohesion Ci of each person by the following Equation (3). In the following description a pair of persons having element values in the meeting matrix of not below the threshold (for instance three minutes per day) will be deemed to be “communicating”.

$${C}_{i} = \frac{{L}_{i}}{{}_{{N}_{i}}^{}{C}{}_{2}^{}} \times {N}_{i} \qquad [ Equation 3 ]$$

Ci: Cohesion level of person i

Ni: Number of persons linked with person i

Li: Number of links between persons linked with person i

NiC2: Number of combinations of all links among Ni persons

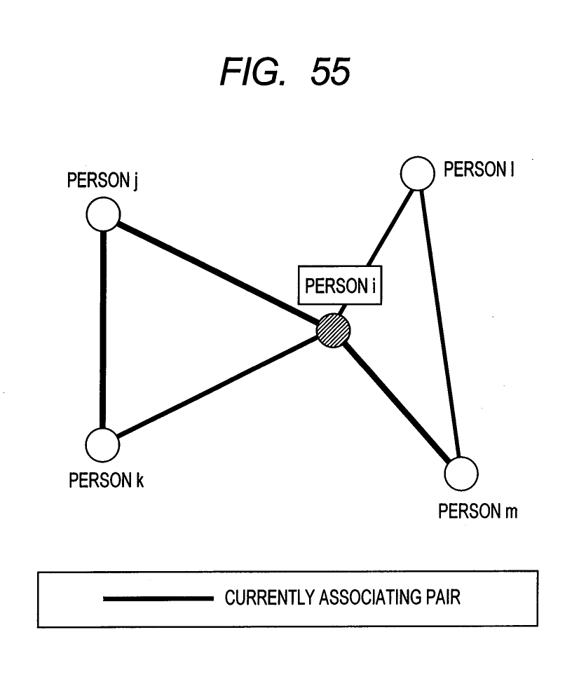

Equation 3 will be described with reference to an example of network diagram indicating links, given as FIG. 55. In FIG. 55, Ni is 4 (persons), Li is 2 and NiC2 is 6. Therefore, the level of cohesion Ci is found to have a value of (2÷6×4=) 1.33. Similarly, the level of cohesion is calculated for every person.

Next, the association-expected pair extraction (ASR2), noting the person lowest in the level of cohesion, extracts pairs of persons that person should communicate with to enhance his own level of cohesion, namely association-expected pairs. More specifically, all the pairs communicating with the noted person but not among each other are listed up. To refer to the example in FIG. 55, for instance, each member of the pair of a person j and a person l communicates with a person i but not with the pair partner, linkage within this pair will boost the number of linked persons (Li) each linked with the person i, and the level of cohesion of the person i can be raised.

A method of listing up according to an element (representing the meeting time between persons) in the meeting matrix will be described more specifically. Out of the members of the organization, all the patterns of combining three persons (i, j, l) are successively checked. The element of the person i and the person j is denoted by T(i, j), that of the person i and the person l by T(i, l), that of the person j and the person l by T (i, l) and the threshold presumably indicating linkage, by K. In the combination of three persons, conditions to satisfy T(i, j)≧K and T(i,1)≧K and T(i,1)<K are found out, and the pair of two persons other than the person i (person j, person l) is listed up as an association-expected pair.

Incidentally, instead of taking note of the person lowest in the level of cohesion, it is also possible to pick out association-expected pairing in advance for each of multiple persons in the ascending order of the level of cohesion, and select and display a few pairs at the next stage of network diagram drawing (ASR3). In this case, advice for overall and uniform improvement of the organization can be given.

In the network diagram drawing (ASR3), by a method of drawing (network diagram) by which persons are associated with circles and person-to-person links with line, the current status of linkages in the organization is derived from the meeting matrix (ASMM) by the use of a layout algorithm, such as a mass-spring model. Further, a few (for instance two pairs; the number of pairs to be displayed is determined in advance) are selected at random out of the pairs extracted by the association-expected pair extraction (ASR2), and the pair partners are linked by different kinds of lines (for instance dotted lines) or colored lines. An example of drawn image is shown in FIG. 56. FIG. 56 is a network diagram in which already associated pairs are indicated by solid lines, and association-expected pairs by dotted lines. This way of representation makes clearly understandable what pairs can be expected to improving the organization by establishing linkage.

A possible measure to urge linkage is to divide members into multiple groups and have them work in those groups. If grouping so arranged as to assign partners of a displayed association-expected pair to the same group, association of the target pairs can be encouraged. Further in this case, it is also possible to so select the pairs to be displayed as to make the membership size of each group about equal instead of selecting them out of association-expected pairs at random.

The method described above enable association-expected pairs to be extracted and specifically displayed. This would contribute to linkages within the organization and accordingly to productivity improvement of the organization.

Exemplary embodiments of the present invention have been described so far, but the invention is not limited to these embodiments. Persons skilled in the art would readily understand that various modifications are possible and some of the described embodiments can be appropriately combined.

### INDUSTRIAL APPLICABILITY

The present invention can be applied to, for instance, the consulting industry for helping productivity improvement through personnel management and project management.

### REFERENCE SIGNS LIST

TR, TR2 through TR3: Terminal
GW, GW2: Base station
US, US2 through 5; User
QC: Client for performance inputting
NW: Network
PAN: Personal area network
SS: Sensor network server
AS: Application server
CL: Client

1. An information processing system comprising:
a terminal;
an input/output unit; and
a processing unit for processing data transmitted from the terminal and the input/output unit,
wherein the terminal is provided with a sensor for detecting a physical quantity and a data transmitting unit for transmitting data representing the physical quantity to the processing unit;
the input/output unit is provided with an input unit for receiving an input of data representing a productivity element relating to a person wearing the terminal and a data transmitting unit for transmitting the data representing the productivity element to the processing unit; and
the processing unit is provided with a feature value extracting unit for extracting a feature value from the data representing the physical quantity, a conflict calculating unit for determining multiple items of data giving rise to conflict from the data representing the productivity element, and a coefficient-of-influence calculating unit for calculating the closeness of relation between the feature value and the multiple items of data giving rise to conflict.

2. The information processing system according to claim 1,
wherein the coefficient-of-influence calculating unit, using the same feature value, calculates the closeness of relation to multiple items of data giving rise to the conflict.

3. The information processing system according to claim 1,
wherein the processing unit is further provided with a balance map drawing unit for drawing an image on which signs denoting the feature values are plotted on a coordinate plane having two axes of which one represents the closeness of relation between a first data item, out of multiple items of data giving rise to the conflict, to the feature values and the other represents the closeness of relation between a second data item, out of multiple items of data giving rise to the conflict, to the feature values.

4. The information processing system according to claim 1,
wherein the conflict calculating unit selects multiple combinations out of productivity representing data sets, calculates a coefficient of correlation of each of the multiple combinations, and determines one combination of which the coefficient of correlation is negative and an absolute value thereof is the greatest as multiple items of data giving rise to the conflict.

5. The information processing system according to claim 1,
wherein the sensor detects acceleration as the physical quantity; and
the feature value extracting unit calculates an acceleration rhythm representing the frequency of oscillation from a value of the acceleration and calculates the feature value on the basis of the magnitude of the acceleration rhythm or the duration of the acceleration rhythm in a prescribed range.

6. The information processing system according to claim 1,
wherein the sensor detects infrared rays transmitted from another terminal and acquires meeting data with the other terminal; and
the feature value extracting unit calculates from meeting data the meeting time between the terminal and the other terminal, and calculates the feature value on the basis of a length of the meeting time.

7. The information processing system according to claim 6,
wherein the feature value extracting unit complements a blank in the meeting data, measures a change in posture of the terminal wearing person during meeting on the basis of the complemented data, and makes the change in posture during meeting the feature value.

8. The information processing system according to claim 1,
wherein the terminal and the input/output unit are the same unit.

9. An information processing system:
a terminal;
an input/output unit; and
a processing unit for processing data transmitted from the terminal and the input/output unit,
wherein the terminal is provided with a sensor for detecting a physical quantity and a data transmitting unit for transmitting data representing the physical quantity;
the input/output unit is provided with an input unit for receiving an input of data representing multiple productivity elements relating to a person wearing the terminal and a data transmitting unit for transmitting the data representing the productivity element to the processing unit; and
the processing unit is provided with a feature value extracting unit for extracting a feature value from the data representing the physical quantity; a conflict calculating unit for unifying items of data representing the multiple productivity elements, respective periods and sampling periods thereof; and a coefficient-of-influence calculating unit for calculating the closeness of relation between the feature values for which the periods and sampling frequencies are unified and the data representing multiple productivity elements.

10. The information processing system according to claim 9,
wherein the feature value extracting unit unifies the respective sampling periods of the multiple feature values by dividing the sampling period stepwise in an ascending order of size and figuring out the feature values.

11. The information processing system according to claim 9,
wherein the conflict calculating unit determines multiple items of data giving rise to conflict from the data items representing the productivity element; and
the coefficient-of-influence calculating unit calculates the closeness of relation between the feature values and the multiple items of data giving rise to conflict.

12. The information processing system according to claim 11,
wherein the conflict calculating unit selects multiple combinations from the multiple data items representing the productivity element, calculates the coefficient of correlation of each of the multiple combinations, and determines one combination of which the coefficient of correlation is negative and an absolute value thereof is the greatest as multiple items of data giving rise to the conflict.

13. An information processing system comprising:
a terminal;
an input/output unit; and
a processing unit for processing data transmitted from the terminal and the input/output unit,
wherein the terminal is provided with a sensor for detecting a physical quantity and a data transmitting unit for transmitting data representing the physical quantity detected by the sensor;
the input/output unit is provided with an input unit for receiving an input of data representing a productivity element relating to a person wearing the terminal and a data transmitting unit for transmitting the data representing the productivity element to the processing unit; and
the processing unit is provided with a feature value extracting unit for extracting a feature value from the data representing the physical quantity, a conflict calculating unit for determining subjective data representing the person's subjective evaluation and objective data on the duty performance relating to the person from the data representing the productivity element, and a coefficient-of-influence calculating unit for calculating the closeness of relation between the feature value and the subjective data and the closeness of relation between the feature value and the objective data.

14. The information processing system according to claim 13,
wherein the processing unit is further provided with a balance map drawing unit for drawing an image on which signs denoting the feature values are plotted on a coordinate plane having two axes of which one represents the closeness of relation between the feature value and the subjective data, and the other represents the closeness of relation between the feature value and the objective data.

15. The information processing system according to claim 13,
wherein the subjective data and the objective data give rise to conflict.

16. The information processing system according to claim 13,
wherein the conflict calculating unit selects multiple combinations from the multiple data items representing the productivity element, calculates the coefficient of correlation of each of the multiple combinations, and determines one combination of which the coefficient of correlation is negative and an absolute value thereof is the greatest as the subjective data and the objective data.

17. An information processing system comprising:
a terminal;
an input/output unit; and
a processing unit for processing data transmitted from the terminal and the input/output unit,
wherein the terminal is provided with a sensor for detecting a physical quantity and a data transmitting unit for transmitting data representing the physical quantity detected by the sensor;
the input/output unit is provided with an input unit for receiving an input of data representing multiple productivity elements relating to a person wearing the terminal and a data transmitting unit for transmitting the data representing the productivity element to the processing unit; and
the processing unit is provided with a feature value extracting unit for extracting multiple feature values from the data representing the physical quantity and a coefficient-of-influence calculating unit for calculating the closeness of relation between one feature value selected out of the multiple feature values and each of data items representing the multiple productivity elements.

18. An information processing system comprising:
a recording unit for recording a first time series of data, a second time series of data, a first reference value and a second reference value;
a first determining unit for determining whether the first time series of data or a value resulting from conversion of the first time series is greater or smaller than the first reference value;
a second determining unit for determining whether the second time series of data or a value resulting from conversion of the second time series of data is greater or smaller than the second reference value,
a status determining unit for determining a case in which the first time series of data or the value resulting from conversion of the first time series is greater than the first reference value, and the second time series of data or the value resulting from conversion of the second time series of data is greater than the second reference value to be a first status, and determines a status other than the first status or a specific status other than the first status as a second status;
a unit allocating a first name to the first status and a second name to the second status; and
a unit for causing a display unit connected thereto a fact of being in the first status or the second status by using the first name or the second name, respectively.

19. The information processing unit according to claim 18,
wherein the first time series of data is signals having an acceleration waveform or data converted from signals having the acceleration waveform.

20. The information processing unit according to claim 18,
wherein the first time series of data is signals relating to sleep or data converted from the signals relating to sleep.

21. The information processing unit according to claim 18, wherein:
the first time series of data is signals relating to walking or walking speed or data converted from the signals relating to signals relating to walking or walking speed.

22. The information processing unit according to claim 18,
wherein the first time series of data is signals relating to fluctuations or consistency of human motions or data converted from the signals relating to fluctuations or consistency of human motions.

23. The information processing unit according to claim 18, further comprising:
a unit for preparing the first reference value by converting the first time series of data; and
a unit for preparing the second reference value by converting the second time series of data.

24. An information processing unit comprising:
a unit for acquiring information inputted by a user concerning a first quantity and a second quantity relating to the user's life or duty performance;
a status determining unit for determining a case in which the first quantity increases and the second quantity increases as a first status and determining a status other than the first status or a specific status other than the first status as a second status;
a unit for allocating a first name to the first status and a second name to the second status; and
a unit for causing a display unit connected thereto to display a fact of the user being in the first status or the second status by using the first name or the second name, respectively.

25. The information processing unit according to claim 24,
wherein the first quantity or the second quantity is a quantity relating to any of sleep, rest, concentration, conversation, walking and outing.

26. An information processing unit comprising:
a unit for acquiring information inputted by a user concerning a first quantity, a second quantity, a third quantity and a fourth quantity relating to the user's life or duty performance;
a status determining unit for:
determining a case in which the first quantity increases and the second quantity increases as a first status;
determining a status other than the first status or a specific status other than the first status as a second status;
determining a case in which the third quantity increases and the fourth quantity increases as a third status;
determining a status other than the third status or a specific status other than the third status as a fourth status;
determining a status which is the first status and is the third status as a fifth status;
determining a status which is the first status and is the fourth status as a sixth status;
determining a status which is the second status and is the third status as a seventh status; and
determining a status which is the second status and is the fourth status as an eighth status,
a unit for allocating a first name to the fifth status, a second name to the sixth status, a third name to the seventh status and a fourth name to the eighth status; and
a unit for causing a display unit connected thereto a fact of the user being in one of the fifth status, sixth status, seventh status and eighth status by using at least one of the first name, second name, third name and fourth name.

27. The information processing unit according to claim 26,
wherein advice respectively matching the fifth status, the sixth status, the seventh status and the eighth status is recorded in advance; and
the display unit is caused to display the advice when the user has determined to be in the fifth status, the sixth status, the seventh status or the eighth status.

28. An information processing unit comprising:
a recording unit for recording time series of data relating to movements of a person;
a calculating unit for calculating indicators regarding fluctuations, unevenness or consistency in the movements of the person by converting the time series of data;
a determining unit for determining from the indicators insignificance of fluctuations or of unevenness or significance of consistency in the movements of the person; and
a unit for causing on the basis of the determination a desirable status of the person or an organization to which the person belongs to be displayed on a display unit connected thereto.

29. The information processing unit according to claim 28, wherein:
the time series of data is acceleration data obtained from the acceleration sensor;
the calculating unit extracts information regarding frequency from the acceleration data; and
the information regarding frequency includes information indicating at least part of a range in which the frequency intensity is from 1 Hz to 3 Hz.

30. An information processing unit comprising:
a recording unit for recording time series of data relating to sleep of a person:
a calculating unit for calculating indicators regarding fluctuations, unevenness or consistency in the sleep of the person by converting the time series of data;
a determining unit for determining from the indicators insignificance of fluctuations or of unevenness or significance of consistency in the sleep of the person; and
a unit for causing on the basis of the determination a desirable status of the person or an organization to which the person belongs to be displayed on a display unit connected thereto.

31. The information processing unit according to claim 30,
wherein advice to the person or the organization is recorded in advance matched with the status of the person; and
the determining unit determines the status of the person from the indicators regarding significance of fluctuations or of unevenness or consistency relating to the sleep of the person and provides advice to the person or the organization on the basis of the result of determination.

32. An information processing unit comprising:
a recording unit for recording data representing the state of communication among at least a first user, a second user, and a third user; and
a processing unit for analyzing the data representing the state of communication,
wherein the recording unit records a first communication quantity and a first related information item between the first user and the second user, a second communication quantity and a second related information item between the first user and the third user, and a third communication quantity and a third related information item between the second user and the third user, and
the processing unit, when it determines that the third communication quantity is smaller than the first communication quantity and the third communication quantity is smaller than the second communication quantity, gives a display or an instruction to urge communication between the second user and the third user.
